(19) United States
(12) Patent Application Publication
(10) Pub. No.: US 2025/0109963 A1
(43) Pub. Date: Apr. 3, 2025

(54) ROBOT-FRIENDLY BUILDINGS, AND MAP GENERATION METHODS AND SYSTEMS FOR ROBOT OPERATION

(71) Applicant: NAVER CORPORATION, Seongnam-si (KR)

(72) Inventors: Ka Hyeon KIM, Seongnam-si (KR); Hak Seung CHOI, Seongnam-si (KR); Yo Han CHO, Seongnam-si (KR); Young Hwan YOON, Seongnam-si (KR); Seung Hyun YU, Seongnam-si (KR); Su Won CHAE, Seongnam-si (KR)

(73) Assignee: NAVER CORPORATION, Seongnam-si (KR)

(21) Appl. No.: 18/980,678

(22) Filed: Dec. 13, 2024

Related U.S. Application Data
(63) Continuation of application No. PCT/KR2023/004438, filed on Apr. 3, 2023.

(30) Foreign Application Priority Data
Jun. 14, 2022 (KR) 10-2022-0072464

(51) Int. Cl. G01C 21/00; G01C 21/20; G05D 1/246; G05D 107/60; G06F 3/0482

(52) U.S. Cl. CPC G01C 21/383; G01C 21/206; G05D 1/246; G05D 2107/60; G06F 3/0482

(57) ABSTRACT

A map generation method and system for robot operation. The map generation method including receiving a map editing request for a specific floor among a plurality of floors of a building, providing an editing interface on a display unit of an electronic device in response to the map editing request, the editing interface including at least a part of a specific map corresponding to the specific floor, allocating at least one graphic object on the specific map based on editing information received from the electronic device, and updating the specific map on a cloud server based on completion of the allocating such that robots travel through the specific floor according to an attribute of the at least one graphic object.

### CROSS-REFERENCE TO RELATED APPLICATIONS

This U.S. non-provisional application is a continuation application of, and claims the benefit of priority under 35 U.S.C. § 365(c) to, International Application No. PCT/KR2023/004438, filed Apr. 3, 2023, which claims priority to Korean Application No. 10-2022-0072464, filed Jun. 14, 2022, the entire contents of each of which are hereby incorporated by reference.

### TECHNICAL FIELD

The inventive concepts relate to a map generation method and system for robot operation, in which a robot providing services within a building is capable of preparing a map that may be utilized for planning a global movement path and a local movement path conveniently and efficiently.

### BACKGROUND

With the advancement of technology, various service devices are emerging, particularly in recent times, there has been active development of technology for robots that perform various tasks or services.

Further, in recent years, with the advancements in artificial intelligence technology, cloud technology, and other related fields, it has become possible to control the robots with greater precision and safety. As a result, the utility and applications of the robots are gradually increasing. In particular, due to the advancement in technology, the robots have reached a level where they may safely coexist with humans in indoor spaces.

Accordingly, recently, the robots are replacing human tasks or jobs, and there is active research on various methods in which the robots directly provide services to humans, especially in indoor spaces.

For example, in public places such as airports, train stations, and shopping malls, the robots are providing guidance services, while in restaurants, robots are offering serving services. Further, in office spaces, residential complexes, and the like, the robots are providing delivery services for mail, packages, and more. In addition, the robots are providing various services such as cleaning services, security services, and logistics services. The types and scope of services offered by the robots are expected to increase exponentially in the future, and the level of service provision is also anticipated to continue advancing.

These robots provides various services not only in outdoor spaces but also within the indoor spaces of buildings such as offices, apartments, shopping malls, schools, hospitals, and recreational facilities. In this case, the robots are controlled to move within the indoor spaces of buildings and offer a wide range of services.

In order for a plurality of robots providing services within a building to travel efficiently, a map should be accurately prepared for use in planning the global movement path and local movement path of the robot, reflecting the characteristics and situations of zones within the building.

### SUMMARY

A map generation method and system for robot operation according to the inventive concepts is directed to providing a user environment that allows for the intuitive and convenient preparation of a map utilized for the travel of a robot providing services within a building. Some example embodiments provide a higher level of service using robots within a building by allowing a user to accurately prepare a map for robot operation. For example, the map may be prepared by conveniently and efficiently reflecting the characteristics and situations of zones within the building.

Specifically, the map generation method and system for robot operation according to the inventive concepts is directed to providing a user environment that allows for the preparation of a map used for the travel of a robot on the basis of each of the plurality of floors included in the building.

More specifically, the map generation method and system for robot operation according to the inventive concepts is directed to providing a user environment that allows for the convenient allocation of areas with various types on the map so as to control the operation of the robot on an area-by-area basis.

Further, the map generation method and system for robot operation according to the inventive concepts is directed to providing a user environment that allows for the convenient and flexible preparation of a node map, by reflecting the traveling path of a robot, the operation of the robot, and facilities placed within the building.

Further, the map generation method and system for robot operation according to the inventive concepts is directed to providing a map that may be intuitively recognized by the user.

Further, the inventive concepts are directed to providing a robot-friendly building where robots and people coexist, offering useful services to people.

Further, the robot-friendly building according to the inventive concepts may expand the types and scope of services that the robot is capable of providing by providing various robot-friendly facility infrastructure available for use by the robot.

Further, the robot-friendly building according to the inventive concepts is capable of managing the travel of a robot providing services in a more systematic manner by organically controlling a plurality of robots and facility infrastructure using a cloud system that interworks with the plurality of robots. Therefore, the robot-friendly building according to the inventive concepts may provide various services to humans more safely, quickly, and accurately.

Further, the robot applied to the building according to the inventive concepts may be implemented in a brainless form controlled by the cloud server, according to which a large number of robots placed in the building may be manufactured at a low cost without expensive sensors, and may be controlled with high performance and high precision.

There is provided a method of generating a map, according to the inventive concepts. The method may include receiving a map editing request for a specific floor among a plurality of floors of a building, providing an editing interface on a display unit of an electronic device in response to the map editing request, the editing interface including at least a part of a specific map corresponding to the specific floor, allocating at least one graphic object on the specific map based on editing information received from the electronic device, and updating the specific map on a cloud server based on completion of the allocating such that robots travel through the specific floor according to an attribute of the at least one graphic object.

Further, there is provided a method of generating a map, according to the inventive concepts. The method may include receiving a map editing request for a specific floor among a plurality of floors of a building, providing an editing interface on a display unit of an electronic device in response to the map editing request, the editing interface including at least a part of a specific map corresponding to the specific floor, allocating at least one node on the specific map based on editing information received from the electronic device, and updating the specific map on a cloud server based on completion of the allocating such that robots travel the specific floor along the at least one node allocated on the specific map, or perform an operation defined at the at least one node on the specific floor.

Further, there is provided a system for generating a map, according to the inventive concepts. The system may include a communication unit configured to receive a map editing request for a specific floor among a plurality of floors of a building, and processing circuitry configured to provide an editing interface on a display unit of an electronic device in response to the map editing request, the editing interface including at least a part of a specific map corresponding to the specific floor, allocate at least one graphic object on the specific map based on editing information received from the electronic device, and update the specific map on a cloud server based on completion of the allocation of the at least one graphic object such that robots travel through the specific floor according to an attribute of the at least one graphic object.

Further, there is provided a non-transitory computer-readable recording medium storing a program including instructions that, when executed by one or more processors in a system, cause the system to receive a map editing request for a specific floor among a plurality of floors of a building, provide an editing interface on a display unit of an electronic device in response to the map editing request, the editing interface including at least a part of a specific map corresponding to the specific floor, allocate at least one graphic object on the specific map based on editing information received from the electronic device, and update the specific map on a cloud server based on completion of the allocation of the at least one graphic object such that robots travel through the specific floor according to an attribute of the at least one graphic object.

Further, there is provided a building in which a plurality of robots provide services. The building may include a plurality of floors having an indoor space where the robots coexist with people, and a communication unit configured to perform communication between the robots and a cloud server, wherein the cloud server is configured to perform control of the robots based on a building map generated through an editing interface, the building map is generated by receiving a map editing request for a specific floor among the plurality of floors, providing an editing interface on a display unit of an electronic device in response to the map editing request, the editing interface including at least a part of a specific map corresponding to the specific floor, and allocating at least one graphic object on the specific map based on editing information received from the electronic device, and updating the specific map on the cloud server based on completion of the allocation of the at least one graphic object such that the robots travel through the specific floor according to an attribute of the at least one graphic object.

The map generation method and system for robot operation according to the inventive concepts may provide an editing interface that includes at least a part of the specific map corresponding to a specific floor on the display unit of an electronic device in response to receiving a map editing request for the specific floor among the plurality of floors in the building. Therefore, the user may generate and edit each floor-specific map for a building configured with a plurality of floors. Accordingly, the user may generate and correct each floor-customized maps by reflecting the characteristics of each floor in a building configured with a plurality of floors.

Further, the map generation method and system for robot operation according to the inventive concepts may allocate a graphic object on the specific map included in the editing interface on the basis of editing information received from an electronic device. Therefore, since the user may prepare and edit the map simply by allocating graphic objects in the editing interface, even an unskilled user may conveniently and easily prepare and edit the map.

Further, the map generation method and system for robot operation according to the inventive concepts may update a specific map allocated with graphic objects to the cloud server so that the robots may travel on the specific floor according to the attributes of the graphic objects allocated on the specific map. Therefore, the robot may efficiently travel by following a global plan on the basis of a map that reflects interactions between robots, between robots and humans, and between robots and various facility infrastructure placed in the building, without the need to process complex environments.

Further, the robot-friendly building according to the inventive concepts may use technological convergence in which robotics, autonomous driving, AI, cloud technologies are fused and connected and provide a new space where these technologies, robots, and facility infrastructure provided in the building are organically combined.

Further, the robot-friendly building according to the inventive concepts is capable of systematically managing the travel of a robot providing services in a more systematic manner by organically controlling a plurality of robots and facility infrastructure using the cloud server that interworks with the plurality of robots. Therefore, the robot-friendly building according to the inventive concepts may provide various services to humans more safely, quickly, and accurately.

Further, the robot applied to the building according to the inventive concepts may be implemented in a brainless form controlled by the cloud server, according to which a large number of robots placed in the building may be manufactured at a low cost without expensive sensors, and may be controlled with higher performance and higher precision.

Furthermore, in the building according to the inventive concepts, robots and humans may coexist naturally in the same space (or similar spaces) by controlling the travel of the robots to take into account humans, in addition to taking into account tasks allocated to the plurality of robots placed in the building and a situation in which the robots are moving.

Further, in the building according to the inventive concepts, by performing various controls to prevent (or reduce) accidents by robots and respond to unexpected situations, it is possible to instill in humans the perception that robots are friendly and safe, rather than dangerous.

### BRIEF DESCRIPTION OF THE DRAWINGS

FIGS. 1, 2, and 3 are conceptual views for describing a robot-friendly building according to some example embodiments.

FIGS. 4, 5, and 6 are conceptual views for describing a robot traveling in the robot-friendly building according to some example embodiments and a system for controlling various facilities provided in the robot-friendly building.

FIGS. 7 and 8 are conceptual views for describing a facility infrastructure provided in the robot-friendly building according to some example embodiments.

FIGS. 9 to 11 are conceptual views for describing a method of estimating a position of a robot traveling in the robot-friendly building according to some example embodiments.

FIG. 12 is a conceptual view for describing a map generation system for robot operation according to some example embodiments.

FIG. 13 is a flowchart for describing a method of generating a map for robot operation according to some example embodiments.

FIGS. 14 and 15 are conceptual views for describing an editing interface provided in some example embodiments.

FIG. 16 is a conceptual view for describing a method of generating a map using a point cloud technique in some example embodiments.

FIGS. 17A, 17B, and 18 are conceptual views for describing an area graphic object according to some example embodiments.

FIGS. 19A, 19B, 20, 21, and 22 are conceptual views for describing a node graphic object according to some example embodiments.

FIGS. 23A, 23B, 23C, 23D, 23E, 23F and 24 are conceptual views for describing a zone according to some example embodiments.

FIGS. 25A and 25B are conceptual views for describing a method of filtering a graphic object on an editing interface of some example embodiments.

### DETAILED DESCRIPTION

Hereinafter, some example embodiments disclosed in the present specification will be described in detail with reference to the accompanying drawings. The same or similar constituent elements are assigned with the same reference numerals (or similar reference numerals) regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of some example embodiments disclosed in the present specification, the specific descriptions of publicly known related technologies will be omitted when it is determined that the specific descriptions may obscure the subject matter of some example embodiments disclosed in the present specification. In addition, it should be interpreted that the accompanying drawings are provided only to allow those skilled in the art to easily understand some example embodiments disclosed in the present specification, and the technical spirit disclosed in the present specification is not limited by the accompanying drawings, and includes all alterations, equivalents, and alternatives that are included in the spirit and the technical scope of some example embodiments.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element may be coupled or connected directly to another constituent element, and an intervening constituent element may also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, operations, constituent elements, and components described in the specification or a combination thereof, and do not exclude a possibility of the existence or addition of one or more other characteristics, numbers, operations, constituent elements, and components, or a combination thereof in advance.

Some example embodiments relate to a robot-friendly building, and proposes a robot-friendly building in which humans and robots may safely coexist, and in which robots may provide beneficial services within the building.

More specifically, some example embodiments provide a method of providing useful services to humans using robots, robot-friendly infrastructure, and various systems that control the same. In the building according to some example embodiments, humans and a plurality of robots may coexist, and various infrastructures (or facility infrastructures) may be provided to allow the plurality of robots to move freely within the building.

In some example embodiments, the building is a structure (e.g., a brick and mortar building) made for continuous habitation, living, working, etc. and may have various forms, such as a commercial building, an industrial building, an institutional building, a residential building, etc. In addition, the building may be a multi-story building having a plurality of floors, and a single-story building as opposed to the multi-story building. However, in some example embodiments, an infrastructure or facility infrastructure applied to the multi-story building is described as an example for convenience of description.

In some example embodiments, an infrastructure or facility infrastructure may be a facility provided in a building for the provision of services, the movement of robots, the maintenance of functionality, the maintenance of cleanliness, and the like, which may be of various types and forms. For example, an infrastructure in a building may include mobility facilities (e.g., robotic pathways, elevators, escalators, etc.), charging facilities, communication facilities, cleaning facilities, structures (e.g., stairs, etc.), etc. In this specification, these facilities are referred to as facilities, infrastructure, or facility infrastructure, and in some cases the terms are used interchangeably.

Further, in the building according to some example embodiments, at least one of the building, various facility infrastructures provided in the building, and the robot may be controlled in conjunction with each other so that the robot is able to safely and accurately provide various services in the building.

Some example embodiments provide a building equipped with various facility infrastructures that is capable of providing a plurality of robots to travel within the building and provide mission (or task) specific services, and supporting waiting or charging functions as needed (or otherwise, used), as well as repair and cleaning functions for the robots. The building according to some example embodiments provides an integrated solution (or a system) for robots, and the building may be referred to by various modifiers. For example, the building according to some example embodiments may be described in various ways, such as: i) a building having infrastructure used by robots, ii) a building having robot-friendly infrastructure, iii) a robot-friendly building, iv) a building where robots and humans live together, v) a building providing various services using robots, and the like.

The meaning of “robot-friendly” in some example embodiments is a building in which robots coexist, and more specifically, may mean that robots are allowed to travel, that robots provide services, that a facility infrastructure is established that robots are able to use, or that a facility infrastructure is established that provides functions required (or otherwise, performed) by robots (e.g., charging, repair, cleaning, etc.). In this case, “robot-friendly” in some example embodiments may be used in the meaning of having an integrated solution for the coexistence of robots and humans.

Hereinafter, some example embodiments will be described in more detail with reference to the accompanying drawings.

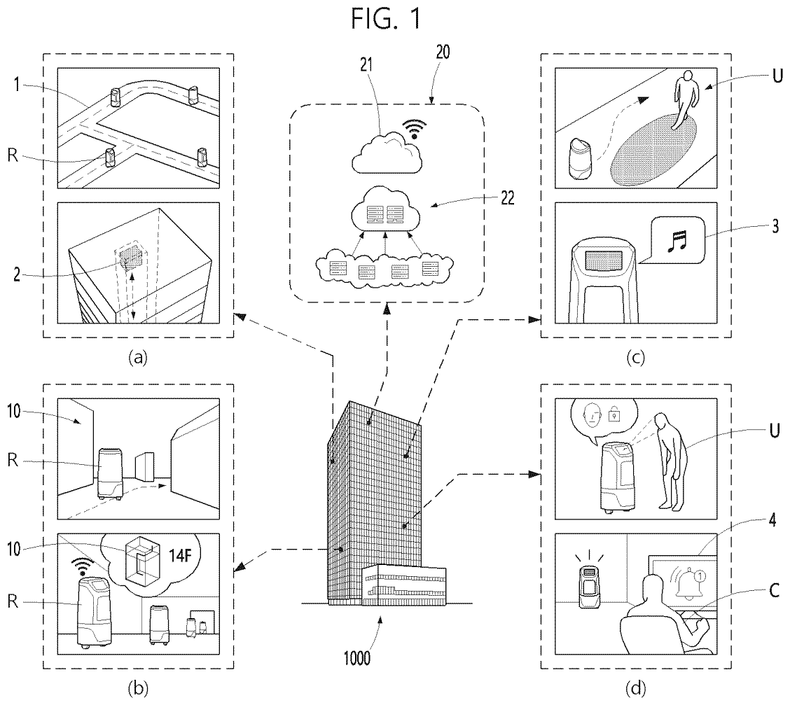

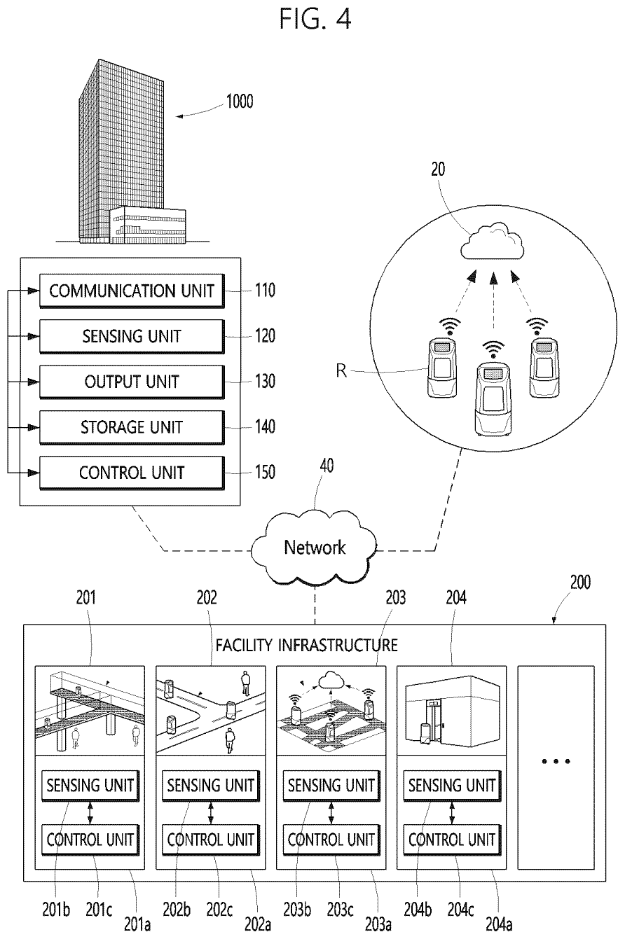

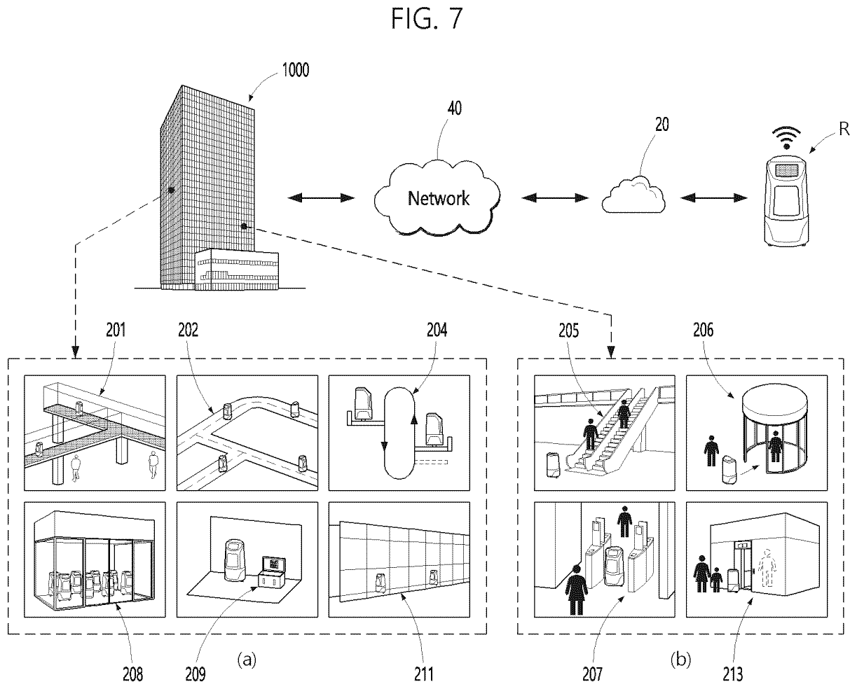

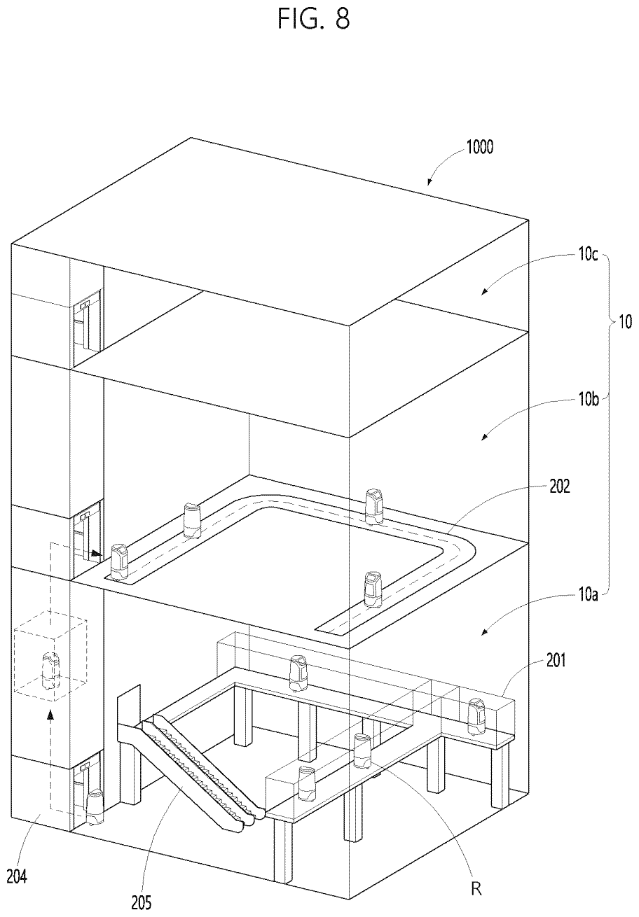

FIGS. 1, 2, and 3 are conceptual views for describing a robot-friendly building according to some example embodiments, and FIGS. 4, 5, and 6 are conceptual views for describing a robot traveling in the robot-friendly building according to some example embodiments and a system for controlling various facilities provided in the robot-friendly building. Further, FIGS. 7 and 8 are conceptual views for describing a facility infrastructure provided in the robot-friendly building according to some example embodiments.

First, for convenience of description, the representative reference numerals will be defined.

In some example embodiments, a building is given the reference numeral “1000” and a space (interior space or interior area) of the building 1000 is given the reference numeral “10” (see FIG. 8). Further, interior spaces corresponding to each of a plurality of floors constituting interior spaces of the building 1000 are given the reference numerals 10a, 10b, 10c, and the like (see FIG. 8). In some example embodiments, the interior space or the interior area, is a concept as opposed to an exterior of the building, meaning an interior of the building protected by an exterior wall, and is not limited to meaning a space.

Further, in some example embodiments, robots are given the reference numerals “R”, and all references to robots in the drawings or specification may be understood as robots R, even if no reference numerals are given to the robots.

Furthermore, in some example embodiments, a human or a person is given the reference numeral “U”, and a human or a person may be referred to as a dynamic object. In this case, the dynamic object does not necessarily refer to a human, but may be taken to include an animal such as a dog or a cat, or at least one other robot (e.g., a user's personal robot, a robot providing another service, etc.), a drone, a cleaner (e.g., a robot cleaner), or any other object capable of moving.

The building (building, structure, edifice, 1000) described in some example embodiments is not limited to any particular type and may refer to a structure built for human occupancy, work, animal husbandry, or storage.

For example, the building 1000 may be an office, an office building, an apartment, a mixed-use apartment building, a house, a school, a hospital, a restaurant, a government building, and the like, and some example embodiments may be applicable to these various types of buildings.

As illustrated in FIG. 1, in the building 1000 according to some example embodiments, the robots may travel and provide various services.

A plurality of robots of one or more different types may be positioned within the building 1000, and these robots may, under control of the server 20, travel within the building 1000, provide services, and use the various facility infrastructure provided in the building 1000.

In some example embodiments, the server 20 may exist at a variety of positions. For example, the server 20 may be positioned in at least one of an interior of the building 1000 and/or an exterior of the building 1000. That is, at least a portion of the server 20 may be positioned inside the building 1000, and a remaining portion thereof may be positioned outside the building 1000. Alternatively, the server 20 may be positioned entirely inside the building 1000, or only outside the building 1000. Accordingly, in some example embodiments, there are no particular limitations on the specific location of the server 20.

Further, in some example embodiments, the server 20 may be configured to use at least one of a server in a cloud computing method (cloud server 21) and a server in an edge computing method (edge server 22). Further, in addition to the cloud computing or edge computing methods, the server 20 may be applied in some example embodiments as long as the server uses a method that enables control of the robot.

The server 20 according to some example embodiments may, in some cases, perform control of at least one of the robots and the facility infrastructure provided in the building 1000 by mixing the server 21 of the cloud computing method with the edge computing method.

Examining the cloud server 21 and edge server 22 in more detail, the edge server 22 is an electronic device that may operate as the brain of the robot R. That is, each edge server 22 may control at least one robot R wirelessly. In this case, the edge server 22 may control the robot R on the basis of a designated control cycle. The control cycle may be determined as a sum of a time given to process data related to the robot R and a time given to provide a control command to the robot R. The cloud server 21 may manage at least one of the robot R and/or the edge server 22. In this case, the edge server 22 may operate as a server in correspondence to the robot R, and as a client in correspondence to the cloud server 21.

The robot R and the edge server 22 may communicate wirelessly, and the edge server 22 and the cloud server 21 may communicate either wired or wirelessly. In this case, the robot R and the edge server 22 may communicate through a wireless network that supports ultra-reliable and low latency communications (URLLC). For example, the wireless network may include at least one of a 5G network or WiFi-6 (WiFi ad/ay). Here, the 5G network may not only support ultra-reliable and low latency communications but also have characteristics that enable enhanced mobile broadband (eMBB) and massive machine type communications (mMTC). For example, the edge server 22 may include a mobile edge computing or multi-access edge computing (MEC) server and may be placed at a base station. Therefore, the latency time due to communication between the robot R and the edge server 22 may be reduced. In this case, in the control cycle of the edge server 22, as the time given to provide a control command to the robot R is reduced, the time given to process data may be extended. The edge server 22 and the cloud server 21 may communicate through a wireless network, such as the Internet, for example.

In some cases, a plurality of edge servers may be connected through a wireless mesh network, and the functions of the cloud server 21 may be distributed across the plurality of edge servers. In this case, for a certain robot R, one of the edge servers may operate as the edge server 22 for the robot R, while at least another one of the edge servers may operate as the cloud server 21 for the robot R in cooperation with one of the edge servers.

A network or communication network formed in the building 1000 according to some example embodiments may include communication among at least one robot R configured to collect data, at least one edge server 22 configured to control the robot R wirelessly, and/or the cloud server 21 connected to the edge server 22 and configured to manage the robot R and the edge server 22.

The edge server 22 may be configured to receive the data wirelessly from the robot R, determine a control command on the basis of the data, and transmit the control command wirelessly to the robot R.

According to some example embodiments, the edge server 22 may judge whether to cooperate with the cloud server 21 on the basis of the data, and when it is judged that cooperation with the cloud server 21 is unnecessary, may be configured to determine the control command and transmit the control command within a designated control cycle.

According to some example embodiments, when it is judged that cooperation with the cloud server 21 is required (or otherwise, to be performed), the edge server 22 may be configured to communicate with the cloud server 21 on the basis of the data to determine the control command.

The robot R may be driven according to a control command. For example, the robot R may move a position or change a posture by changing a motion, and may perform a software update.

In some example embodiments, for convenience of description, the server 20 will be collectively referred to as a “cloud server” and will be given the reference numeral “20”. It should be noted that the cloud server 20 may also be replaced by the term edge server 22 in edge computing.

Further, the term “cloud server” may be varied to include terms such as a cloud robot system, a cloud system, a cloud robot control system, a cloud control system, and the like.

The cloud server 20 according to some example embodiments is capable of performing integrated control of a plurality of robots traveling in the building 1000. That is, the cloud server 20 may: i) perform monitoring of the plurality of robots R located in the building 1000; ii) allocate missions (or tasks) to the plurality of robots R; iii) directly control facility infrastructure provided in the building 1000 to enable the plurality of robots R to successfully perform the missions; and/or iv) communicate with a control system that controls the facility infrastructure to enable the facility infrastructure to be controlled.

Further, the cloud server 20 may identify state information on the robots positioned in the building and provide (or support) various functions required (or otherwise, performed) by the robots. Here, different functions may include a charging function for robots, a cleaning function for contaminated robots, and a waiting function for robots that have completed missions.

The cloud server 20 may control the robots to use various facility infrastructure provided in the building 1000 in order to provide various functions for the robots. Further, the cloud server may directly control the facility infrastructure provided in the building 1000, or may allow the facility infrastructure to be controlled through communication with the control system that controls the facility infrastructure, in order to provide various functions for the robots.

As described above, the robots controlled by the cloud server 20 may travel in the building 1000 and provide various services.

The cloud server 20 may perform various controls based on information stored in a database, and some example embodiments do not have particular limitations on types and locations of the database. The term database may be freely modified and used as long as it refers to the term for the means by which information is stored, such as a memory, a storage unit, a storage, a cloud storage, an external storage, an external server, etc. Hereinafter, the term “database” will be used throughout.

The cloud server 20 according to some example embodiments may perform distributed control of the robots on the basis of various standards, such as types of services provided by the robots, types of control of the robots, and the like, in which case the cloud server 20 may have subordinate sub-servers of a sub-concept.

Further, the cloud server 20 according to some example embodiments may control the robot traveling in the building 1000 on the basis of various artificial intelligence algorithms.

Further, the cloud server 20 performs artificial intelligence-based learning that uses data collected in the process of controlling the robot as learning data and utilizes the learning data to control the robot, so that the more control is performed on the robot, the more accurately and efficiently the robot may be operated. That is, the cloud server 20 may be configured to perform deep learning or machine learning. In addition, the cloud server 20 may perform deep learning or machine learning through simulation or the like, and perform control of the robot using the resulting artificial intelligence model.

The building 1000 may be provided with various facility infrastructures for traveling of the robot, providing functions of the robot, maintaining functions of the robot, performing missions of the robot, and/or coexistence of the robot and human.

For example, as illustrated in (a) of FIG. 1, the building 1000 may be provided with various facility infrastructures 1 and 2 that may support the traveling (or moving) of the robot R. These facility infrastructures 1 and 2 may support horizontal movement of the robot R within a floor of the building 1000, or may support vertical movement of the robot R between different floors of the building 1000. As described above, the facility infrastructures 1 and 2 may include a transportation system to support the movement of the robot. The cloud server 20 may allow the robot R to move within the building 1000 to provide services by controlling the robot R to use these various facility infrastructures 1 and 2, as illustrated in (b) of FIG. 1.

The robots according to some example embodiments may be controlled on the basis of at least one of the cloud server 20 and a control unit provided on the robot itself, to perform to travel within the building 1000 and/or to provide services corresponding to the allocated mission.

Further, as illustrated in (c) of FIG. 1, the building according to some example embodiments is a building in which robots and humans coexist, and the robots may be configured to travel by avoiding obstacles such as humans U, objects used by humans (e.g., strollers, carts, etc.), and animals, and may in some cases be configured to output notification information 3 related to the traveling of the robots. The traveling of the robot may be performed to avoid obstacles on the basis of at least one of the cloud server 20 and the control unit provided on the robot. The cloud server 20 may perform control of the robot to move within the building 1000 to avoid obstacles on the basis of information received through various sensors provided on the robot (e.g., a camera (an image sensor), a proximity sensor, an infrared sensor, etc.).

In addition, the robot traveling in the building through processes of (a) to (c) of FIG. 1 may be configured to provide services to humans or target objects present in the building, as illustrated in (d) of FIG. 1.

The types of services provided by the robot may vary from one robot to another. That is, there may be different types of robots for different purposes, and the robots may have different structures for different purposes, and the robots may be equipped with a program that is appropriate for the purpose.

For example, the building 1000 may have robots placed to provide at least one of delivery, logistics operations, guidance, interpretation, parking, security, crime prevention (or reduction), guarding, policing, cleaning, sanitizing, disinfecting, laundry, food preparation, serving, fire suppression, medical assistance, entertainment services, etc. The services provided by the robots may vary in addition to the examples listed above.

The cloud server 20 may allocate appropriate missions to the robots, taking into account respective uses of the robots, and perform control of the robots so that the allocated missions are carried out.

At least some of the robots described in some example embodiments may travel or perform missions under the control of the cloud server 20, in which case the amount of data processed by the robots themselves to travel or perform missions may be minimized (or reduced). In some example embodiments, such a robot may be referred to as a brainless robot. This brainless robot may rely on control of the cloud server 20 for at least some of the control in carrying out activities such as traveling, performing missions, charging, waiting, cleaning, etc. within the building 1000.

However, in the present specification, the brainless robots are not named separately, and all robots are referred to as “robots”.

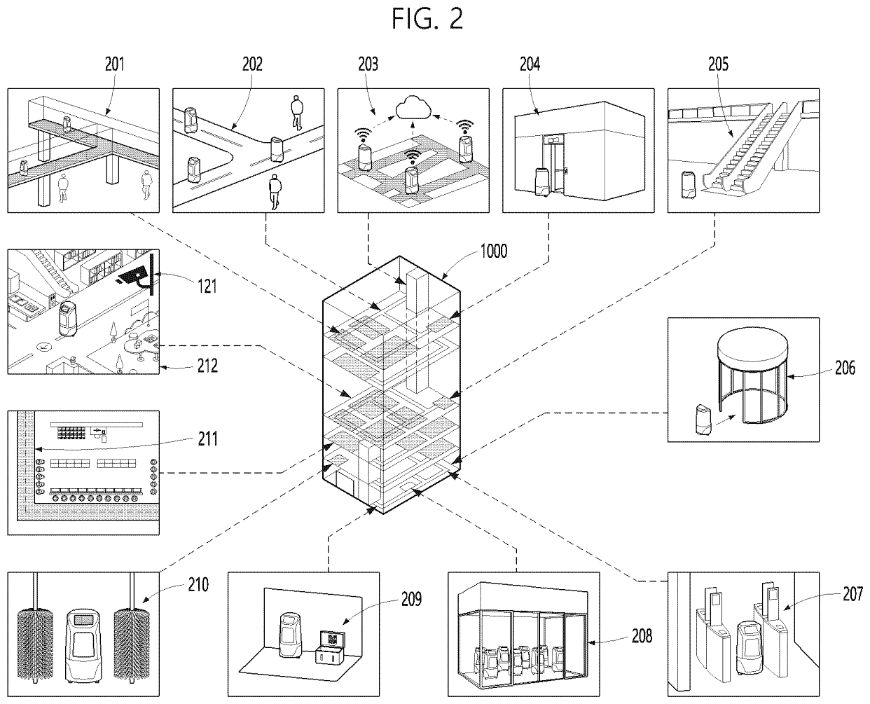

As described above, the building 1000 according to some example embodiments may be provided with various facility infrastructures available to the robot, and as illustrated in FIGS. 2, 3, and 4, the facility infrastructure may be placed within the building 1000 to support the movement (or travel) of the robot or provide various functions to the robot through interworking with the building 1000 and the cloud server 20.

More specifically, the facility infrastructure may include facilities to support the movement of robots within the building.

The facilities supporting the movement of robots may have either type of a robot-exclusive facility used solely by robots or a shared facility used jointly by robots and people.

Further, the facilities supporting the movement of robots may support horizontal movement or vertical movement of the robots. The robots may move horizontally or vertically within the building 1000 using the facilities. Horizontal movement refers to movement within the same floor (or similar floors), while vertical movement may refer to movement between different floors. Therefore, in some example embodiments, movement up and down within the same floor (or similar floors) may be referred to as horizontal movement.

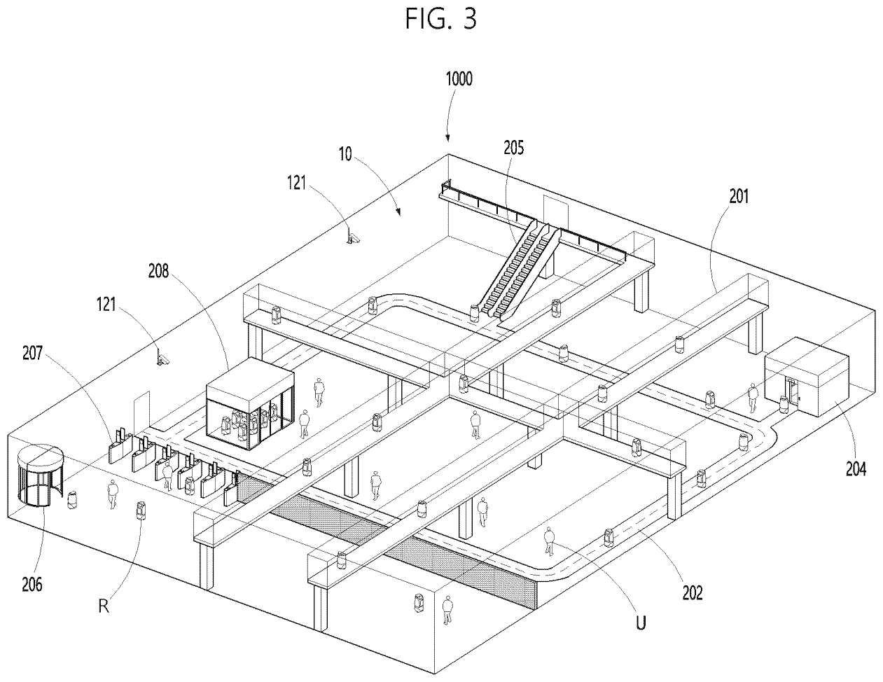

The facilities supporting the movement of robots may vary, and for example, as illustrated in FIGS. 2 and 3, the building 1000 may provide robot passages (robot roads 201, 202, and 203) that support horizontal movement of the robots. Such a robot passage may include a robot-exclusive passage used solely by robots. The robot-exclusive passage may be configured to fundamentally prevent (or reduce) human access, but is not necessarily limited thereto. That is, the robot-exclusive passage may be configured to allow human passage or access.

As illustrated in FIG. 3, the robot-exclusive passage may be configured as at least one of a first exclusive passage (or first type of passage 201) and a second exclusive passage (or second type of passage 202). The first exclusive passage and the second exclusive passage 201 and 202 may be provided together on the same floor (or similar floors) or on different floors.

For another example, as illustrated in FIGS. 2 and 3, the building 1000 may provide moving means 204 and 205 to support the vertical movement of the robot. Such moving means 204 and 205 may include at least one of an elevator or an escalator. The robot may move between different floors using the elevator 204 or escalator 205 provided in the building 1000.

Such an elevator 204 or escalator 205 may be configured exclusively for robots or shared for use with people.

For example, the building 1000 may include at least one of a robot-exclusive elevator or a shared elevator. Similarly, further, the building 1000 may include at least one of a robot-exclusive escalator or a shared escalator.

The building 1000 may be provided with moving means that may be utilized for both vertical and horizontal movement. For example, moving means in the form of a moving walkway may support horizontal movement within a floor or vertical movement between floors for the robot.

The robot may move horizontally or vertically within the building 1000 under its own control or under the control of the cloud server 20, in which case the robot may use various facilities that support movement of the robot to move within the building 1000.

Further, the building 1000 may include at least one of an entrance door 206 (or automatic door) and/or an access control gate 207, which control access to the building 1000 or a specific area within the building 1000. At least one of the entrance door 206 and/or the access control gate 207 may be configured to be usable by the robot. The robot may be configured to pass through the entrance door (or automatic door 206) or access control gate 207 under the control of the cloud server 20.

The access control gate 207 may be named in various ways, such as a speed gate.

Further, the building 1000 may further include a waiting space facility 208 corresponding to a waiting space where the robot waits, a charging facility 209 for charging the robot, and/or a cleaning facility 210 for cleaning the robot.

Further, the building 1000 may include a facility 211 specialized for a specific service provided by the robot, for example, a facility for delivery services.

In addition, the building 1000 may include a facility for monitoring the robot (see reference numeral 212), and an example of such a facility may include various sensors (e.g., a camera (or image sensor 121)).

As examined together with FIGS. 2 and 3, the building 1000 according to some example embodiments may be provided with various facilities for service provision, robot movement, travel, function maintenance, cleanliness maintenance, etc.

As illustrated in FIG. 4, the building 1000 according to some example embodiments is interconnected with the cloud server 20, the robot R, and the facility infrastructure 200 via a network 40, allowing robots to provide various services within the building 1000, as well as to appropriately use the facilities for this purpose.

Here, “interconnected” may mean that various data and control commands related to services provided within the building, robot movement, travel, function maintenance, cleanliness maintenance, etc. are transmitted and received in a unidirectional or bidirectional manner from at least one entity to at least another one entity through a network (or communication network).

Here, the entity may be the building 1000, the cloud server 20, the robot R, the facility infrastructure 200, etc.

Further, the facility infrastructure 200 may include at least one of each of various facilities examined with FIGS. 2 and 3 (see reference numerals 201 to 213) and/or control systems (201a, 202a, 203a, 204a, 205a, 206a, 207a, 208a, 209a, 210a, 211a, 212a and/or 213a) respectively included in each facility control system 201a, 202a, 203a, 204a, . . . for controlling the various facilities.

The robot R traveling in the building 1000 is configured to communicate with the cloud server 20 through the network 40 and may provide services within the building 1000 under the control of the cloud server 20.

More specifically, the building 1000 may include a building system 1000a that communicates with various facilities provided in the building 1000 or directly controls those facilities. As illustrated in FIG. 4, the building system 1000a may include a communication unit 110, a sensing unit 120, an output unit 130, a storage unit 140, and/or a control unit 150.

The communication unit 110 may form at least one of a wired communication network or a wireless communication network within the building 1000, thereby connecting: i) the cloud server 20 and the robot R, ii) the cloud server 20 and the building 1000, iii) the cloud server 20 and the facility infrastructure 200, iv) the facility infrastructure 200 and the robot R, and/or v) the facility infrastructure 200 and the building 1000. That is, the communication unit 110 may perform as a medium for communication between different entities. Such a communication unit 110 may also be referred to as a base station or a router, and the communication unit 110 may form a communication network or a network within the building 1000 to enable the robot R, the cloud server 20, and the facility infrastructure 200 to communicate with each other.

In the present specification, being connected to the building 1000 through a communication network may refer to being connected to at least one constituent element included in the building system 1000a.

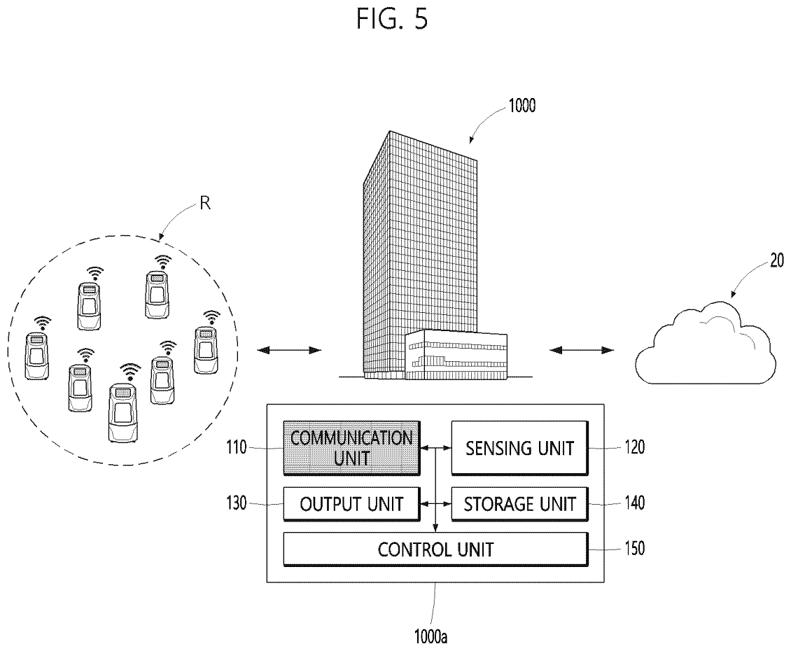

As illustrated in FIG. 5, a plurality of robots R placed in the building 1000 may be configured to be remotely controlled by the cloud server 20 by performing communication with the cloud server 20 through at least one of a wired communication network and a wireless communication network formed through the communication unit 110. Such a communication network, like a wired communication network or a wireless communication network, may be understood as the network 40.

As described above, the building 1000, the cloud server 20, the robot R, and the facility infrastructure 200 may form the network 40 on the basis of the communication network formed within the building 1000. The robot R, on the basis of such a network, may provide a service corresponding to an allocated mission by using various facilities provided in the building 1000 under the control of the cloud server 20.

The facility infrastructure 200 may include at least one of each of various facilities examined with FIG. 2 and FIG. 3 (see reference numerals 201 to 213) and control systems (201a, 202a, 203a, 204a, . . . ) that control the various facilities (this control system may also be referred to as a “control server”.)

As illustrated in FIG. 4, different types of facilities may be provided with their own unique control systems. For example, in case of a robot passage (or robot-exclusive passage, robot road, robot-exclusive road, 201, 202, and 203), there may exist control systems 201a, 202a, and 203a to independently control each robot passage 201, 202, or 203, and in case of an elevator (or robot-exclusive elevator 204), there may exist a control system 204a to control the elevator 204.

Such unique control systems for controlling the facilities may communicate with at least one of the cloud server 20, the robot R, or the building 1000 to perform appropriate control of each facility so that the robot R may use the facilities.

A sensing unit 201b, 202b, 203b, 204b, 205b, 206b, 207b, 208b, 209b, 210b, 211b, 212b and/or 213b respectively included in each facility control system 201a, 202a, 203a, 204a, . . . may be provided in the facility itself and configured to sense various information related to the facility.

Further, a control unit 201c, 202c, 203c, or 204c, . . . included in each facility control system 201a, 202a, 203a, or 204a, . . . may perform control for driving each facility and, through communication with the cloud server 20, may perform appropriate control to allow the robot R to use the facilities. For example, the control system 204a of the elevator 204 may control the elevator 204 to stop at the floor where the robot R is positioned, allowing the robot R to board the elevator 204 through communication with the cloud server 20.

At least apart of the control unit 201c, 202c, 203c, or 204c, . . . included in each facility control system 201a, 202a, 203a, or 204a, . . . may be positioned within the building 1000 along with each facility 201, 202, 203, or 204, . . . or positioned outside the building 1000.

Further, at least a part of the facilities included in the building 1000 according to some example embodiments may also be controlled by the cloud server 20 or by the control unit 150 of the building 1000. In this case, the facility may not be provided with a separate facility control system.

In the following description, each facility will be described by way of example as providing its own unique control system. However, as mentioned above, the role of the control system for controlling the facility may, of course, be replaced by the cloud server 20 or the control unit 150 of the building 1000. In this case, the term “control unit” 201c, 202c, 203c, or 204c, . . . of the facility control system described in the present specification may, of course, be expressed by replacing with the term “cloud server” 20 or “control unit” 150 (or control unit 150 of the building).

In FIG. 4, the constituent elements of each facility control system 201a, 202a, 203a, or 204a, . . . are for illustrative, and various constituent elements may be added or omitted depending on characteristics of each facility.

As described above, in some example embodiments, the robot (R), cloud server 20, and facility control systems 201a, 202a, 203a, and 204a, . . . use the facility infrastructure to provide various services within the building 1000.

In this case, the robot R primarily travels within the building to provide various services. To this end, the robot R may provide at least one of a body unit, a driving unit, a sensing unit, a communication unit, an interface unit, and/or a power supply unit.

The body unit includes a casing (such as casing, housing, or cover) that forms an exterior appearance. In some example embodiments, the casing may be divided into a plurality of parts, and various electronic components are embedded within a space formed by the casing. In this case, the body unit may be configured in different forms depending on the various services exemplified in some example embodiments. For example, in case of a robot providing delivery services, a storage compartment for holding items may be provided at an upper portion of the body unit. As another example, in case of a robot providing cleaning services, a suction port that uses vacuum to absorb dust may be provided at the lower portion of the body unit.

The driving unit is configured to perform a specific operation according to a control command transmitted by the cloud server 20.

The driving unit provides means for the body unit of the robot to move within a specific space in relation to travel. More specifically, the driving unit includes a motor and a plurality of wheels, which are combined together to perform the functions of traveling, switching direction, and rotating the robot R. As another example, the driving unit may be provided with at least one of an end effector, manipulator, or actuator to perform operations other than travel, such as pickup tasks, for example.

The sensing unit may include one or more sensors to sense at least one of information within the robot (particularly, the drive state of the robot), surrounding environmental information surrounding the robot, position information on the robot, or user information.

For example, the sensing unit may be provided with a camera (image sensor), proximity sensor, infrared sensor, laser scanner (LiDAR sensor), RGBD sensor, geomagnetic sensor, ultrasonic sensor, inertial sensor, UWB sensor, and/or others.

The communication unit of the robot is configured to transmit and receive wireless signals from the robot to perform wireless communication between the robot R and the communication unit of the building, between the robot R and other robots, or between the robot R and the control system of the facility. As such an example, the communication unit may be provided with a wireless Internet module, short-range communication module, position information module, and/or others.

The interface unit may be provided as a passage to connect the robot R with external devices. For example, the interface unit may be a terminal (charging terminal, connection terminal, power terminal), a port, a connector, or others. The power supply unit may be a device that receives external or internal power and supplies power to each constituent element included in the robot R. As another example, the power supply unit may be a device that generates electrical energy within the robot R and supplies the energy to each constituent element.

As described above, the robot R has primarily been described in the context of traveling within the building, but some example embodiments are not necessarily limited thereto. For example, the robot in some example embodiments may also take the form of a flying robot, such as a drone, operating within the building. More specifically, a robot providing guidance services may fly around a person within the building to provide guidance on the building.

The overall operation of the robot in some example embodiments may be controlled by the cloud server 20. In addition, the robot may be provided with a control unit separately as a subordinate controller to the cloud server 20. For example, the control unit of the robot receives control commands related to travel from the cloud server 20 and controls the driving unit of the robot accordingly. In this case, the control unit may use the data sensed by the sensing unit of the robot to calculate the torque or current to be applied to the motor. Using the calculated results, the motor and other components are driven by position controllers, speed controllers, current controllers or the like, allowing the robot to execute the control commands from the cloud server 20.

In some example embodiments, the building 1000 may include the building system 1000a for communicating with various facilities provided in the building 1000 or directly controlling those facilities. As illustrated in FIG. 4 and FIG. 5, the building system 1000a may include at least one of the communication unit 110, the sensing unit 120, the output unit 130, the storage unit 140, and/or the control unit 150.

The communication unit 110 may form at least one of a wired communication network or a wireless communication network within the building 1000, thereby connecting: i) the cloud server 20 and the robot R, ii) the cloud server 20 and the building 1000, iii) the cloud server 20 and the facility infrastructure 200, iv) the facility infrastructure 200 and the robot R, and/or v) the facility infrastructure 200 and the building 1000. That is, the communication unit 110 may perform as a medium for communication between different entities.

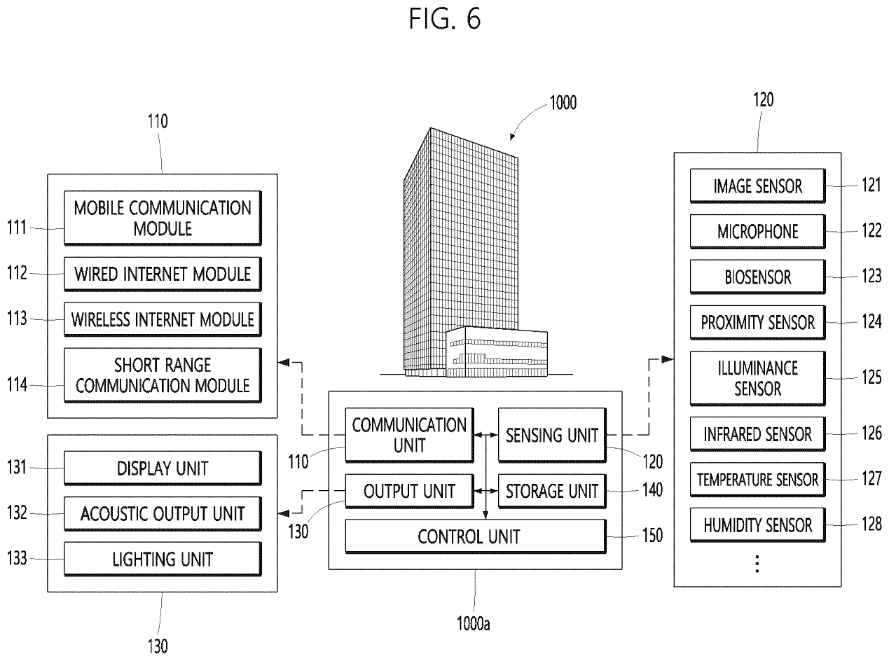

As illustrated in FIG. 5 and FIG. 6, the communication unit 110 may be configured to include at least one of a mobile communication module 111, wired Internet module 112, wireless Internet module 113, and/or short-range communication module 114.

The communication unit 110 may support various communication methods based on the communication modules listed above.

For example, the mobile communication module 111 may be configured to transmit and receive wireless signals with at least one of the building system 1000a, cloud server 20, robot R, or facility infrastructure 200 over a mobile communication network established according to technical standards or communication methods for mobile communications (e.g., 5G, 4G, global system for mobile communication (GSM), code division multiple access (CDMA), code division multiple access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), etc.). In this case, as a more specific example, the robot R may transmit and receive wireless signals with the mobile communication module 111 using the aforementioned communication unit of the robot R.

Next, the wired Internet module 112 may be configured to transmit and receive signals with at least one of the cloud server 20, robot R, or facility infrastructure 200, using a physical communication line as a medium, by way of providing communication in a wired manner.

Further, the wireless Internet module 113, as a concept including the mobile communication module 111, may refer to a module capable of wireless Internet access. The wireless Internet module 113 is placed within the building 1000 and is configured to transmit and receive wireless signals with at least one of the building system 1000a, cloud server 20, robot R, or facility infrastructure 200 over a communication network according to wireless Internet technologies.

Wireless Internet technologies may vary and include not only the communication technologies of the aforementioned mobile communication module 111, but also wireless local area network (WLAN), Wi-Fi, Wi-Fi Direct, digital living network alliance (DLNA), wireless broadband (WiBro), world interoperability for microwave access (WiMAX), etc. Further, in some example embodiments, the wireless Internet module 113 transmits and receives data according to at least one wireless Internet technology, in the range including Internet technologies not listed above.

Next, the short-range communication module 114 is intended for short-range communication and may perform communication with at least one of the building system 1000a, cloud server 20, robot R, or facility infrastructure 200 using at least one of Bluetooth™, radio frequency identification (RFID), infrared data association (IrDA), ultra wideband (UWB), ZigBee, near field communication (NFC), Wi-Fi, Wi-Fi Direct, or wireless universal serial bus (Wireless USB).

The communication unit 110 may include at least one of the communication modules described above, and these communication modules may be placed in various spaces within the building 1000 to form a communication network. With this communication network, i) the cloud server 20 and robot R, ii) the cloud server 20 and building 1000, iii) the cloud server 20 and facility infrastructure 200, iv) the facility infrastructure 200 and robot R, and/or v) the facility infrastructure 200 and building 1000 may be configured to communicate with each other.

Next, the building 1000 may include the sensing unit 120, which may be configured to include various sensors. At least part of the information sensed by the sensing unit 120 of the building 1000 may be transmitted to at least one of the cloud server 20, robot R, or facility infrastructure 200 through the communication network formed by the communication unit 110. At least one of the cloud server 20, robot R, or facility infrastructure 200 may use the information sensed by the sensing unit 120 to control the robot R or the facility infrastructure 200.

The types of sensors included in the sensing unit 120 may vary widely. The sensing unit 120 may be provided in the building 1000 and configured to sense various types of information related to the building 1000. The information sensed by the sensing unit 120 may be information on the robot R traveling within the building 1000, people positioned in the building 1000, obstacles, and more, and may also include various environmental information related to the building (e.g., temperature and humidity, etc.)

As illustrated in FIG. 5, the sensing unit 120 may include at least one of an image sensor 121, a microphone 122, a biosensor 123, a proximity sensor 124, an illuminance sensor 125, an infrared sensor 126, a temperature sensor 127, a humidity sensor 128, etc. According to some example embodiments, each of the sensing units (201b, 202b, 203b, 204b, 205b, 206b, 207b, 208b, 209b, 210b, 211b, 212b and 213b).

Here, the image sensor 121 may correspond to a camera. As examined in FIG. 3, a camera corresponding to the image sensor 121 may be placed within the building 1000. In this specification, the same reference numeral “121” as (or a similar reference numeral to) that of the image sensor 121 will be assigned to the camera.

There is no limitation on the number of cameras 121 placed in the building 1000. The types of cameras 121 placed in the building 1000 may vary, and as an example, the camera 121 placed in the building 1000 may be a closed circuit television (CCTV). Stating that the camera 121 is placed in the building 1000 may mean that the camera 121 is placed in the indoor space 10 of the building 1000.

Next, the microphone 122 may be configured to sense various sound information occurring within the building 1000.

The biosensor 123 is intended to sense biometric information and may sense biometric information on people or animals positioned in the building 1000 (e.g., fingerprint information, facial information, iris information, etc.)

The proximity sensor 124 may be configured to sense an object (such as a robot or person) that approaches or is positioned near the proximity sensor 124.

Further, the illuminance sensor 125 is configured to sense the illuminance around the illuminance sensor 125, while the infrared sensor 126, which is equipped with an LED, may use the LED to capture images of the building 1000 in dark indoor conditions or at night.

Further, the temperature sensor 127 senses the temperature around the temperature sensor 127, while the humidity sensor 128 may sense the humidity around the humidity sensor 128.

In some example embodiments, there are no particular limitations on the types of sensors that make up the sensing unit 120, as long as the functions defined by each sensor are implemented.

Next, the output unit 130 is a means for outputting at least one of visual, auditory, or tactile information to people or the robot R in the building 1000, and may include at least one of a display unit 131, an acoustic output unit 132, and/or a lighting unit 133. Such an output unit 130 may be placed at an appropriate position within the indoor space of the building 1000 as needed (or otherwise, used) or depending on the situation.

Next, the storage unit 140 may be configured to store various information related to at least one of the building 1000, the robot, and the facility infrastructure. In some example embodiments, the storage unit 140 may be provided within the building 1000 itself. In contrast, at least part of the storage unit 140 may refer to at least one of the cloud server 20 or an external database. That is, it may be understood that the storage unit 140 only needs to be (or otherwise, is) a space where various information according to some example embodiments is stored, without restrictions on the physical space.

Next, the control unit 150 serves as a means for performing overall control of the building 1000, and may control at least one of the communication unit 110, sensing unit 120, output unit 130, and/or storage unit 140. The control unit 150 may interwork with the cloud server 20 to perform control over the robot. Further, the control unit 150 may exist in the form of the cloud server 20. In this case, the building 1000 may be jointly controlled by the cloud server 20, which is a control means for the robot R. In contrast, the cloud server controlling the building 1000 may exist separately from the cloud server 20 that controls the robot R. In this case, the cloud server controlling the building 1000 and the cloud server 20 controlling the robot R may interwork with each other through mutual communication to provide services via the robot R, or may interwork for purposes such as moving the robot, maintaining functionality, maintaining cleanliness, etc. According to some example embodiments, operations described herein as being performed by the control unit 150, the server 20, the cloud server 21, the edge server 22, the robot R (e.g., the body unit, driving unit, sensing unit, communication unit, interface unit and/or power supply unit of the robot R) and/or the building system 1000a may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc. For example, the control unit of the building 1000 may also be referred to as a “processor,” which may be configured to process various commands by performing basic arithmetic, logic, and input/output calculations.

As described above, at least one of the building 1000, robot R, cloud server 20, or facility infrastructure 200 may form a network 40 based on the communication network, enabling various services using the robot to be provided within the building 1000.

As described above, in the building 1000 according to some example embodiments, the robot R, facility infrastructure 200 provided within the building, and cloud server 20 may be organically connected so that various services may be provided by the robot. At least part of the robot R, facility infrastructure 200, or cloud server 20 may exist in the form of a platform for establishing a robot-friendly building.

Hereinafter, with reference to the details of the building 1000, building system 1000a, facility infrastructure 200, and cloud server 20 described above, a more specific examination will be conducted regarding the process in which the robot R uses the facility infrastructure 200. In this case, the robot R may travel through the indoor space 10 of the building 1000 or use the facility infrastructure 200 to move for purposes such as performing mission (or providing services), travel, charging, cleanliness maintenance, and waiting. Further, the robot R may use the facility infrastructure 200.

As described above, the robot R, on the basis of a certain “purpose,” may travel through the indoor space of the building 1000 or use the facility infrastructure 200 to move in order to achieve that “purpose.” Further, the robot R may use the facility infrastructure 200.

In this case, the purpose that the robot needs to (or otherwise, does) achieve may be specified based on various causes. The purpose that the robot needs to (or otherwise, does) achieve may exist as a first type of purpose and a second type of purpose.

Here, the first type of purpose is intended for the robot to carry out the inherent mission of the robot, while the second type of purpose may be for the robot to perform missions or functions other than the inherent mission of the robot.

That is, the purpose that the robot needs to (or otherwise, does) achieve according to the first type may be a purpose for performing the inherent mission of the robot. This purpose may also be understood as the “mission (task)” of the robot.

For example, in case that the robot is a robot providing serving services, the robot may travel through the indoor space of the building 1000 or use the facility infrastructure 200 to move in order to achieve the purpose or mission of providing serving services. Further, the robot may use the facility infrastructure 200. In addition, in case that the robot is a robot providing path guidance services, the robot may travel through the indoor space of the building 1000 or use the facility infrastructure 200 to move in order to achieve the purpose or mission of providing path guidance services. Further, the robot may use the facility infrastructure 200.

In the building according to some example embodiments, a plurality of robots operating for different purposes may be positioned. That is, different robots capable of performing different missions may be placed in the building, and depending on the needs (or choices) of the building's administrator of the or various entities residing in the building, different types of robots may be placed in the building.

For example, the building may have robots placed to provide at least one of delivery, logistics operations, guidance, interpretation, parking, security, crime prevention (or reduction), guarding, policing, cleaning, sanitizing, disinfecting, laundry, food preparation, serving, fire suppression, medical assistance, entertainment services, etc. The services provided by the robots may vary in addition to the examples listed above.

The second type of purpose is intended for the robot to perform missions or functions other than the inherent mission of the robot, and this may be a purpose unrelated to the inherent mission of the robot. This second type of purpose may not be directly related to the robot performing its inherent mission, but may be a mission or function that is indirectly necessary (or otherwise, performed).

For example, for the robot to perform its inherent mission, sufficient power for operation is required (or used), and to provide comfortable services to people, the robot needs to (or should) maintain cleanliness. Further, for a plurality of robots to be efficiently operated within the building, there may sometimes be situations where the robots need to (or otherwise, do) wait in a designated space.

As described above, in some example embodiments, the robot may travel through the indoor space of the building 1000 or use the facility infrastructure 200 to move in order to achieve the second type of purpose. Further, the robot may use the facility infrastructure 200.

For example, the robot may use a charging facility infrastructure to achieve the purpose related to charging functions, and may use a cleaning facility infrastructure to achieve the purpose related to cleaning functions.

As described above, in some example embodiments, the robot may travel through the indoor space of the building 1000 or use the facility infrastructure 200 to move in order to achieve a certain purpose. Further, the robot may use the facility infrastructure 200.

The cloud server 20 may perform appropriate control of each of the robots positioned within the building on the basis of information corresponding to each of the plurality of robots positioned in the building, which is stored in the database.

Various information regarding each of the plurality of robots positioned within the building may be stored in the database, and the information related to the robot R may vary. As an example, i) identification information for identifying the robot R placed in the space 10 (e.g., serial number, TAG information, QR code information, etc.), ii) mission information assigned to the robot R (e.g., type of mission, operations according to the mission, target user information related to the mission, mission performing place, scheduled mission performing time, etc.), iii) traveling path information set for the robot R, iv) position information on the robot R, v) state information on the robot R (e.g., power state, malfunction status, cleaning state, battery state, etc.), vi) image information received from the camera provided in the robot R, vii) operation information related to the operation of the robot R, and the like, may exist in the database.

Appropriate control of the robots may be related to operating the robots according to the first type of purpose or the second type of purpose described above.

Here, the operation of the robot may refer to controlling the robot to travel through the indoor space of the building 1000, use the facility infrastructure 200 to move, and further, to use the facility infrastructure 200.

The movement of the robot may be referred to as the robot's travel, and thus, in some example embodiments, “movement path” and “traveling path” may be used interchangeably.

The cloud server 20, on the basis of the information stored in the database for each robot, may allocate appropriate missions to the robots according to each robot's intended use (or inherent mission) and perform control of the robots to ensure that the allocated missions are carried out. In this case, the allocated mission may be a mission intended to achieve the first type of purpose, as described above.

Further, the cloud server 20 may perform control of each robot to achieve the second type of purpose, on the basis of the information stored in the database for each robot.

In this case, the robot receiving a control command from the cloud server 20 to achieve the second type of purpose may move to the charging facility infrastructure or the cleaning facility infrastructure, etc., on the basis of the control command, to achieve the second type of purpose.

Hereinafter, the terms “purpose” or “mission” will be used without distinguishing between the first type or the second type of purpose. The purpose described hereinafter may be either the first type of purpose or the second type of purpose.

Likewise, the mission described hereinafter may be a mission intended to achieve either the first type of purpose or the second type of purpose.

For example, when there is a robot capable of providing serving services and there is a target user to be served, the cloud server 20 may perform control of the robot to ensure that the robot carries out the mission corresponding to serving the target user.

As another example, when there is a robot in need of charging (or to be charged), the cloud server 20 may perform control to ensure that the robot moves to the charging facility infrastructure to carry out the mission corresponding to charging.

Accordingly, hereinafter, without distinguishing between the first type or the second type of purpose, a method by which the robot performs a purpose or mission using the facility infrastructure 200 under the control of the cloud server 20 will be described in detail. In this specification, it is also possible to refer to a robot controlled by the cloud server 20 for the purpose of performing a mission as a “target robot.”

The cloud server 20 may specify at least one robot to perform a mission on the basis of a request or its own judgment.

Here, the request may be received from various entities. For example, the cloud server may receive requests in various ways (e.g., user input through electronic devices, gesture-based user input) from various entities such as visitors, administrators, residents, or workers positioned in the building. Here, the request may be a service request intended to have a specific service (or specific mission) provided by the robot.

The cloud server 20, on the basis of such a request, may specify a robot capable of performing the corresponding service from among the plurality of robots positioned within the building 1000. The cloud server 20 may specify a robot capable of responding to the request on the basis of i) a type of service the robot is able to perform, ii) a mission already allocated to the robot, iii) a current position of the robot, and/or iv) a state of the robot (e.g., power state, cleanliness state, battery state, etc.). As described above, various information regarding each robot exists in the database, and on the basis of this database, the cloud server 20 may specify a robot to perform the mission in response to the request.

Further, the cloud server 20 may specify at least one robot to perform a mission on the basis of its own judgment.

Here, the cloud server 20 may perform its own judgment based on various causes.

As an example, the cloud server 20 may judge whether a specific user or specific space existing within the building 1000 requires the provision of (or otherwise, is to be provided with) a service. The cloud server 20 may extract a specific target requiring the provision of a service (or to which a service is to be provided) on the basis of information sensed and received from at least one of the sensing unit 120 (see FIG. 4 to FIG. 6) existing in the building 1000, the sensing unit included in the facility infrastructure 200, or the sensing unit provided in the robot.

Here, the specific target may include at least one of a person, space, or object. The object may refer to facilities or items positioned within the building 1000. Further, the cloud server 20 may specify the type of service needed by (or to be provided to) the extracted specific target and control the robot to ensure that the specific service is provided to the specific target.

To this end, the cloud server 20 may specify at least one robot to provide the specific service to the specific target.

The cloud server 20 may judge the target requiring the provision of a service (or to which a service is to be provided) on the basis of various judgment algorithms. For example, the cloud server 20 may specify the type of service, such as path guidance, serving, or moving across stairs, on the basis of the information sensed and received from at least one of the sensing unit 120 (see FIG. 4 to FIG. 6) existing in the building 1000, the sensing unit included in the facility infrastructure 200, or the sensing unit provided in the robot. Further, the cloud server 20 may specify the target that requires the corresponding service (or to which the corresponding service is to be provided). Further, the cloud server 20 may specify a robot capable of providing the specified service, ensuring that the service is provided by the robot.

Further, the cloud server 20 may judge a specific space requiring the provision of a service (or to which the service is to be provided) on the basis of various judgment algorithms. For example, the cloud server 20 may extract a specific space or object requiring the provision of a service, such as a delivery target user, a guest needing (or that should be provided) guidance, a contaminated space, a contaminated facility, and/or a fire zone, on the basis of the information sensed and received from at least one of the sensing unit 120 (see FIG. 4 to FIG. 6) existing in the building 1000, the sensing unit included in the facility infrastructure 200, or the sensing unit provided in the robot. Further, the cloud server 20 may specify a robot capable of providing the service so that the service by the robot is provided to the corresponding specific space or object.

As described above, once the robot to perform a specific mission (or service) is specified, the cloud server 20 may allocate the mission to the robot and perform a series of controls required for (or otherwise, used) the robot to execute the mission.

In this case, the series of controls may include at least one of i) setting the movement path of the robot, ii) specifying the facility infrastructure to be used for moving to the mission destination, iii) communicating with the specified facility infrastructure, iv) controlling the specified facility infrastructure, v) monitoring the robot performing the mission, vi) evaluating the robot's travel, and/or vii) monitoring the completion status of the robot's mission.

The cloud server 20 may specify the destination where the robot's mission is to be performed and set a movement path for the robot to reach the corresponding destination. Once the movement path is set by the cloud server 20, the robot R may be controlled to move to the corresponding destination in order to perform the mission.

The cloud server 20 may set a movement path for the robot from the position where the mission performing starts (initiates) (hereinafter referred to as the “mission performing start position”) to the destination. Here, the position where the robot starts performing the mission may be the current position of the robot or the position of the robot at an occasion when the robot starts performing the mission.

The cloud server 20 may generate the movement path of the robot to perform the mission on the basis of a map (or map information) corresponding to the indoor space 10 of the building 1000.

Here, the map may include map information for each of the plurality of floors 10a, 10b, and 10c, . . . that make up the indoor space of the building.

Further, the movement path may be a movement path from the mission performing start position to the destination where the mission is performed.

In some example embodiments, the map information and movement path are described as being related to the indoor space, but some example embodiments are not limited thereto. For example, the map information may include information on outdoor spaces, and the movement path may be a path extending from the indoor space to the outdoor space.

As illustrated in FIG. 8, the indoor space 10 of the building 1000 may be made up of a plurality of different floors (10a, 10b, 10c, 10d, . . . ), and the mission performing start position and the destination may be positioned on the same floor (or similar floors) or on different floors.

The cloud server 20 may generate the movement path of the robot to perform a service within the building 1000 using the map information on the plurality of floors 10a, 10b, 10c, and 10d, . . . .

The cloud server 20 may specify at least one facility among the facility infrastructure (plurality of facilities) placed within the building 1000 that the robot needs to (or otherwise, does) use or pass through in order to move to the destination.

For example, when the robot needs to (or otherwise, does) move from the first floor 10a to the second floor 10b, the cloud server 20 may specify at least one facility 204 or 205 to assist with the inter-floor movement of the robot and generate the movement path including a point where the specified facility is positioned. Here, the facility assisting with the inter-floor movement of the robot may be at least one of the robot-exclusive elevator 204, shared elevator 213, or escalator 205. In addition, there may be various types of facilities that assist with the inter-floor movement of the robot.

As an example, the cloud server 20 may identify a specific floor corresponding to the destination among the plurality of floors 10a, 10b, and 10c, . . . in the indoor space 10, and on the basis of the mission performing start position of the robot (e.g., a position of the robot at an occasion when the mission corresponding to the service is initiated), may judge whether inter-floor movement is needed for (or is to be used for) the robot to perform the service.

Further, the cloud server 20 may include a facility (means) to assist with the inter-floor movement of the robot on the movement path, on the basis of the judgment result. In this case, the facility assisting with the inter-floor movement of the robot may be at least one of the robot-exclusive elevator 204, shared elevator 213, or escalator 205. For example, when the inter-floor movement of the robot is required (or to be performed), the cloud server 20 may generate the movement path such that the facility assisting with the inter-floor movement of the robot is included in the movement path.

As another example, when a robot-exclusive passage 201 or 202 is positioned on the movement path of the robot, the cloud server 20 may generate the movement path to include a point where the robot-exclusive passage 201 or 202 is positioned, allowing the robot to move using the robot-exclusive passage 201 or 202. As described above with reference to FIG. 3, the robot-exclusive passage may be configured as at least one of a first exclusive passage (or first type of passage 201) and a second exclusive passage (or second type of passage 202). The first exclusive passage and the second exclusive passage 201 and 202 may be provided together on the same floor (or similar floors) or on different floors. The first exclusive passage 201 and the second exclusive passage 202 may have different heights relative to the floor surface of the building.

The cloud server 20 may control the travel characteristics of the robot on the robot-exclusive passage to vary based on a type of robot-exclusive passage and a level of congestion around the robot-exclusive passage that is used by the robot. As illustrated in FIG. 3 and FIG. 8, when the robot travels through the second exclusive passage, the cloud server 20 may enable the travel characteristics of the robot to vary based on the level of congestion around the robot-exclusive passage. Since the second exclusive passage is a passage accessible to people or animals, this is to consider both safety and movement efficiency.

Here, the travel characteristics of the robot may be related to a travel speed of the robot. Further, the level of congestion may be calculated on the basis of images received from at least one of the cameras (or image sensor, 121) placed in the building 1000 or the cameras placed in the robot. On the basis of such images, when the point where the robot is positioned and the robot-exclusive passage in the advancing direction are congested, the cloud server 20 may control the travel speed of the robot to be equal to or less than (or less than) a preset (or alternatively, given) speed.

As described above, the cloud server 20 uses the map information on the plurality of floors 10a, 10b, 10c, and 10d, . . . to generate the movement path of the robot that will perform a service within the building 1000. In this case, the cloud server 20 may specify at least one facility among the facility infrastructure (plurality of facilities) placed within the building 1000 that the robot needs to (or will) use or pass through in order to move to the destination. Further, the cloud server 20 may generate the movement path such that at least one specified facility is included in the movement path.

The robot traveling through the indoor space 10 to perform a service may sequentially use or pass through the at least one facility while following the movement path received from the cloud server 20 to perform the travel to reach the destination.

The sequence of facilities that the robot needs to use (or uses) may be determined under the control of the cloud server 20. Further, the sequence of facilities that the robot needs to use (or uses) may be included in information regarding the movement path received from the cloud server 20.

As illustrated in FIG. 7, the building 1000 may include at least one of a robot-exclusive facility 201, 202, 204, 208, 209, or 211 used exclusively by the robot (depicted as (a) of FIG. 7), and a shared facility 205, 206, 207, or 213 used jointly by both robots and people (depicted as (b) of FIG. 7).

The robot-exclusive facility used solely by the robot may include facilities 208 and 209 that provide functions necessary for (or otherwise, used by) the robot, such as charging, cleaning, or waiting functions, as well as facilities 201, 202, 204, and 211 used for the movement of the robot.

The cloud server 20, when generating the movement path for the robot, may generate the movement path such that when a robot-exclusive facility exists on the path from the mission performing start position to the destination, the robot uses the robot-exclusive facility to move (or pass through). That is, the cloud server 20 may generate the movement path by prioritizing the robot-exclusive facility. This is intended to enhance the efficiency of the robot's movement. For example, when both the robot-exclusive elevator 204 and the shared elevator 213 exist on the movement path to the destination, the cloud server 20 may generate the movement path that includes the robot-exclusive elevator 204.

As described above, the robot traveling through the building 1000 according to some example embodiments may use various facilities provided in the building 1000 to travel through the indoor space of the building 1000 in order to perform the mission.

The cloud server 20 may be configured to communicate with the control system (or control server) of at least one facility that the robot is using or is scheduled to use to ensure smooth movement of the robot. As described above with reference to FIG. 4, unique control systems for controlling the facilities may communicate with at least one of the cloud server 20, the robot R, or the building 1000 to perform appropriate control of each facility so that the robot R may use the facilities.

The cloud server 20 may monitor the position of the robot traveling within the building 1000 in real-time or at preset (or alternatively, given) time intervals. The cloud server 20 may monitor the position information on all the plurality of robots traveling within the building 1000, and/or selectively monitor the position information on a specific robot. The monitored position information on the robot may be stored in the database where the information on the robot is stored, and the position information on the robot may be continuously updated over time.

There are various methods for estimating the position information on the robot positioned within the building 1000, and hereinafter, some example embodiments of estimating the position information on the robot will be described.

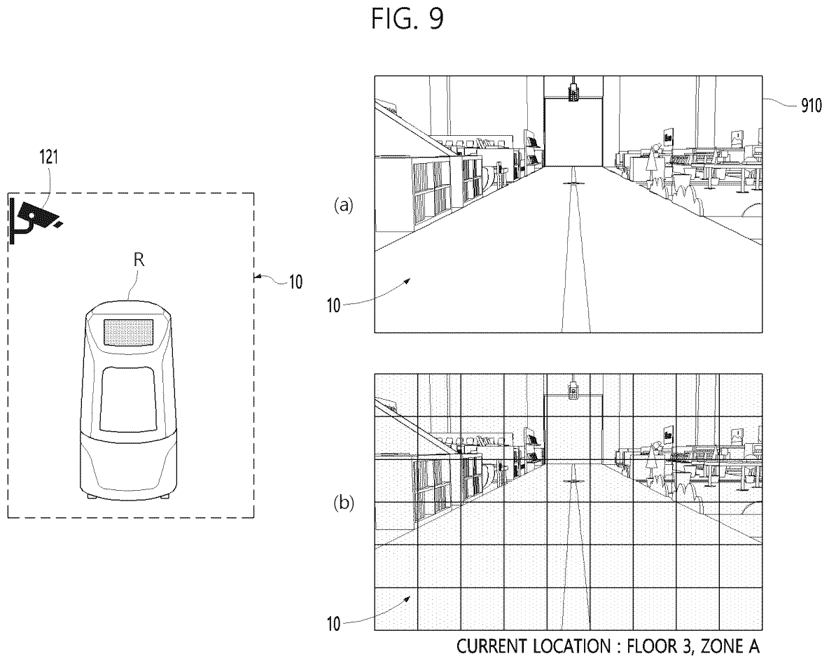

FIGS. 9 to 11 are conceptual views for describing a method of estimating a position of a robot traveling in the robot-friendly building according to some example embodiments.

As an example, as illustrated in FIG. 9, the cloud server 20 according to some example embodiments may be configured to perform visual localization by receiving images of the space 10 using the camera (not illustrated) provided in the robot R and estimating the position of the robot from the received images. In this case, the camera is configured to capture (or sense) images of the space 10, e.g., images of the surroundings of the robot R. Hereinafter, for convenience of description, the images obtained using the camera provided in the robot R will be referred to as “robot images.” Further, the images obtained through the camera placed in the space 10 will be referred to as “space images.”

The cloud server 20 is configured to obtain robot images 910 through the camera (not illustrated) provided in the robot R, as illustrated in (a) of FIG. 9. Further, the cloud server 20 may use the obtained robot image 910 to estimate the current position of the robot R.

The cloud server 20 may compare the robot image 910 with the map information stored in the database and extract the position information corresponding to the current position of the robot R (e.g., “3rd floor zone A (3, 1, 1)”), as illustrated in (b) of FIG. 9.

As described above, the map of the space 10 in some example embodiments may be a map prepared based on a simultaneous localization and mapping (SLAM) by at least one robot moving through the space 10 in advance. In particular, the map of the space 10 may be a map generated based on image information.

That is, the map of the space 10 may be a map generated by the vision (or visual) based SLAM technology.

Therefore, the cloud server 20 may specify coordinate information (e.g., (3rd floor zone A (3, 1, 1)) for the robot image 910 obtained from the robot R, as illustrated in (b) of FIG. 9. As described above, the specified coordinate information may be information on the current position of the robot R.

In this case, the cloud server 20 may estimate the current position of the robot R by comparing the robot image 910 acquired from the robot R with the map generated by the vision (or visual) based SLAM technology. In this case, the cloud server 20 may i) specify an image most similar to the robot image 910 using an image comparison between the robot image 910 and images making up the pre-generated (or generated) map, and ii) specify position information on the robot R in a method of obtaining the position information matched to the specified image.

As described above, when the robot image 910 is obtained from the robot R, the cloud server 20 may specify the current position of the robot using the obtained robot image 910, as illustrated in (a) of FIG. 9. As described above, the cloud server 20 may extract position information (e.g., coordinate information) corresponding to the robot image 910 from the map information (e.g., which may also be referred to as a “reference map”) pre-stored (or stored) in the database.

In the above description, an example in which the cloud server 20 estimates the position of the robot R has been described, but as described above, the estimating of the position of the robot R may be performed by the robot R itself. That is, the robot R may estimate the current position in the method described above, on the basis of an image received by the robot R itself. Further, the robot R may transmit the estimated position information to the cloud server 20. In this case, the cloud server 20 may perform a series of controls on the basis of the position information received from the robot.

As described above, once the position information on the robot R is extracted from the robot image 910, the cloud server 20 may specify at least one camera 121 placed in the indoor space 10 corresponding to the position information. The cloud server 20 may specify the camera 121 placed in the indoor space 10 corresponding to the position information, on the basis of the matching information related to the camera 121 stored in the database.

Such images may be utilized not only for estimating the position of the robot but also for monitoring and controlling the robot. For example, the cloud server 20 may output both the robot image 910 obtained from the robot R itself and the image obtained from the camera 121 placed in the space where the robot R is positioned to the display unit of the control system for monitoring and controlling the robot R. Therefore, an administrator managing and controlling the robot R remotely, whether within the building 1000 or from the outside, may perform remote control of the robot R by considering not only the robot image 910 obtained from the robot R but also the image of the space where the robot R is positioned.

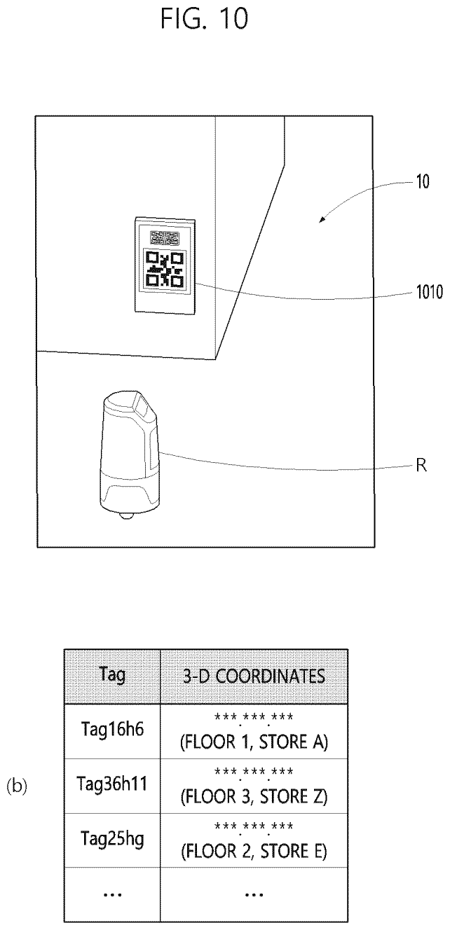

As another example, the estimation of the position of the robot traveling through the indoor space 10 may be configured based on a tag 1010 provided in the indoor space 10, as illustrated in (a) of FIG. 10.

With reference to FIG. 10, the position information corresponding to a point where the tag 1010 is attached may exist to be matched in the tag 1010, as illustrated in (b) of FIG. 10. That is, a different plurality of points within the indoor space 10 of the building 1000 may each be provided with tags 1010 that have different identification information. The identification information on each tag and the position information on the point where the tag is attached may exist to be matched in the database.

Further, the tag 1010 may be configured to include the position information matched to each tag 1010.

The robot R may recognize the tag 1010 provided in the space 10 using the sensor provided in the robot R. Through such recognition, the robot R may figure out the current position of the robot by extracting the position information included in the tag 1010. The extracted position information may be transmitted from the robot R to the cloud server 20 through the communication unit 110. Accordingly, the cloud server 20 may monitor the positions of the robots traveling within the building 1000 on the basis of the position information received from the robot R that sensed the tag.

Further, the robot R may transmit the identification information on the recognized tag 1010 to the cloud server 20. The cloud server 20 may extract the position information matched to the identification information on the tag 1010 from the database, thereby monitoring the position of the robot within the building 1000.

The term “tag 1010” described above may be referred to as various names. For example, such a tag 1010 may be variously referred to as a QR code, barcode, identification label, and so on. The term “tag” described above may be replaced and used as “marker.”

Hereinafter, a method of monitoring the robot R positioned in the indoor space 10 of the building 1000 using an identification label provided in the robot R, as part of the methods of monitoring the position of the robot R, will be described.

As described above, various information regarding the robot R may be stored in the database. Various information regarding the robot R may include identification information for identifying the robot R positioned in the indoor space 10 (e.g., serial numbers, TAG information, QR code information, etc.).

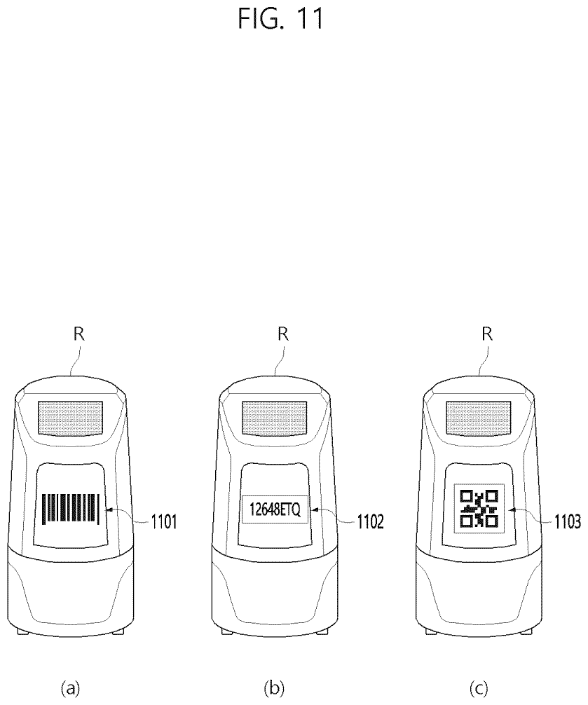

As illustrated in FIG. 11, the identification information on the robot R may be included in the identification label (or identification mark) provided in the robot R. Such an identification label may be sensed or scanned by the building control system 1000a or the facility infrastructure 200. As illustrated in (a) to (c) of FIG. 11, the identification labels 1101, 1102, and 1103 of the robot R may include the identification information on the robot. As illustrated, the identification labels 1101, 1102, and 1103 may be represented as a barcode 1101, serial information 1102, QR code 1103, RFID tag (not illustrated), NFC tag (not illustrated), or the like. The barcode 1101, serial information 1102, QR code 1103, RFID tag (not illustrated), NFC tag (not illustrated), or the like may be configured to include the identification information on the robot to which the identification label is provided (or attached).

The identification information on the robot is information that distinguishes one robot from another, and even robots of the same type (or similar types) may have different identification information. The information that make up the identification label may be variously configured other than the aforementioned barcode, serial information, QR code, RFID tag (not illustrated), or NFC tag (not illustrated).

The cloud server 20 may extract the identification information of the robot R from images received from cameras placed in the indoor space 10, cameras provided in other robots, or cameras provided in the facility infrastructure, thereby figuring out and monitoring the position of the robot within the indoor space 10. The means for sensing the identification label is not necessarily limited to a camera, and depending on the form of the identification label, a sensing unit (e.g., a scanning unit) may be used. Such a sensing unit may be provided in at least one of the indoor space 10, robots, or facility infrastructure 200.

As an example, when the identification label is sensed from an image captured by the camera, the cloud server 20 may figure out the position of the robot R from the image received from the camera. In this case, the cloud server 20 may figure out the position of the robot R on the basis of at least one of the position information on the camera placed and the position information on the robot in the image (exactly, the position information on the graphic object corresponding to the robot in the image captured with the robot as a subject).

In the database, the position information on the places where the cameras are placed may exist to be matched together with the identification information on the cameras placed in the indoor space 10 Accordingly, the cloud server 20 may extract the position information matched with the identification information on the camera that captured the image from the database, thereby extracting the position information on the robot R.

As another example, when the identification label is sensed by the scanning unit, the cloud server 20 may figure out the position of the robot R from the scan information sensed by the scanning unit. In the database, the position information on the places where the scanning unit is placed may exist to be matched together with the identification information on the scanning unit placed in the indoor space 10 Accordingly, the cloud server 20 may extract the position information matched with the scanning unit that scanned the identification label provided in the robot from the database, thereby extracting the position information on the robot R.

As described above, in the building according to some example embodiments, it is possible to extract and monitor positions of the robots using various infrastructures provided in the building. Further, the cloud server 20 may perform efficient and accurate control of the robots within the building by monitoring the positions of the robots.

In order to provide various services using the robot R, a map may be generated that is utilized for the operation and travel of the robot R, ensuring that the robot R positioned in the building 1000 moves safely and efficiently within the building 1000, while reflecting the characteristics and situations of the actual spaces within the building 1000.

To this end, some example embodiments enable a method of providing a user environment in which the user may conveniently and intuitively generate and change a map for the operation and travel of the robot R providing services in the building 1000, and allowing the robot R to operate and travel within the building 1000 on the basis of the map generated and changed by the user.

Hereinafter, with reference to the accompanying drawings, a more detailed description will be given of the user environment in which the user may conveniently and efficiently generate and change a map, and the method by which the robot R is operated on the basis of the generated and changed map.

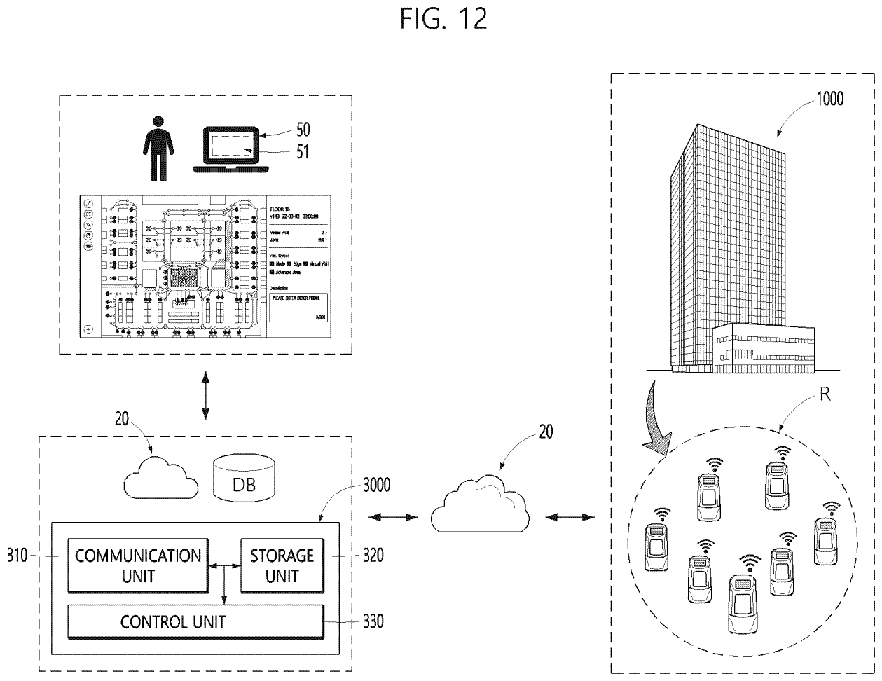

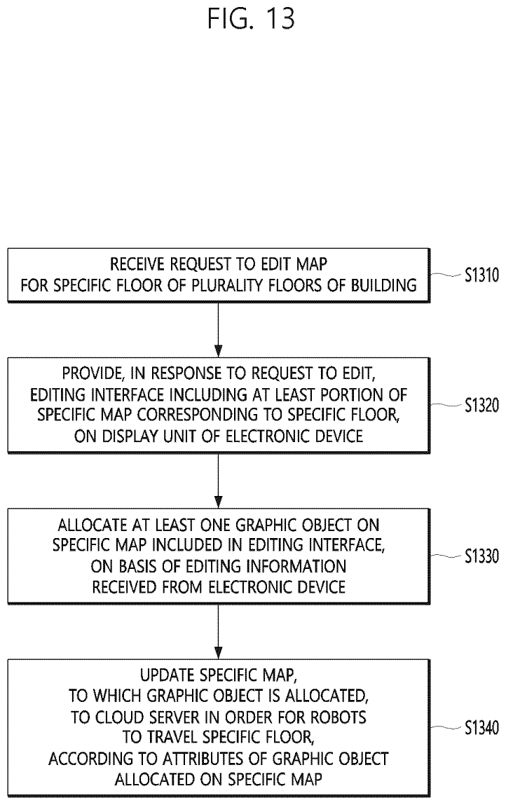

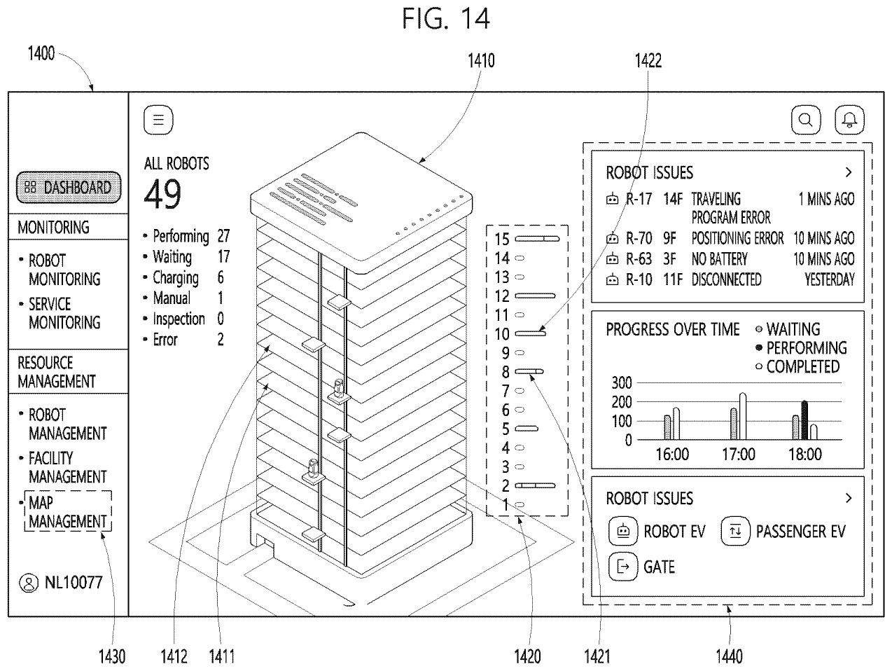

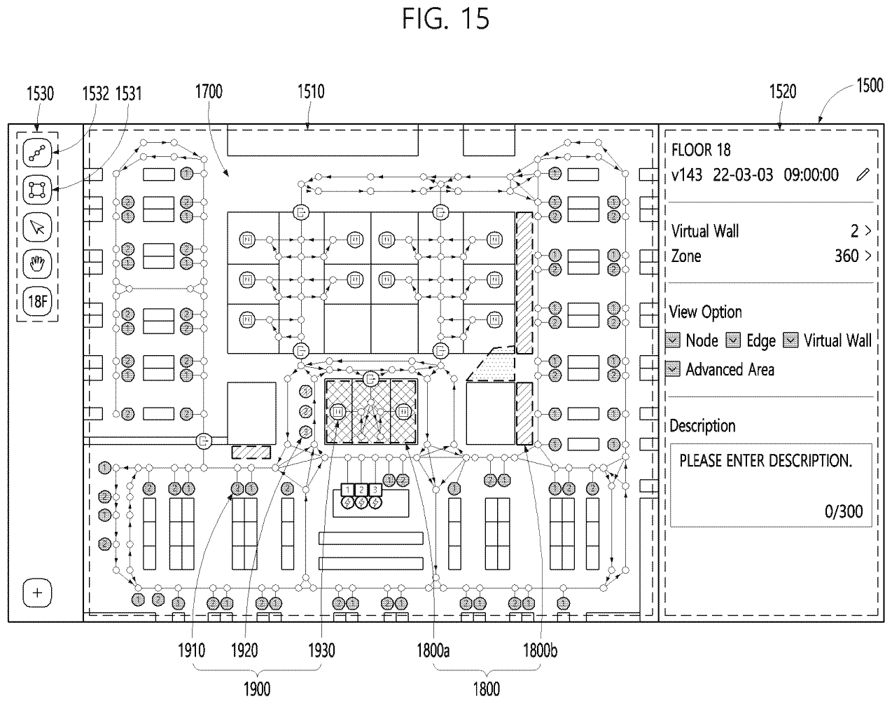

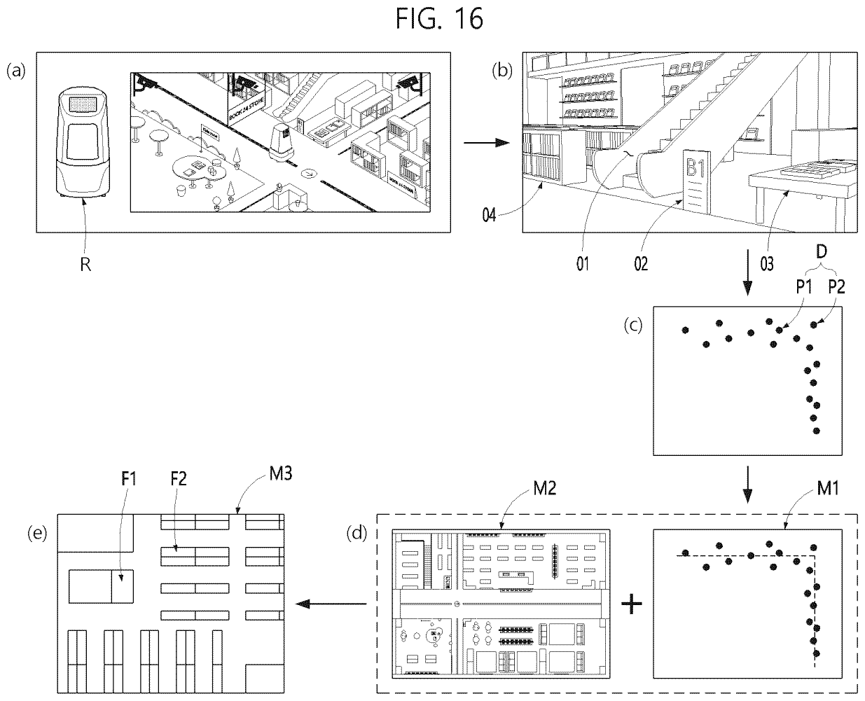

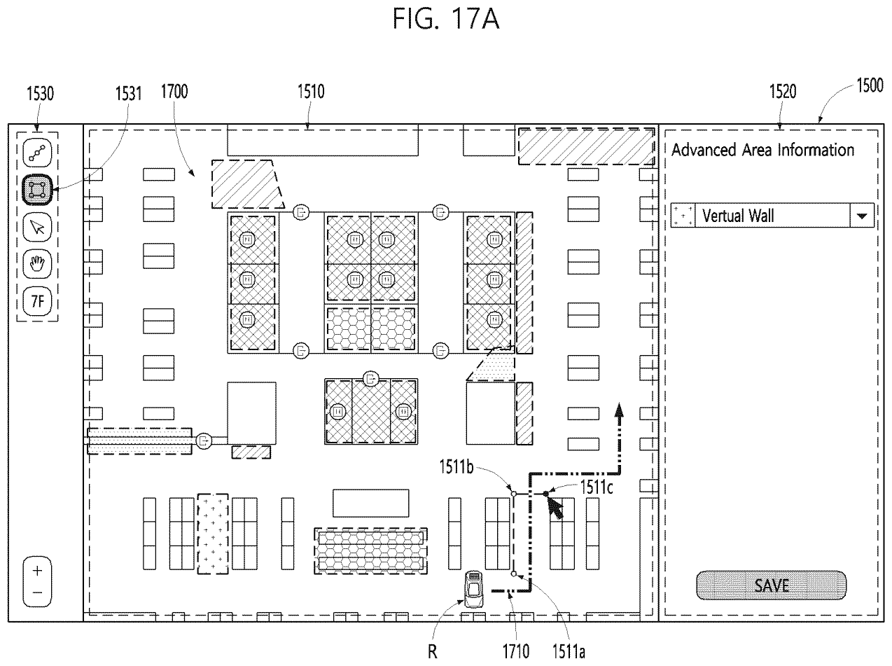

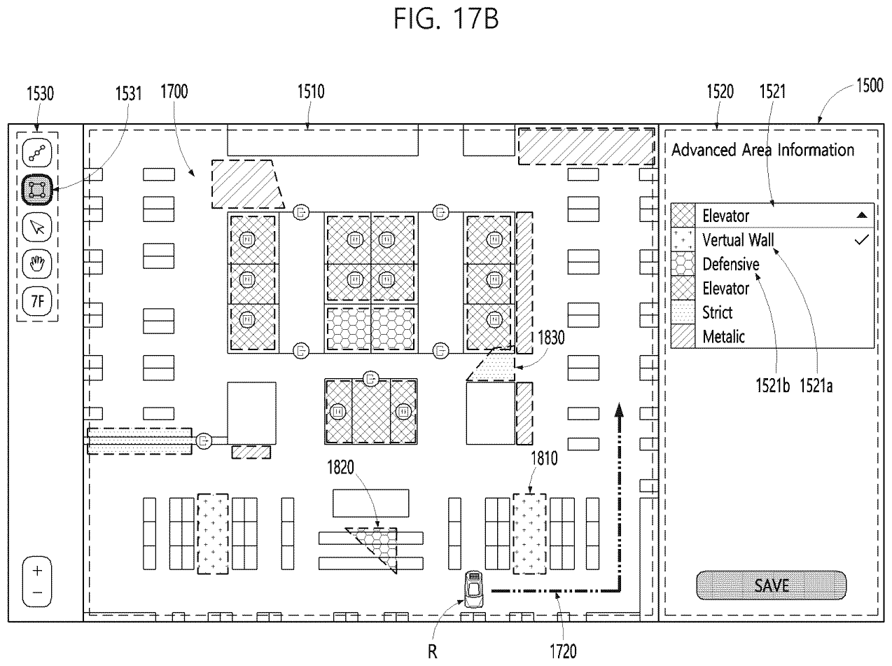

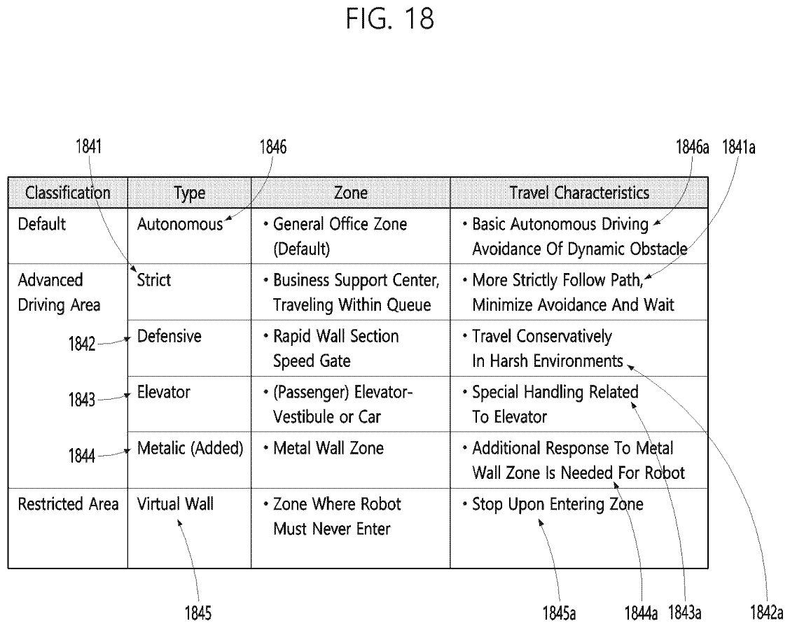

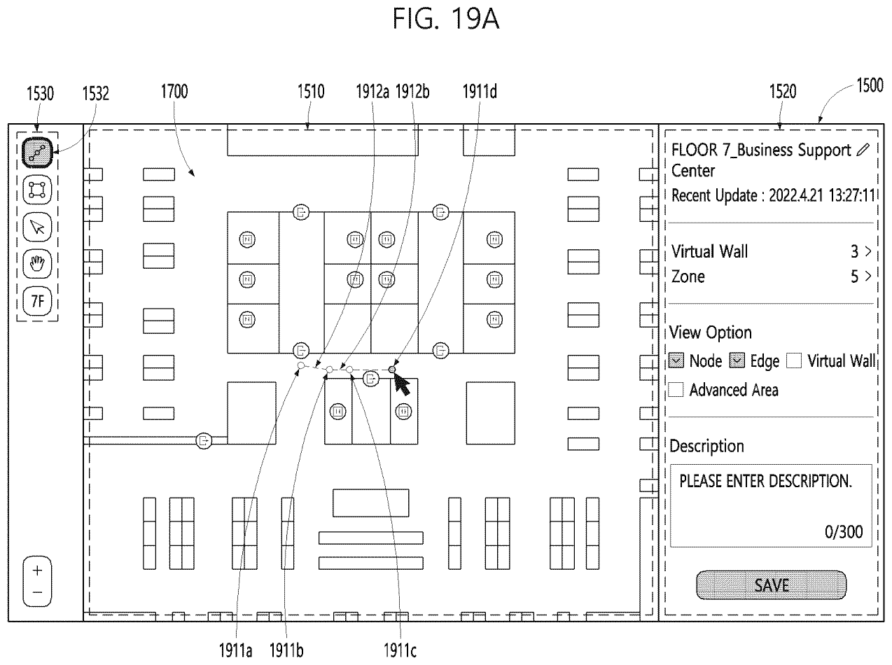

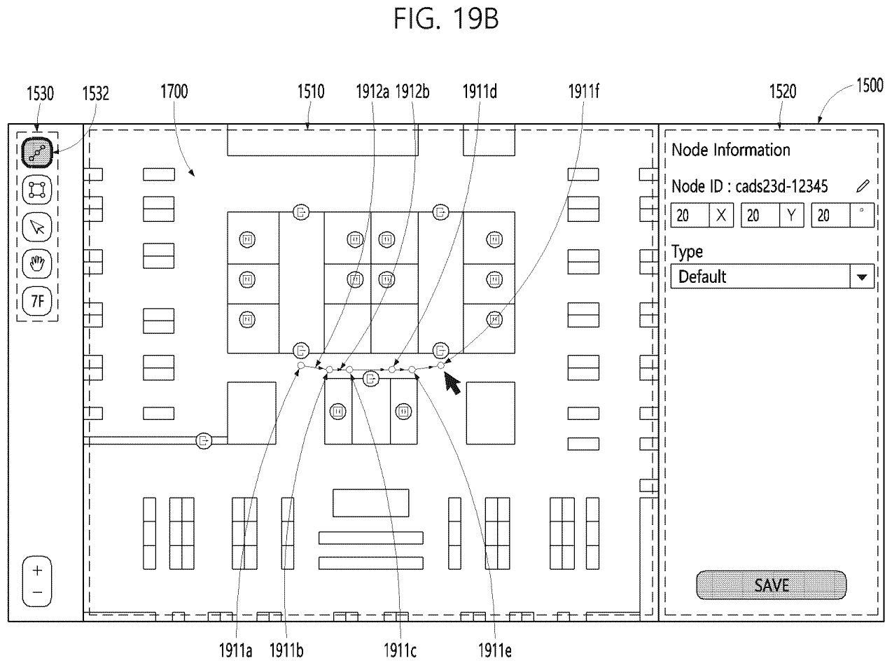

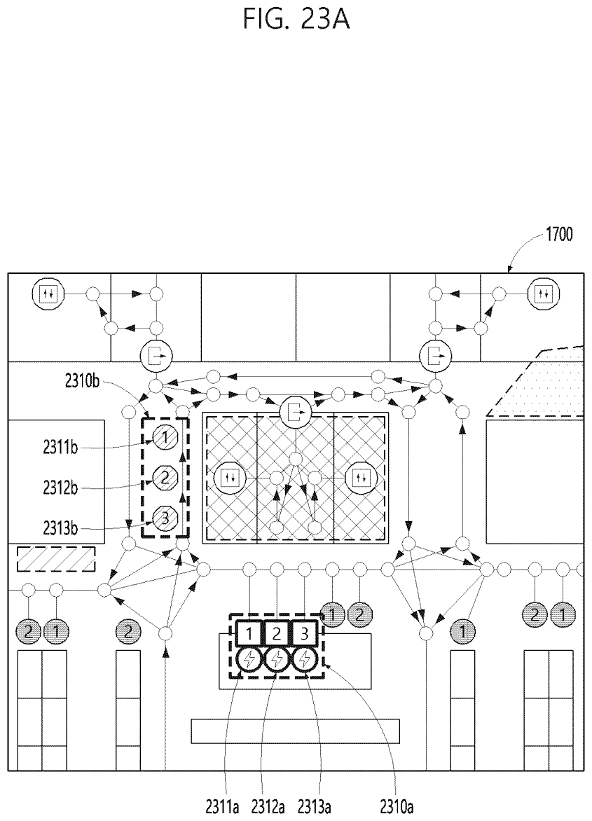

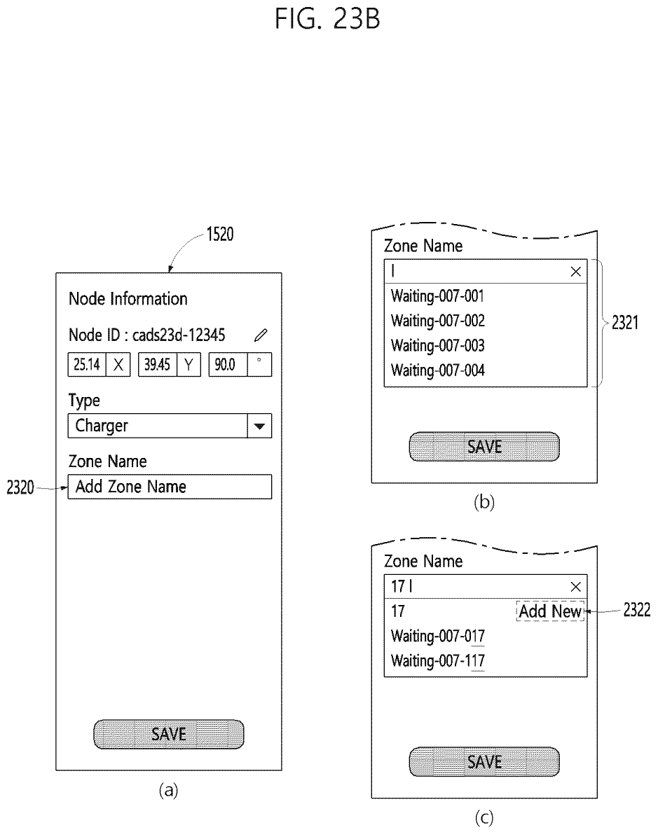

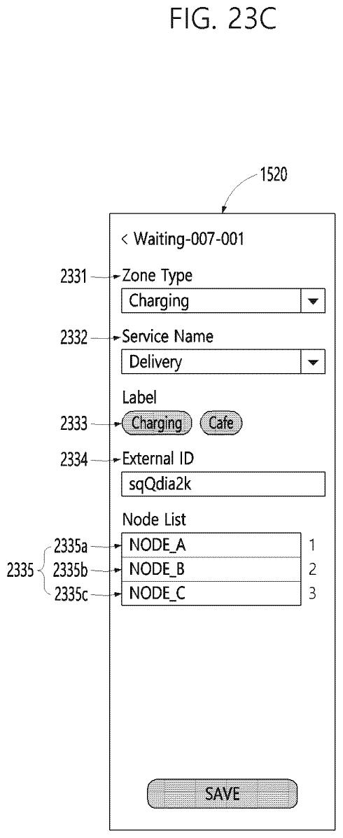

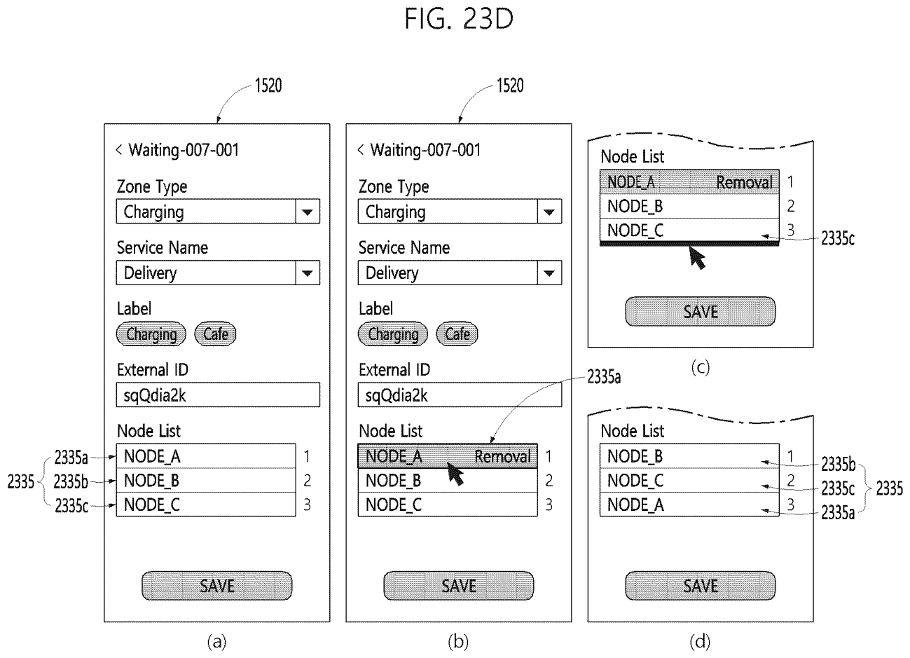

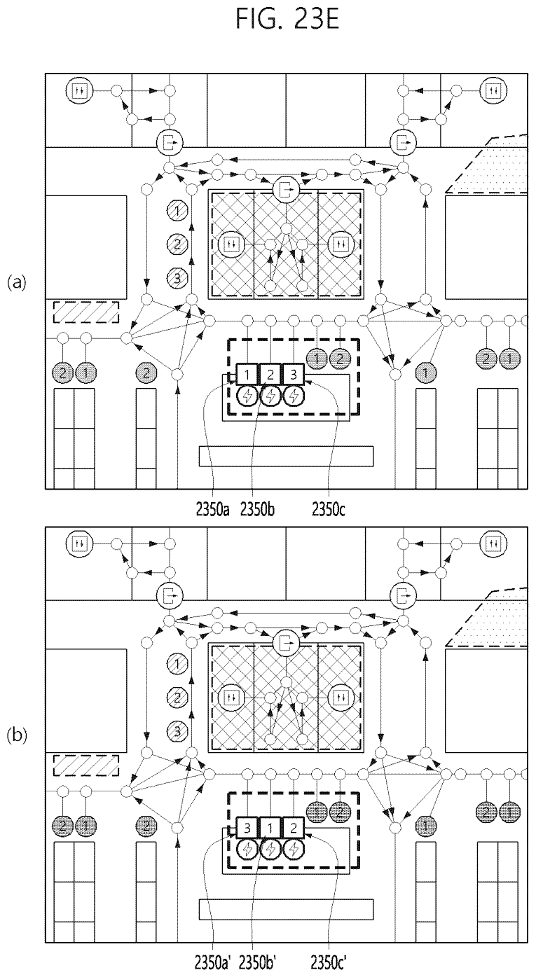

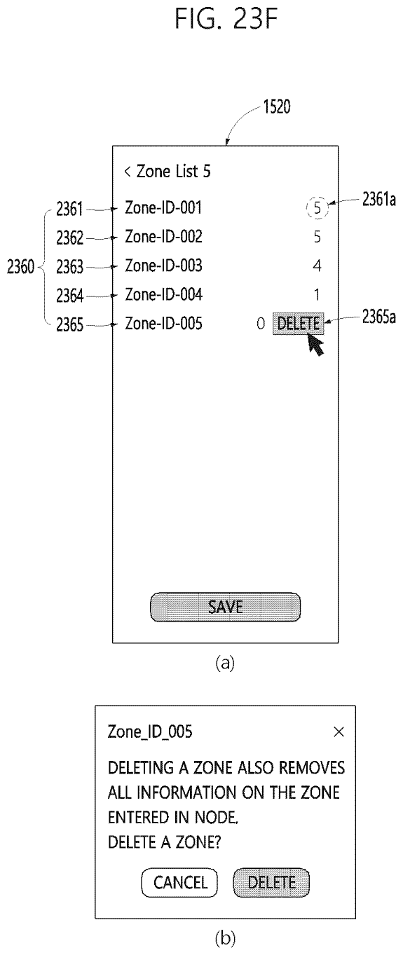

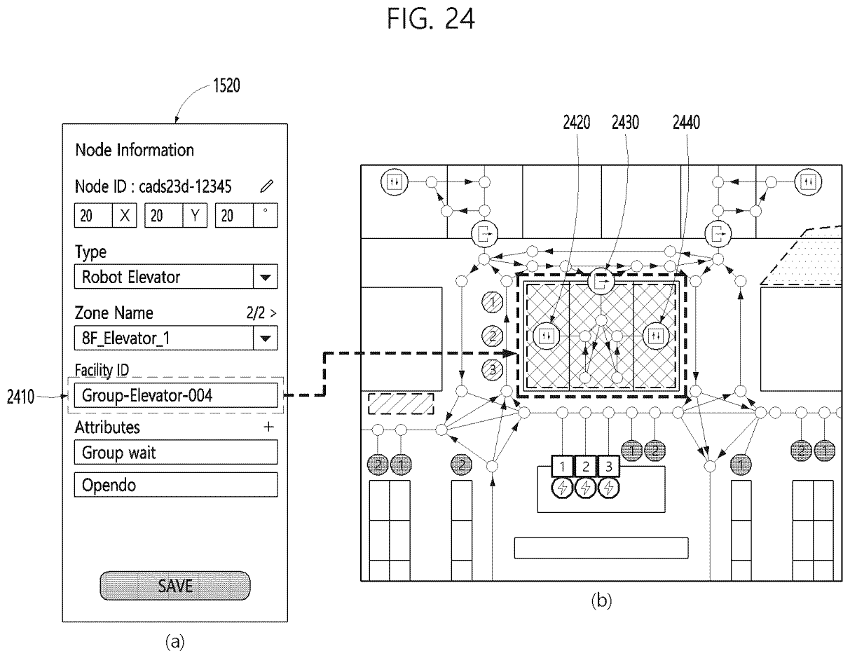

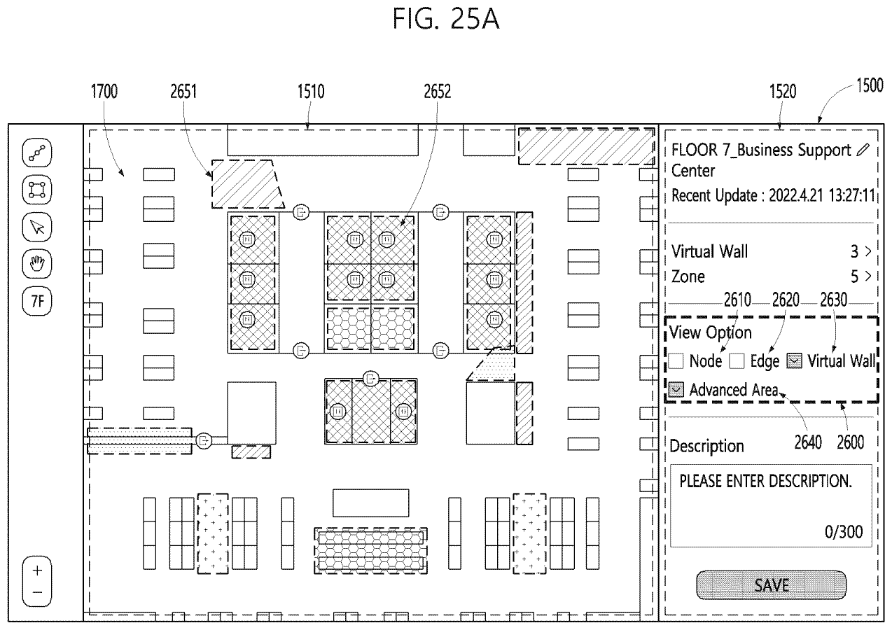

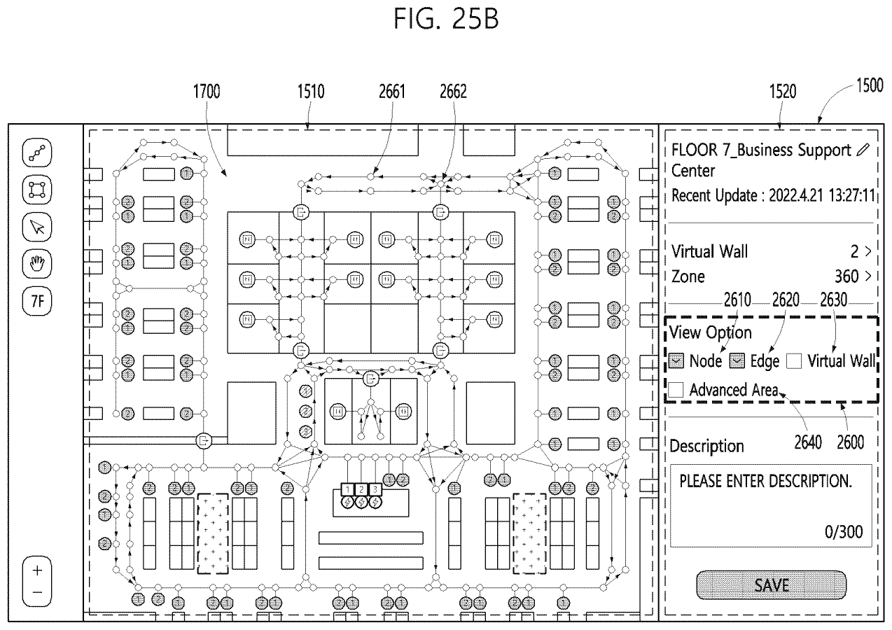

FIG. 12 is a conceptual view for describing a map generation system for robot operation according to some example embodiments. FIG. 13 is a flowchart for describing a method of generating a map for robot operation according to some example embodiments, FIGS. 14 and 15 are conceptual views for describing an editing interface provided in some example embodiments, FIG. 16 is a conceptual view for describing a method of generating a map using a point cloud technique in some example embodiments, FIGS. 17A, 17B, and 18 are conceptual views for describing an area graphic object according to some example embodiments, FIGS. 19A, 19B, 20, 21, and 22 are conceptual views for describing a node graphic object according to some example embodiments, FIGS. 23A, 23B, 23C, 23D, 23E, 23F and 24 are conceptual views for describing a zone according to some example embodiments, and FIGS. 25A and 25B are conceptual views for describing a method of filtering a graphic object on an editing interface of some example embodiments.

As illustrated in FIG. 12, a map generation system 3000 for operating the robot R according to some example embodiments may include at least one of a communication unit 310, a storage unit 320, and/or a control unit 330.

The map generation system 3000 for operating the robot R according to some example embodiments provides a user environment in which the user may conveniently, intuitively, and efficiently generate, change, and edit (hereinafter referred to as “edit”) the map for operating the robot R. This system may be variously referred to as a “map generation system,” “map editing system,” “map management system,” “map generation editor,” “map editing editor,” “map management editor,” “map editor,” “editing editor,” and the like, with these terms used interchangeably.

The communication unit 310 may be configured to perform communication with at least one of i) an electronic device 50, ii) the cloud server 20, iii) various robots R placed within the building 1000, iv) various facility infrastructure 200 placed within the building 1000, or v) the building system 1000a. According to some example embodiments, operations described herein as being performed by the map generation system 3000, the control unit 330 and/or the electronic device 50 may be performed by processing circuitry.

Here, the electronic device 50 may be any electronic device capable of communicating with the map generation system 3000 for operating the robot R according to some example embodiments, without any particular limitation on its type. For example, the electronic device 50 may include a cell phone, a smart phone, a notebook computer, a portable computer (laptop computer), a slate PC, a tablet PC, an ultrabook, a desktop computer, a digital broadcast terminal, a personal digital assistant (PDA), a portable multimedia player (PMP), a navigation device, a wearable device (e.g., a watch-type device (smartwatch), a glass-type device (smart glass), and a head mounted display (HMD)), and the like. In some example embodiments, the term “electronic device” may be used interchangeably with “user terminal” or “user terminal device.”

The communication unit 310 may transmit information related to an editing interface 1500 to the electronic device 50 in order to output the editing interface 1500 on a display unit 51 of the electronic device 50 for generating and editing the map.

Here, the information related to the editing interface 1500 may be understood to include all the information provided through the editing interface 1500 that allows the user to perform map editing.

The communication unit 310 may receive editing information based on user input applied to the editing interface 1500 through the electronic device 50.

Here, the editing information may include information utilized for specifying and allocating graphic objects on the map. For example, the editing information may include, in a specific map, at least one of i) a placement position of a graphic object, ii) a size of the graphic object, iii) a shape of the graphic object, iv) the graphic object, and/or v) various information related to the graphic object.

Further, the communication unit 310 may update the map (e.g., the specific map 1700), in which the graphic object has been allocated, to the cloud server 20 (e.g., update the map on the cloud server 20) when the graphic object is allocated (e.g., in response to the allocating of the graphic object) on a specific map 1700 on the basis of the editing information received from the electronic device 50.

Next, the storage unit 320 may be configured to store various information related to some example embodiments. In some example embodiments, the storage unit 320 may be provided in the map generation system 3000 itself for operating the robot R. In contrast, at least part of the storage unit 320 may refer to at least one of the cloud server 20, an external database, or a storage unit 140 of the building system 1000a. That is, it may be understood that the storage unit 320 is sufficient to be a space in which information necessary (or otherwise, used) for generating a map according to some example embodiments is stored, and there is no restriction on a physical space. Accordingly, hereinafter, the storage unit 320, the cloud server 20, the external database, and the storage unit 140 of the building system 1000a will all be referred to as the storage unit 320, without distinguishing separately.

Next, the control unit 330 may be configured to control the overall operation of the map generation system 3000 for operating the robot R according to some example embodiments. The control unit 330 may process signals, data, information, and the like that are input or output through the constituent elements described above, or may provide or process appropriate information or functions to a user.

The control unit 330 may allocate a graphic object having at least one type among a plurality of types of graphic objects on the specific map 1700 corresponding to a specific floor among a plurality of floors, on the basis of the editing information received from the electronic device 50.

Here, the type of the graphic object may be classified (or distinguished) according to the function linked to the graphic object, and may include i) an area graphic object related to a function of specifying the traveling mode of the robots, ii) a travel node graphic object related to a function of configuring the traveling path of the robots, iii) an operation node graphic object related to a specific operation of the robots, and/or iv) a facility graphic object related to the facility.

The control unit 330 may allocate (or place) a graphic object corresponding to one of the plurality of types of graphic object on the specific map 1700, on the basis of user input being applied on the editing interface 1500 provided through electronic device 50.

Further, the control unit 330 may update the specific map, on which the graphic object has been allocated, to the cloud server so that the robots travel on the specific floor, according to the attributes of the graphic object allocated on the specific map.

As described above, the cloud server 20 may perform control of the plurality of robots R that provide services within the building. Specifically, the cloud server 20 may generate a global movement path and/or a local movement path of the robot R on the basis of the specific map 1700 corresponding to a specific space or specific floor, and perform control to allow the robot R move according to the generated movement path.

As described above, in some example embodiments, a map utilized for controlling the robot R that provides services within the building is generated based on each of the plurality of floors, and the editing interface 1500 may be provided, allowing the user to easily and intuitively prepare and edit the map.

Hereinafter, a more detailed description will be provided regarding a method by which a user conveniently and efficiently prepares a map used for the operation and travel of the robot R, on the basis of each configuration of the aforementioned map generation system 3000 for operating the robot R.

First, in some example embodiments, a process may be performed to receive a map editing request for a specific floor among the plurality of floors of the building 1000 (S1310, see FIG. 13).

As described above, the building 1000 in some example embodiments may be made up of a plurality of floors. The communication unit 310 may receive a map editing request for a specific floor among the plurality of floors that make up the building 1000 from the electronic device 50.

In some example embodiments, “map editing” may be understood as an operation to generate or change a map (or map information) for the space 10 within the building 1000. Specifically, in some example embodiments, “map editing for a specific floor among a plurality of floors” may be understood as an operation to generate or correct a map (or map information) for a specific floor of the building 1000.

The map editing request for the specific floor may be received from the electronic device 50 in various ways.

For example, the map editing request for the specific floor may be configured in a state where a monitoring screen 1400 is being provided on the display unit of electronic device 50, as illustrated in FIG. 14.

The monitoring screen 1400 is a screen that may monitor the plurality of robots R positioned within the building 1000, which includes a plurality of floors. The monitoring screen may include at least one of i) a building graphic object 1410 corresponding to the building 1000, ii) a state graphic object 1420 that includes state information on the robots R positioned on each floor, iii) a specific area 1430 linked to a page (or screen) related to map management corresponding to one of the plurality of floors, and/or iv) a graphic object 1440 corresponding to information related to the robots R positioned throughout all floors of the building 1000.

As illustrated in FIG. 14, in a state where the building graphic object 1410 corresponding to the building is output on the display unit 51 of the electronic device 50, on the basis of a sub-graphic object 1411 or 1412 corresponding to a specific floor being selected, the communication unit 310 may receive a map editing request for the specific floor.

For example, on the basis of the user selecting the sub-graphic object 1411 corresponding to the 8th floor on the display unit 51 of the electronic device 50, the communication unit 310 may receive a map editing request for the 8th floor.

Further, as illustrated in FIG. 14, in a state where the state graphic object 1420 corresponding to each of the plurality of floors is output on the display unit 51 of the electronic device 50, on the basis of a state graphic object 1421 or 1422 corresponding to a specific floor being selected, the communication unit 310 may receive a map editing request for the specific floor.

For example, on the basis of the user selecting the state graphic object 1421 corresponding to the 8th floor on the display unit 51 of the electronic device 50, the communication unit 310 may receive a map editing request for the 8th floor.

Here, “state graphic object 1420” may be understood as a graphic object configured with a visual exterior appearance corresponding to state information, so that the state information on the robots R positioned on each of the plurality of floors within the building 1000 is displayed.

For example, the state graphic object corresponding to the 8th floor may be configured with a visual exterior appearance corresponding to first state information on some robots of the plurality of robots R positioned on the 8th floor, as well as a visual exterior appearance corresponding to second state information thereon.

The user may intuitively recognize the state of the robots R on each of the plurality of floors within the building 1000 through the state graphic object 1420.

Further, as illustrated in FIG. 14, on the basis of a specific area (e.g., “map management” 1430) being selected on the display unit 51 of the electronic device 50, the communication unit 310 may receive a map editing request for the specific floor.

For example, when an user input for the specific area 1430 corresponding to “map management” is received, the control unit 330 may provide, on the display unit 51 of the electronic device 50, a graphic object (or screen) that allows the selection of a specific floor among the plurality of floors within the building to be received. More specifically, the control unit 330 may provide a pop-up on the display unit of the electronic device 50, which includes a plurality of graphic objects including numbers corresponding to each of the plurality of floors. The communication unit 310 may receive a map editing request for the specific floor from electronic device 50, on the basis of a graphic object corresponding to the specific floor being selected among the plurality of graphic objects.

The method of receiving the map editing request for the specific floor described above corresponds to some example embodiments, and the method of receiving the map editing request for the specific floor in the map generation system 3000 according to some example embodiments is not limited to the method described above.

Next, in some example embodiments, in response to the map editing request corresponding to the specific floor received from electronic device 50, a process may proceed to provide the editing interface 1500 on the display unit 51 of the electronic device 50, which includes at least a part of the specific map corresponding to the specific floor (S1320, see FIG. 13).

As illustrated in FIG. 15, the editing interface 1500 may include at least one of a first area 1510 that includes at least a part of the specific map corresponding to the specific floor, or a second area 1520 that includes a function of performing settings related to the specific map 1700.

In some example embodiments, the editing interface 1500 is a screen output on the display unit 51 of the electronic device 50 to provide the user with a function of editing the specific map 1700, and may also be referred to as an “editing screen,” “editing user graphic interface (GUI),” “editing page,” or the like.

The first area 1510 may include (display or provide) at least one of i) at least a part of the specific map corresponding to the specific floor (hereinafter referred to as the specific map 1700), ii) an area graphic object 1800, and/or iii) a node graphic object 1900. This first area may also be referred to as the “map area.”

The specific map 1700 may be stored in the storage unit 320 along with an editing history for the specific map. When receiving an editing request for the map corresponding to the specific floor, the control unit 330 may refer to the editing history and provide the editing interface 1500, which includes the most recently updated specific map 1700, on the display unit of the electronic device 50.

For example, when the specific map 1700 has been edited three times, the control unit 330 may provide the editing interface 1500, which includes the specific map 1700 updated based on a third edit, on the display unit of the electronic device 50, on the basis of the editing request for the map corresponding to the specific floor.

At least a part of the specific map 1700 may have at least one of the area graphic object 1800 or the node graphic object 1900 overlapped and included therein.

The area graphic object 1800 is related to the traveling mode of the robot R within a specific space within the specific floor, and may be represented (or placed) to overlap an area corresponding the specific space within the specific floor, on the specific map 1700.

The visual exterior appearance of the area graphic object 1800 may be determined by at least one of size, position, shape (or form), or color on the specific map 1700, according to the actual position, actual size, actual shape (or form), and properties of the specific space within the specific floor.

As illustrated in FIG. 15, the visual exterior appearance of each of a first area graphic object 1800a and a second area graphic object 1800b may differ in terms of size, position, shape (or form), and/or color, depending on the actual size, actual position, actual shape (or actual form), and/or properties (or type) of a first space and a second space to which the first area graphic object 1800a and the second area graphic object 1800b each correspond.

The color of the visual exterior appearance of the area graphic object 1800 may be determined on the basis of the type matched to the area graphic object (or the actual space). As illustrated in FIG. 15, when the types matched to the first area graphic object 1800a and the second area graphic object 1800b are different from each other, the colors of the first area graphic object 1800a and the second area graphic object 1800b may also be different from each other.

The node graphic object 1900 may refer to a graphic object allocated (placed, displayed, represented, or included) on the specific map 1700 to correspond to a node allocated in an actual space (which may be referred to as an actual area, target space or the like) of the specific floor. Accordingly, in some example embodiments, the terms “node graphic object 1900” and “node” may be used interchangeably.

In some example embodiments, “node” refers to a point or area that serves as a unit target for the movement of the robot, and each node may correspond to a specific point or specific area within a target space.

The node graphic object 1900 may be represented (or placed) on the specific map 1700, to overlap a position corresponding to a specific point (or specific area) within a specific floor.

Further, the node graphic object 1900 may have three different types depending on its attribute (or kind). i) A node having a first node type may refer to a travel node (travel node graphic object 1910) linked to the travel of the robots R, ii) a node having a second node type may refer to an operation node (operation node graphic object 1920) corresponding to an operation node linked to a specific operation of the robots, and/or iii) a node having a third node type may refer to a facility node (facility node graphic object 1930) corresponding to a facility node linked to a facility placed on a specific floor.

The travel node graphic object 1910 may be understood as a graphic object related to a travel node that corresponds to a travel node linked to the travel of the robots, forming part of the traveling path of the robots.

The robot R may move along the travel node on the basis of information matched to the travel node graphic object 1910 (e.g., direction information).

The operation node graphic object 1920 may be understood as a graphic object related to an operation node linked to a specific operation of the robot R.

The robot R may perform the specific operation at the travel node on the basis of the specific operation matched to the operation node graphic object 1920.

For example, assume that a waiting operation is matched to the operation node graphic object 1920. When the robot R arrives at the operation node while moving along the travel nodes, the robot R may stop traveling and enter a waiting operation.

Further, the operation node graphic object 1920 may also include the role of a travel node graphic object (or travel node).

The facility node graphic object 1930 may be understood as a graphic object corresponding to a facility node linked to a facility placed on the specific floor. More specifically, the facility node graphic object 1930 may be represented (output or provided) on the specific map 1700, to overlap a point (position) corresponding to a point (position or space) where the facility infrastructure is placed.

The facility node graphic object 1930 may be pre-allocated (or allocated) on the specific map 1700 during the process of generating the specific map 1700 corresponding to a specific floor, even if the facility node graphic object 1930 is not allocated on the specific map 1700, on the basis of editing information being received from the electronic device 50.

Further, the facility node graphic object 1930 may be allocated to a space corresponding to at least one of a specific point where a specific facility is positioned in the space of a specific floor, or a specific space that the robot needs to necessarily (or otherwise, does) pass through in order to pass through the specific facility (e.g., speed gate, elevator, etc.). That is, when the robot uses a specific facility, the robot may need to (or otherwise, does) move to at least a part of the plurality of facility node graphic objects and travel node graphic objects corresponding to the specific facility.

The visual exterior appearance of the node graphic object 1900 may be determined by at least one of position or color on the specific map 1700, according to the actual position of the node within the specific floor and the type (or property) of the node.

Specifically, the color of the visual exterior appearance of the node graphic object 1900 may be determined on the basis of the type matched to the node graphic object (or actual node).

As illustrated in FIG. 15, a type of a first node graphic object corresponds to the operation node graphic object 1920, while a type of a second node graphic object corresponds to the facility node graphic object 1930. Accordingly, the visual exterior appearances of the first node graphic object and the second node graphic object (e.g., color, shape, pattern, three-dimensional effect, icon shape, etc.) may be different from each other.

In contrast, when the types of a plurality of node graphic objects are identical (or similar), the visual exterior appearances of the plurality of node graphic objects (e.g., color, shape, pattern, three-dimensional effect, icon shape, etc.) may also be identical (or similar).

Further, the visual exterior appearance of the facility node graphic object 1930 may be configured differently depending on the kind of facility so that the kind of the corresponding facility infrastructure is represented.

For example, a facility graphic object 2000a corresponding to an elevator may be represented with a visual exterior appearance corresponding to the elevator, and a facility graphic object corresponding to a speed gate may be represented with a visual exterior appearance corresponding to the speed gate.

Next, in some example embodiments, a process may proceed to allocate at least one graphic object on the specific map 1700 included in the editing interface 1500, on the basis of information received from the electronic device 50 (S1330, see FIG. 13).

The allocated graphic object may refer to at least one of the previously described area graphic object 1800 and/or node graphic object 1900.

The control unit 330 may allocate, on the basis of a user input applied to a specific area on the specific map 1700 included in the first area 1510, one of the area graphic object 1800 or the node graphic object 1900 at a position corresponding to the specific area.

In some example embodiments, “allocating a graphic object” may be understood as overlapping and placing a graphic object on a specific area of a specific map, and matching (or setting) an area (or point) where the graphic object is placed to have a type corresponding to the type of the graphic object.

For example, as illustrated in FIG. 15, the control unit 330 may display and overlap the node graphic object 1900 on a specific area of the specific map 1700, and match a node corresponding to the node graphic object 1900 to the specific area.

The user may allocate a graphic object to a specific point on the specific map 1700 by applying a user input to a desired specific point on the specific map 1700. The details regarding a method of allocating a graphic object will be described below.

Next, in some example embodiments, a process may proceed to update the specific map 1700, on which a graphic object has been allocated, to the cloud server so that the robots R travel on a specific floor, depending on the type of the graphic object allocated on the specific map 1700 (S1340, see FIG. 13). According to some example embodiments, upon completion of the update of the specific map in operation S1440, and/or generation of the specific map to include allocated graphic object, the cloud server 20 may control the robot R to travel (e.g., using the driving unit and/or sensing unit of the robot R as discussed herein) on the basis of the specific map 1700 that includes the nodes according to the graphic object and/or the corresponding node (e.g., node information of the corresponding node).

As described above, the cloud server 20 may use the map (or map information 1700) stored in the cloud server 20 to set the movement path of the robot R within the space of the building 1000. Further, the cloud server 20 may control the robot R to move from its current position to a specific destination. The cloud server 20 may specify current position information and destination position information on the robot, set a path to reach the destination, and/or control the robot to move (e.g., using the driving unit and/or sensing unit of the robot R as discussed herein) along the set path to reach the destination.

More specifically, each of the plurality of node graphic objects 1900 may correspond to each of the plurality of nodes, and have node information for each node matched thereto. Such node information may include various types of information, representatively including coordinate information and node connection information.

First, the node information includes coordinate information. A single node specifies a specific coordinate or a range of coordinates on the map. For example, the node may be configured to specify a circular area on the map with a predetermined (or alternatively, given) area. To this end, the coordinate information included in the node may be configured as a specific coordinate or a range of coordinates.

Second, the node information includes node connection information. The single node includes information that defines another node to which the robot is able to move from the corresponding node. The node connection information may include a unique number of another node to which the robot is able to move from the corresponding node, or coordinate information specified by another node.

In addition, the node connection information may include direction information defining the directions in which the robot may move between nodes. The direction information may define whether the robot may move in only one direction or in both directions between two nodes when the robot is able to move from one node to the other.

Further, each of the plurality of facility node graphic objects 1930 of node graphic objects may correspond to each of the plurality of facilities, and have facility information for each facility matched thereto.

The facility information defines information related to the facility placed in a target space. Specifically, the facility information may include at least one of a type of facility, information related to a server corresponding to the facility, and/or node information of the node corresponding to the position where the facility is placed.

The cloud server 20 may control the robot R to move from one node to another node, and repeat this process to control the robot R to reach a target point. In the present specification, the robot moving to a specific node may mean that the robot moves to coordinate information or within a range of coordinates that the specific node designates.

Further, the area graphic object 1800 may correspond to a specific actual space, and have traveling mode information on the robot R matched thereto in a specific space. For example, the traveling mode may include modes such as a default autonomous traveling mode, a strict path-following mode, and/or a conservative traveling mode.

The cloud server 20, in controlling the movement of the robot R from one node to another, may control the robot R to move according to the traveling mode matched to the area graphic object 1800 in the space corresponding to the area graphic object 1800.

As described above, the cloud server 20 may generate the movement path of the robot R and control the travel of the robot R on the basis of the map (or map information) updated in some example embodiments.

To this end, some example embodiments provide a user environment method that allows a user to conveniently and intuitively edit (generate or change) the map (or map information) so that the cloud server 20 may efficiently set the movement path of the robot.

Hereinafter, a method by which the control unit 330 generates the map (or map information) on the basis of the information received from the electronic device 50 will be described. However, the map generation may be configured by the cloud server 20 or another system, rather than by the control unit 330. Another system may be a system established for map generation, and some example embodiments place no particular limitation thereto.

As described above, the control unit 330 may provide the editing interface 1500, which includes the specific map 1700, on the display unit of the electronic device 50 on the basis of receiving an editing request for the specific map 1700 corresponding to a specific floor from the electronic device (see FIG. 15).

The specific map 1700 may be configured as at least one of a two-dimensional or three-dimensional map of the specific floor, and may refer to a map that may be utilized to set the traveling path of the robot R.

In this case, the map may be a map prepared in advance based on simultaneous localization and mapping (SLAM) by at least one robot moving within the space 10. That is, the map may be a map generated by a vision-based (or visual) SLAM technology.

More specifically, as illustrated in (a) of FIG. 16, the robot R may travel within the building 1000 while performing sensing of the space inside the building 1000. The cloud server 20 may control the travel of the robot R so that the robot R performs sensing of the space within the building 1000.

A server related to map generation may perform a process of detecting static obstacles O1, O2, O3, and O4 within the space, on the basis of information 1610 regarding the space sensed by the robot R (see (b) of FIG. 16).

Here, the server related to map generation may refer to the map generation system 3000 according to some example embodiments or another server. For example, the other server may be the cloud server 20, or correspond to another server that performs map generation functions. Hereinafter, the map generation will be described as being performed by the cloud server 20. However, the same function (or similar functions) may be performed by the control unit 330 or another server according to some example embodiments.

The cloud server 20 may generate points having three-dimensional coordinates for the detected obstacles by using the point cloud technique.

Here, the point cloud technique, is referred to as a point data technique or point group technique, may refer to a method of providing numerous point clouds (or measured point groups) emitted from a sensor, reflected off an object, and returned to a receiver.

The point clouds (or measured point groups) may each be obtained through sampling for each point, with respect to a central coordinate system (x, y, z).

The cloud server 20 may convert the three-dimensional point clouds for the obstacles obtained using the point cloud technique into information on two-dimensional point clouds P1 and P2, as illustrated in (c) of FIG. 16. That is, the cloud server 20 may convert the three-dimensional point clouds for the detected obstacles into two-dimensional flattened point clouds P1 and P2 (or collectively, D).

Further, as illustrated in (d) of FIG. 16, the cloud server 20 may perform a process of confirming the position of the static obstacles by matching the map (or map information, M1), which includes the two-dimensional flattened point clouds, with a building plan M2 of the building 1000. More specifically, the cloud server 20 may specify the position and size of the static obstacles relative to the robot R in a state where the map M1, which includes the two-dimensional flattened point clouds, and the building plan M2 of the building 1000 overlap each other, considering the detection information and positioning of physical obstacles within the actual space.

Further, the cloud server 20 may prepare the static obstacles as figures F1 and F2 on the map M3, as illustrated in (e) of FIG. 16, on the basis of the specified position and size of the static obstacles.

In some example embodiments, the map generated through the aforementioned process may be provided on the display unit 51 of the electronic device 50, thereby providing a user environment that allows the user to perform editing on the map.

The aforementioned map generation process may be configured either by the cloud server 20 or by an operator (or administrator). In case that the map generation process is configured by an operator (or administrator), part of the aforementioned map generation process may be configured by the operator (or administrator).

As described above, in some example embodiments, in a state where the editing interface 1500 is provided on the display unit 51 of the electronic device 50, the area graphic object 1800 may be allocated on the specific map 1700 on the basis of a user input applied to the editing interface 1500.

Here, the area graphic object 1800 may be understood as being intended to set the robots R to travel (or operate) in a specific traveling mode within a specific area of a specific floor.

Hereinafter, with reference to FIG. 17A, FIG. 17B, and FIG. 18, a process of allocating the area graphic object 1800 will be described in more detail.

First, the control unit 330 may control the editing interface 1500 into an area editing mode on the basis of receiving a request for area editing from the electronic device 50.

Here, the “area editing mode” may be understood as a mode in which the area graphic object 1800 may be allocated on the specific map 1700 through the editing interface 1500, and the type and related information on the area graphic object 1800 may be set.

The control unit 330 may switch the mode of the editing interface 1500 to the area editing mode on the basis of the selection of a specific editing tool (see reference numeral 1531 in FIG. 17A) corresponding to the area editing mode, in a state where the editing interface 1500 is in a mode other than the area editing mode (e.g., a default mode).

The control unit 330 may allocate an area graphic object on the specific map 1700 on the basis of editing information received from the electronic device 50 in a state where the editing interface 1500 is operating in the area editing mode.

The editing information may include information for specifying at least one of i) the placement position of the area graphic object 1800 on the specific map 1700, ii) the size of the area graphic object 1800, iii) the shape of the area graphic object 1800, and/or iv) the type of the area graphic object 1800.

Such editing information may be formed by combining user inputs that are input regarding the first area 1510 and the second area 1520 of the editing interface 1500.

As described above, the first area 1510 of the editing interface 1500 may include the specific map 1700. Further, the second area 1520 may include a setting menu for settings related to the editing of the specific map 1700.

In this case, the second area 1520 may include a setting menu for settings related to the area graphic object, depending on the editing interface 1500 operating in the area editing mode.

The control unit 330 may specify the area graphic object 1800 to be allocated on the specific map 1700 by specifying i) the placement position, ii) the size, and/or iii) the shape of the area graphic object 1800 on the basis of the user input applied to the first area 1510.

Further, the control unit 330 may specify the type of the area graphic object 1800 on the basis of the user input applied to the second area 1520.

The control unit 330 may allocate the area graphic object on the specific map 1700 by combining the user inputs applied each to the first area 1510 and the second area 1520.

Hereinafter, a method for specifying at least one of the placement position, size, and shape of the area graphic object 1800 (a first allocation process) on the basis of the user input applied to the first area 1510, and a method for specifying the type of the area graphic object 1800 (a second allocation process) on the basis of the user input applied to the second area 1520 will be described in detail.

Hereinafter, the description will first address the first allocation process, followed by the second allocation process. However, the order of the first allocation process and the second allocation process may be changed. That is, it is apparent that the second allocation process may proceed first, followed by the first allocation process.

The control unit 330 may specify at least one of the area (or placement position) in which the area graphic object 1800 is to be positioned, size, and/or shape of the area graphic object 1800 to be allocated on the specific map 1700 on the basis of editing information received from the user input applied to the first area 1510.

The control unit 330 may specify the area graphic object 1800 to be allocated on the specific map 1700 on the basis of at least one of a first user input for the first area that specifies an area where the area graphic object 1800 will be positioned, a second user input for the first area that specifies the size of the area graphic object 1800, and/or a third user input for the first area that specifies the shape of the area graphic object.

The distinction between the first user input, second user input, and third user input may be made based on to which information the user inputs are related among the positioned area (or placement position), size, and/or shape of the area graphic object 1800, by the applied user input.

For example, when the applied user input may specify the placement position and/or the size of the area graphic object 1800, then the user input may correspond to the first user input and/or the second user input.

Accordingly, hereinafter, the user inputs for specifying the area graphic object will not be distinguished and will all be referred to simply as “user input.” This user input may be a user input for specifying at least one of the placement position, size, and/or shape of the area graphic object 1800.

The control unit 330 may receive editing information that may specify at least one of the placement position, size, and/or shape of the area graphic object, on the basis of the user input applied to the first area in a state where the editing interface 1500 is in the area editing mode.

Further, the control unit 330 may specify the area graphic object 1800 to be allocated on the specific map 1700 on the basis of the received editing information.

For example, as illustrated in FIG. 17A and FIG. 17B, the control unit 330 may receive, from the electronic device 50, editing information based on the user inputs (e.g., clicks) applied to four different specific points 1511a, 1511b, 1511c, and a fourth specific point (positioned so as to complete a rectangle shape) in the first area 1510. Further, on the basis of the received editing information, the control unit 330 may specify a rectangular-shaped first area graphic object 1810 of a specific size that is placed on the lower left side of the specific map 1700.

As another example, as illustrated in FIG. 17B, the control unit 330 may receive, from the electronic device 50, editing information based on a drag input on the first area 1510. Further, on the basis of the received editing information, the control unit 330 may specify a triangular-shaped second area graphic object 1820 of a specific size that is placed at the lower center of the specific map 1700.

As another example, as illustrated in FIG. 17B, the control unit 330 may specify a trapezoidal-shaped third area graphic object 1830 of a specific size that is placed at the center of the specific map 1700, on the basis of the editing information received from the electronic device 50.

As another example, although not illustrated, the control unit 330 may, on the basis of user input that changes at least one of the position or shape of the lines forming a pre-formed (or formed) figure in the first area 1510, specify the area graphic object 1800 corresponding to the figure changed in size and shape by the changed lines.

As described above, the area graphic object 1800 with a size and shape corresponding to the user input may be allocated in a specific area of the specific map 1700 that corresponds to the position where the user input is applied.

The user may allocate an area graphic object on a specific area of the specific map 1700 that corresponds to a specific space, in order to set the robot R to operate in a specific traveling mode within the specific space. As described above, the user may conveniently and intuitively set the operation mode of the robot R for each space within the building 1000 through the editing interface 1500 provided by some example embodiments.

As described above, the control unit 330 may switch the mode of the editing interface 1500 to the area editing mode on the basis of selecting the specific editing tool 1531 that is exposed on the editing interface 1500.

In this area editing mode state, at least one of the placement position, size, or shape of the area graphic object 1800 may be specified on the basis of the user input applied to the first area.

Accordingly, in some example embodiments, the specific editing tool 1531 (may also be referred to herein as a graphic object editing tool) may be understood as a tool that serves as a medium for user input to specify the area graphic object 1800.

The specific editing tool 1531 may form a plurality of editing tools 1530, together with other tools 1532 and 1533 that are matched to other functions.

The plurality of editing tools 1530 may be positioned in at least one area of the editing interface 1500 and, on the basis of the user input applied to the plurality of editing tools 1530, may be moved to another area of the editing interface 1500.

For example, as illustrated in FIG. 17B, the plurality of editing tools 1530 may be provided to overlap the specific map 1700 in the upper left side of the first area 1510. Further, the user may move the plurality of editing tools 1530 to a different position on the specific map 1700 through user input to the plurality of editing tools 1530.

Even if part of the specific map 1700 is covered by the plurality of editing tools 1530, the user may place the area graphic object 1800 even on the part area of the specific map 1700 that was covered, by moving the position of the plurality of editing tools 1530.

The control unit 330 may receive editing information based on user input applied to the second area 1520 of the editing interface 1500 in a state where the editing interface 1500 is operating in the area editing mode, and specify the type of the area graphic object 1800.

As described above, the type of the area graphic object is linked with the traveling mode of the robot R, and each different type of area graphic object may be linked with a different plurality of traveling modes. For example, a first type of area graphic object may be linked with a first traveling mode, while a second type of area graphic object may be linked with a second traveling mode.

Accordingly, in some example embodiments, “specifying the type of the area graphic object 1800” may be understood as specifying the traveling mode of the robot R in a specific space (or area) of a specific floor corresponding to an area graphic object.

The control unit 330 may provide a setting menu (or setting menu graphic object 1521a) on the second area 1520, as illustrated in FIG. 17B, to allow the user to select the type of the area graphic object 1800 in order to specify the type of the area graphic object 1800.

The control unit 330 may receive the selection of the type of the area graphic object on the basis of a user input (which may be referred to as a fourth user input) to the setting menu 1521 included in the second area 1520.

Further, the control unit 330 may specify the type of the area graphic object so that the robot R operates in the traveling mode linked with the selected type within the specific space (or area) of the specific floor corresponding to the area graphic object 1800.

More specifically, as illustrated in FIG. 17B, the control unit 330 may provide the setting menu 1521 that includes a first sub-setting menu graphic object 1521a and a second sub-setting menu graphic object 1521b on the second area.

In this case, the first sub-setting menu graphic object 1521a may correspond to the first type of area graphic object (or the first traveling mode), and the second sub-setting menu graphic object 1521b may correspond to the second type of area graphic object (or the second traveling mode).

The control unit 330 may receive editing information, which includes type information regarding the area graphic object 1800, from the electronic device 50 on the basis of one of the first sub-setting menu graphic object 1521a or the second sub-setting menu graphic object 1521b being selected.

The control unit 330 may determine the type of the area graphic object on the basis of the editing information. For example, when the control unit 330 receives editing information on the basis of the first sub-setting menu graphic object 1521a being selected, the control unit 330 may specify the area graphic object 1800 as the first type of area graphic object. In contrast, when the control unit 330 receives editing information on the basis of the second sub-setting menu graphic object 1521b being selected, the control unit 330 may specify the area graphic object 1800 as the second type of area graphic object.

Further, the control unit 330 may determine the operation mode of the robot R in the area graphic object on the basis of the editing information. For example, when the control unit 330 receives editing information on the basis of the first sub-setting menu graphic object 1521a being selected, the control unit 330 may specify the operation mode of the robot R in the area graphic object 1800 as a first operation mode. In contrast, when the control unit 330 receives editing information on the basis of the second sub-setting menu graphic object 1521b being selected, the control unit 330 may specify the operation mode of the robot R in the area graphic object 1800 as a second operation mode.

As described above, the area graphic object 1800 in some example embodiments may be configured to have one of a plurality of different types. In addition, the area graphic object 1800 in some example embodiments may be configured so that the robot R operates in one of the different traveling modes.

In some example embodiments, to allow the user to intuitively recognize the traveling mode of the robot R in a specific area on the specific map 1700, the visual exterior appearances of the first type of area graphic object and the second type of area graphic object may be configured differently.

Here, the term “visual exterior appearance” may refer to at least one of the color, three-dimensional effect, pattern, or included icon of the area graphic object. Hereinafter, for convenience of description, the color of the visual exterior appearance will be described as an example.

The first type of area graphic object and the second type of area graphic object may each be matched with different visual information (e.g., color information). The first type of area graphic object may be matched with first visual information, while the second type of area graphic object may be matched with second visual information.

The control unit 330 may, once the type of the area graphic object 1800 is specified, control the color of the area graphic object on the specific map 1700 to have the visual information matched to the specified type of the area graphic object 1800.

When the types specified for the plurality of area graphic objects are different from each other, the control unit 330 may display the plurality of area graphic objects on the specific map 1700 with visual characteristics corresponding to different visual information.

For example, as illustrated in FIG. 17B, the first area graphic object 1810, which is specified as the first type, may be displayed on the specific map 1700 to have the first color information matched to the first type, while the third area graphic object 1830, which is specified as the second type, may be displayed on the specific map 1700 to have the second color information matched to the second type.

In contrast, when the types specified for the plurality of area graphic objects are the same (or similar), the control unit 330 may display the plurality of area graphic objects on the specific map 1700 with visual characteristics corresponding to the same visual information (or similar visual information).

For example, as illustrated in FIG. 17B, the first area graphic object 1810 and the second area graphic object, both specified as the first type, may be displayed on the specific map 1700 with the same color information (or similar color information).

As described above, on the specific map 1700 in some example embodiments, one or more area graphic objects, having the same (or similar) or different types, may be allocated.

In some example embodiments, the type of the selected area graphic object 1800 may be determined in a state where the area graphic object has been selected first.

For example, the control unit 330 may, on the basis of receiving user selection for at least one specific area graphic object on the first area 1510, provide the setting menu 1521 on the second area 1520 to receive a selection of the type for the specific area graphic object. The control unit 330 may set the specific area graphic object as an area graphic object of a specific type when the specific type is selected through the setting menu 1521 in the second area 1520.

In this case, the setting menu 1521 may include sub-description menu graphic objects 1521a and 1521b corresponding to types of area graphic objects applicable to the type applicable to the selected area graphic object.

In addition, in some example embodiments, in a state where the type of the graphic object is first selected, the type of the specified area graphic object 1800 may be determined as the selected type.

For example, the control unit 330 may determine the type of a specific area graphic object as the pre-selected (or selected) type, on the basis of a user input to the first area 1510, in a state where a specific type is selected through the setting menu 1521 on the second area 1520.

As described above, in some example embodiments, the editing interface 1500 may be provided that allows an area graphic object linked with a specific traveling mode to be allocated on a specific map 1700 for a specific floor.

To this end, the user may control the robot R to operate in a specific traveling mode within a specific space of a specific floor corresponding to the area graphic object 1800 simply by selecting the area graphic object 1800 through the second area 1520 of the editing interface 1500.

In addition, the user may intuitively recognize the traveling mode of the robot R linked to the area graphic object 1800 through the color of the area graphic object 1800 on the specific map 1700.

As illustrated in FIG. 18, in the storage unit 320, a plurality of different traveling modes are linked to each type of a plurality of different area graphic objects 1841 to 1846, and may exist as area link information.

The area link information may include travel characteristic information 1841a to 1846a for a plurality of predefined (or preset or alternatively, given) different traveling modes.

A first type of area graphic object 1841 may be matched with a first traveling mode. The travel characteristic 1841a of the first traveling mode may be related to an operation mode that more strictly follows the path, minimizes (or reduces) avoidance, and limits (or reduces) waiting. The robot R may perform travel in a manner that strictly follows the path within a zone corresponding to the first type of area graphic object 1841.

A second type of area graphic object 1842 may be matched with a second traveling mode. The travel characteristic 1842a of the second traveling mode may be related to an operation mode that enables conservative travel. The robot R may perform relatively more conservative travel within a zone corresponding to the second type of area graphic object 1842 compared to other areas.

A third type of area graphic object 1843 may be matched with a third traveling mode. The travel characteristic 1843a of the third traveling mode may be related to a traveling mode linked with an elevator. The robot R may perform operations in a traveling mode, such as boarding, disembarking, and/or waiting in an elevator, within a zone corresponding to the third type of area graphic object 1843.

A fourth type of area graphic object 1844 may be matched with a fourth traveling mode. The travel characteristic 1844a of the fourth traveling mode may be related to a traveling mode linked with a metal wall. The robot R may perform travel in the zone corresponding to the fourth type of area graphic object 1844 in a manner that corresponds to the metal wall (e.g., performing travel to prevent (or reduce) slipping).

A fifth type of area graphic object 1845 may be matched with a fifth traveling mode. The travel characteristic 1845a of the fifth traveling mode may be related to prohibiting (or restrict) the entry of the robot R. The robot R may not enter the zone corresponding to the fifth type of area graphic object 1845.

Further, an area 1846 where no area graphic object is allocated may be matched with a sixth traveling mode. The travel characteristic 1846a of the sixth traveling mode may be related to a default autonomous traveling mode. The robot R may operate in the default autonomous traveling mode in areas where no area graphic object is allocated.

As described above, the robot R traveling within the building 1000 may travel in a specific traveling mode within a specific zone according to the traveling mode linked to the area graphic object allocated on the specific map 1700. Hereinafter, a more detailed description will be provided regarding a method by which the traveling mode of the robot R is controlled on the basis of the area graphic object allocated on the specific map 1700.

As illustrated in FIG. 17B, when at least one area graphic object 1800 is allocated, the control unit 330 may update the specific map 1700 to the cloud server 20 so that the robot R operates in a specific traveling mode within the specific zone corresponding to the area graphic object 1800.

The cloud server 20 may control the robot R to operate in one of the plurality of traveling modes in the zone corresponding to at least one area graphic object 1800, on the basis of at least one area graphic object 1800 being allocated on the specific map 1700.

The cloud server 20 may control the robot R to travel within the zone (or area) corresponding to the specific area graphic object 1810, according to the travel characteristics of the traveling mode linked to the type of the specific area graphic object 1810, within the zone (or area) corresponding to the specific area graphic object 1810.

More specifically, the cloud server 20 may control the robot R to travel according to the first traveling mode when the robot R enters the first zone (area) of a specific floor that corresponds to the area where the first type of area graphic object 1810 is allocated on the specific map 1700.

Further, when the robot R moves out of the first zone (area), the cloud server 20 may change the traveling mode of the robot R on the basis of the type of the area graphic object corresponding to the area in which the robot R is positioned after exiting the first area.

For example, when a new zone (area) in which the robot R is positioned after exiting the first zone (area) is a zone corresponding to an area where no area graphic object is allocated on the specific map 1700, the cloud server 20 may change the traveling mode of the robot R from the first traveling mode to the default traveling mode. In this case, the default traveling mode may correspond to a traveling mode that the robot R is in before entering the first area.

As another example, when the new zone (area) in which the robot R is positioned after exiting the first zone (area) is a zone (area) corresponding to an area where a second type of area graphic object 1830 is allocated on the specific map 1700, the cloud server 20 may change the traveling mode of the robot R from the first traveling mode to the second traveling mode.

As described above, the cloud server 20 may control the robot R to travel according to the second traveling mode when the robot R enters the second area (zone) of a specific floor that corresponds to the area where the second type of area graphic object 1830 is allocated on the specific map 1700.

Further, when the robot R moves out of the second zone (area), the cloud server 20 may change the traveling mode of the robot R on the basis of the type of the area graphic object corresponding to the area in which the robot R is positioned after exiting the second zone (area). For example, the cloud server 20 may change the traveling mode of the robot R from the second traveling mode to the default traveling mode. In this case, the default traveling mode may correspond to a traveling mode that the robot R was in before entering the second zone.

The cloud server 20 may generate the movement path of the robot R on the basis of at least one area graphic object 1800 being allocated on the specific map 1700.

For example, in FIG. 17B, assume that the type of the first area graphic object 1810 on the specific map 1700 is the previously described fifth type of area graphic object 1845, and the actual zone corresponding to the first area graphic object 1810 of the fifth type is referred to as the first zone.

Prior to the allocation of the first area graphic object 1810 of the fifth type on the specific map 1700, the cloud server 20 may generate a movement path 1710 passing through the first zone, as illustrated in FIG. 17A, and control the movement of the robot R along that path.

In contrast, after the first area graphic object 1810 of the fifth type is allocated on the specific map 1700, the cloud server 20 may generate a movement path 1720 that avoids the first zone, as illustrated in FIG. 17B, and control the movement of the robot R.

As described above, in some example embodiments, the editing interface 1500 that allows the area graphic object 1800 to be allocated on a specific map 1700 may be provided to the user, and the user may control the robot R to operate in a specific traveling mode within a specific zone on a specific floor simply by allocating the area graphic object 1800 on the specific map 1700 through the editing interface 1500.

As described above, in some example embodiments, in a state where the editing interface 1500 is provided on the display unit of the electronic device 50, a node graphic object may be allocated on the specific map 1700 on the basis of a user input applied to the editing interface 1500.

Here, the node graphic object 1900 may refer to a graphic object allocated (placed, displayed, represented, or included) on the specific map 1700 to correspond to a node allocated in an actual zone (which may be referred to as an actual area, space, target space or the like) of the specific floor. Accordingly, in some example embodiments, the terms “node graphic object 1900” and “node” may be used interchangeably.

In addition, “a node is allocated on the specific map 1700” may be understood as “the node graphic object 1900 is allocated on the specific map 1700” or “a node is allocated at the position of an actual zone corresponding to a point on the specific map 1700 where the node graphic object is allocated,” or “the node graphic object 1900 is allocated at a point on the specific map 1700 corresponding to the position of an actual zone where the node is allocated,” or similar interpretations.

Further, the node graphic object 1900 may have three different types depending on its attribute (or kind). For example, node graphic object 1900 attributes may include i) a node having a first type is a travel node (travel node graphic object 1910) linked to the travel of the robots R, ii) a node having a second type is an operation node corresponding to an operation node graphic object (operation node graphic object 1920) linked to a specific operation of the robots, and/or iii) a node having a third type is a facility node corresponding to a facility node graphic object (facility node graphic object 1930) linked to a facility placed on a specific floor.

In some example embodiments, robots providing services may be configured to perform operations defined by (or corresponding to) the node allocated at the position where the robots are positioned.

The operation node graphic object 1920 may be understood as a preset (or alternatively, given) node that is set for the robot R, which has moved to a specific node through travel between nodes, to perform an operation corresponding to the specific node. That is, since the operation node graphic object (or travel node, 1920) is a node that includes the role of a travel node graphic object (or travel node), it may be understood that the travel node graphic object 1910 in some example embodiments includes the operation node graphic object 1920.

The facility node graphic object 1930 is allocated to an area corresponding to at least one of a specific point where a specific facility is positioned within the actual zone (or target space) of a specific floor, or a specific area that the robot needs to necessarily (or otherwise, does) pass through in order to pass through the specific facility (e.g., speed gate, elevator, etc.). That is, when the robot uses a specific facility, the robot needs to (or otherwise, does) move to at least part of the plurality of facility node graphic objects corresponding to the specific facility.

The node graphic object 1900 described below may be understood to include at least one of the travel node graphic object 1910, the operation node graphic object 1920, or the facility node graphic object 1930.

The node graphic object 1900 may have node graphic object information corresponding to each individual node graphic object 1900. The node graphic object information may include at least three types of information.

First, the node graphic object information includes coordinate information. A single node graphic object designates a specific coordinate or a range of coordinates on the map. For example, the node graphic object 1900 may be configured to designate a circular area with a predetermined (or alternatively, given) area on the map. To this end, the coordinate information included in the node graphic object 1900 may be configured as a specific coordinate or a range of coordinates.

Second, the node graphic object information includes node graphic object connection information. A single node graphic object includes information that defines other node graphic objects 1900 to which the robot may move from the corresponding node graphic object. The node graphic object connection information may include the unique (e.g., unique among numbers identifying node graphic objects) number of another node graphic object to which the robot may move from the corresponding node graphic object, or the coordinate information designated by the other node graphic object.

Third, the node graphic object information includes facility information. The facility information defines information related to the facility placed in a target space. Specifically, the facility information may include at least one of a type of facility, information related to the server corresponding to the facility, or the node graphic object information on the node graphic object corresponding to a position where the facility is placed.

In some example embodiments, a line connecting a specific node graphic object to a node graphic object different from the specific node graphic object may be referred to as an edge or an edge graphic object.

Edge information (or edge graphic object information) may correspond (or be matched) to the edge (or edge graphic object) for each edge.

The edge information may include direction information that defines a direction in which the robot R may move between two different node graphic objects connected by the edge.

The direction information defines whether the robot may move only unidirectionally or may move bidirectionally when the robot may move from one of two node graphic objects to the other.

For example, assume that the robot R may move from the first node graphic object to the second node graphic object, but movement is restricted from the second node graphic object to the first node graphic object. The edge information corresponding to the edge connecting the first node graphic object and the second node graphic object may include direction information that defines unidirectional movement from the first node graphic object to the second node graphic object.

As another example, assume that the robot R may move both from the first node graphic object to the second node graphic object and from the second node graphic object to the first node graphic object. The edge information corresponding to the edge connecting the first node graphic object and the second node graphic object may include direction information that defines bidirectional movement between the first node graphic object and the second node graphic object.

The direction information in some example embodiments may also be described as being included in the node graphic object information. More specifically, when the direction information is included in the edge information (or edge graphic object information) corresponding to the edge (or edge graphic object) connecting the first node graphic object and the second node graphic object, in some example embodiments, it may also be described that the direction information is included in the node graphic object information corresponding to each of the first node graphic object and the second node graphic object.

That is, in some example embodiments, the direction information set for a specific node graphic object may be understood as the direction information included in the edge (or edge graphic object) related to the specific node graphic object and another specific node graphic object.

The target space of a specific floor may be divided into a plurality of zones. The specific map 1700 includes a plurality of zones. At least one node graphic object is allocated to each zone. Each zone is distinguished based on at least one node included in the zone.

In this specification, a zone may have two types depending on the type of node allocated to the zone. Specifically, a zone may be configured as either a first zone type of zone that includes nodes allocated to an area corresponding to where a facility is positioned, or a second zone type of zone that includes nodes allocated to an area not corresponding to where a facility is positioned.

Only zones of the same type (or similar types) may be allocated to each of the first and second zone types, respectively. For example, only nodes of the first node type may be allocated to the first zone type of zone, and only nodes of the second node type may be allocated to the second zone type of zone.

Each zone may have zone information corresponding each zone. The zone information may include at least one of the serial number and position information on each node included in the corresponding zone, the connection information between nodes included in the corresponding zone, the zone connection information between adjacent zones, or facility information.

The zone connection information may be generated for each zone adjacent to the corresponding zone. The zone connection information for the adjacent first zone and second zone may include node information on the first node, which is placed closest to the second zone among the nodes included in the first zone, and node information on the second node, which is placed closest to the first zone among the nodes included in the second zone. That is, the zone connection information defines the nodes that needs to (or otherwise, does) move for movement between zones.

Hereinafter, a process of allocating the node graphic object 1900, with reference to the accompanying drawings, will be described in more details.

First, the control unit 330 may control the editing interface 1500 into an node editing mode on the basis of receiving a request for node editing from the electronic device 50.

Here, the “node editing mode” may be understood as a mode in which the node graphic object 1900 may be allocated on the specific map 1700 through the editing interface 1500, and the type and related information on the node graphic object 1900 may be set.

The control unit 330 may switch the mode of the editing interface 1500 to the node editing mode on the basis of the selection of a specific editing tool (see reference numeral 1532 in FIG. 19A) corresponding to the node editing mode, in a state where the editing interface 1500 is in a mode other than the area editing mode (e.g., a default mode).

The control unit 330 may allocate the node graphic object 1900 on the specific map 1700 on the basis of editing information received from the electronic device 50 in a state where the editing interface 1500 is operating in the node editing mode.

The editing information may include information for specifying at least one of i) the placement position of the node graphic object 1900 on the specific map 1700, ii) the type of the node graphic object 1900, iii) the identification information on the node graphic object 1900, iv) the attribute information on the node graphic object 1900, v) information regarding the facility interworked with the node graphic object 1900, and/or vi) the identification information on the zone including the node graphic object 1900.

Such editing information may be formed by combining user inputs that are input to the first area 1510 and the second area 1520 in a state where the editing interface 1500 operates in the node editing mode.

As described above, the first area 1510 of the editing interface 1500 may include the specific map 1700. Further, the second area 1520 may include a setting menu for settings related to the editing of the specific map 1700.

In this case, the second area 1520 may include a setting menu for settings related to the node graphic object, depending on the editing interface 1500 operating in the node editing mode.

The control unit 330 may specify the node graphic object 1900 to be allocated on the specific map 1700 by specifying the placement position of the node graphic object 1900 on the basis of the user input applied to the first area 1510.

Further, the control unit 330 may specify the type, attribute, identification information, included zone, interworked facility, and/or visual exterior appearance (e.g., color and/or icon shape) of the node graphic object 1900 on the basis of the user input applied to the second area 1520.

Hereinafter, a method for specifying at least one of the placement position of the node graphic object 1900 (a first allocation process) on the basis of the user input applied to the first area 1510, and a method for specifying the type or the like of the node graphic object 1900 (a second allocation process) on the basis of the user input applied to the second area 1520 will be described in detail.

The order of the first allocation process and the second allocation process may be changed. That is, the second allocation process may proceed first, followed by the first allocation process, or conversely, the first allocation process may proceed first, followed by the second allocation process.

The control unit 330 may specify an area (or placement position) where the node graphic objects 1911a, 1911b, 1911c, 1911d, 1911e, and 1911f to be allocated on the specific map 1700 are to be positioned, on the basis of editing information received from the user input applied to the first area 1510.

As illustrated in FIG. 19A and FIG. 19B, the control unit 330 may output (display or provide) the node graphic objects 1911a, 1911b, 1911c, 1911d, 1911e, and 1911f at the point where the user input is applied to the first area 1510 each time user input is applied.

Further, the control unit 330 may specify a travel direction to define the travel direction of robots between nodes of at least a portion of the plurality of travel node graphic objects 1900 allocated on the specific map 1700.

This travel direction may be configured through a process in which connecting lines 1912a and 1912b (see FIG. 19B) are added to connect adjacent travel node graphic objects among the plurality of travel node graphic objects through the editing interface 1500.

The editing information may include direction information included in each of the node graphic objects 1911a, 1911b, 1911c, and/or 1911d to be allocated on the specific map 1700.

This direction information may be generated on the basis of at least one of the order or direction in which a user input is applied to the first area 1510.

As an example, the direction information may include bidirectional information guiding that the robot R may move both to the node graphic object allocated in the previous order and to the node graphic object allocated in the subsequent order relative to a specific node graphic object.

More specifically, assume that in FIG. 19A, a first node graphic object 1911a, a second node graphic object 1911b, a third node graphic object 1911c, and a fourth node graphic object 1911d are sequentially allocated. The direction information included in the second node graphic object 1911b may include bidirectional information indicating that the robot R is able to move both to the first node graphic object 1911a, which was allocated in the previous order, and to the third node graphic object 1911c, which was allocated in the subsequent order.

As another example, the direction information may include unidirectional information guiding that the robot R may only move to the node graphic object allocated in the subsequent order relative to the specific node graphic object. More specifically, the direction information included in the second node graphic object 1911b may include unidirectional information indicating that the robot R may only move to the third node graphic object 1911c, which was allocated in the subsequent order.

Further, such direction information may be generated or changed on the basis of user information input through the second area 1520. For example, the second area 1520 may include an area for receiving direction information as input. The control unit 330 may generate or change direction information on a specific node graphic object on the basis of the direction information being input for the specific node graphic object through the second area 1520.

Further, the control unit 330 may control the connecting lines 1912a and 1912b to be configured as arrows. The control unit 330 may, on the basis of the direction information included in each of the plurality of node graphic objects 1911a, 1911b, 1911c, and 1911d, represent the possible movement directions of the robot R on the specific map 1700 using connecting lines with arrows 1912a and 1912b (see FIG. 19B).

The user may conveniently and easily allocate a node graphic object on the area of the specific map 1700 corresponding to an actual specific point simply by applying a user input to the editing interface 1500.

The control unit 330 may receive editing information based on user input applied to the second area 1520 of the editing interface 1500 in a state where the editing interface 1500 is operating in the node editing mode, and specify information related to the specific node graphic object 1900.

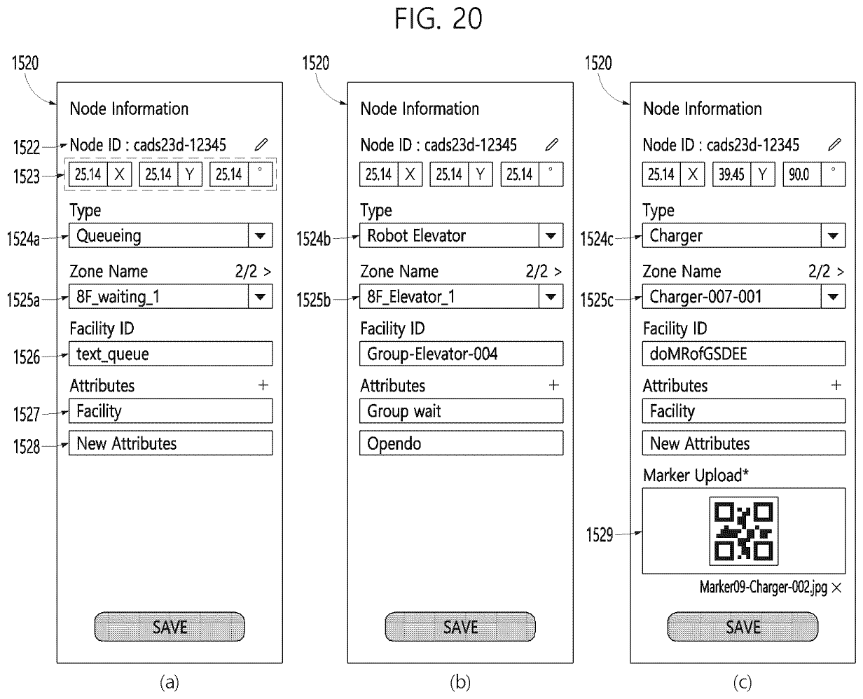

As illustrated in FIG. 20, in some example embodiments, settings for various information related to a specific node graphic object may be configured through the second area 1520.

As illustrated in FIG. 20, the various information related to a specific node graphic object may include at least one of i) identification information 1522 on the node graphic object (e.g., node ID, node name, identification number, etc.), ii) coordinate information 1523 on the node graphic object, iii) information 1524a, 1524b and 1524c on one of a plurality of types for (or of) the node graphic object, iv) zone information 1525a, 1525b, and 1525c on one of a plurality of different zones that include the node graphic object, v) facility information 1526 on a facility interworked with the node graphic object, vi) information 1527 and 1528 related to one of a plurality of attributes for the node graphic object, and/or vii) marker information 1529 related to the facility interworked with the node graphic object.

The control unit 330 may provide, on the second area 1520, information related to the selected node graphic object and an area for receiving the information as input, on the basis of one of the plurality of node graphic objects allocated on the specific map 1700 being selected.

First, the identification information 1522 on the node graphic object may be set differently for each of the plurality of node graphic objects. For example, different first and second node graphic objects may each be matched with different first and second identification information, respectively.

Second, the coordinate information 1523 on the node graphic object may include coordinate information and angle information (which may also be referred to as “direction information”) on one of two-dimensional coordinates (x, y) or three-dimensional coordinates (x, y, z).

The coordinate information may be determined (or generated) on the basis of the user input entered on the first area 1510. The control unit 330 may match the coordinate information corresponding to the user input applied to the first area 1510 to the node graphic object 1900 allocated on the specific map 1700 on the basis of the user input.

The coordinate information may include the coordinates of a point at which a specific node graphic object is allocated. Such coordinate information may be matched to the specific node graphic object on the basis of the user input entered in the first area 1510.

The coordinate information may be changed on the basis of a user input that changes the position of a node graphic object pre-allocated (or allocated) in the first area 1510.

More specifically, the control unit 330 may change coordinate information matched to a node graphic object from coordinate information corresponding to a first point to coordinate information corresponding to a second point when the node graphic object allocated to the first point on the specific map 1700 is moved to the second point on the basis of a user input (e.g., drag).

In contrast, the coordinate information may be configured not to be arbitrarily changed by the user input applied to the second area 1520 (e.g., the extent to which the use may change the coordinate information may be restricted).

For example, the control unit 330 may deactivate the function of being applied with a user input in an area where the coordinate information is output on the second area 1520, thereby preventing the coordinate information of the node graphic object from being changed through the second area (or reducing the occurrence thereof).

The angle information is information related to a direction in which the robot R positioned at an actual node corresponding to the node graphic object is facing. This angle information may be information that defines how much the robot R needs to (or otherwise, does) rotate by a certain angle in a certain direction (e.g., clockwise or counterclockwise) relative to a reference line (or reference point) on the specific map 1700, in order for the front of the robot R to face a certain direction.

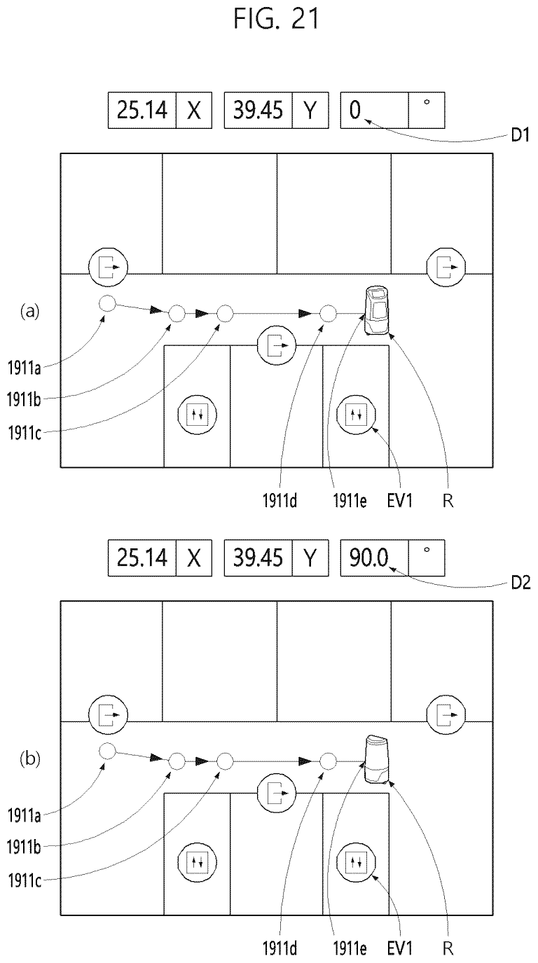

For example, as illustrated in (a) of FIG. 21, when a specific node graphic object is matched with angle information D1 of 0°, the robot R may position itself at the node corresponding to the specific node graphic object by rotating 0° relative to the reference line (or reference point).

As another example, as illustrated in (b) of FIG. 21, when a specific node graphic object is matched with angle information D2 of 90°, the robot R may position itself at the node corresponding to the specific node graphic object by rotating 90° relative to the reference line (or reference point).

The user may control the robot R to wait while facing the elevator (e.g., EV1) at the node related to waiting for the elevator by setting the angle information so that the front of the robot R is related to the elevator direction at the node related to waiting for the elevator, as illustrated in (a) of FIG. 21.

The angle information may be matched to the node graphic object as a preset (or alternatively, given) value on the basis of the allocation of the node graphic object on the specific map 1700. The preset (or alternatively, given) value, which may be referred to as default angle information (or default angle value, default value), is angle information preset (or alternatively, given) by the administrator of the system 3000.

This default angle information may be changed on the basis of the user input applied to the second area 1520.

The control unit 330 may activate the function of being applied with a user input in an area where the angle information is output on the second area 1520, allowing the angle information on the node graphic object to be changed through the second area.

Thirdly, the type information 1524a, 1524b and 1524c for the node graphic object is information that determines the attribute of the node graphic object, and may be information related to one of the types of node graphic objects such as i) travel node graphic object linked with the travel of the robot R, ii) operation node graphic object linked with the operation of the robot R, and/or iii) facility node graphic object related to a facility.

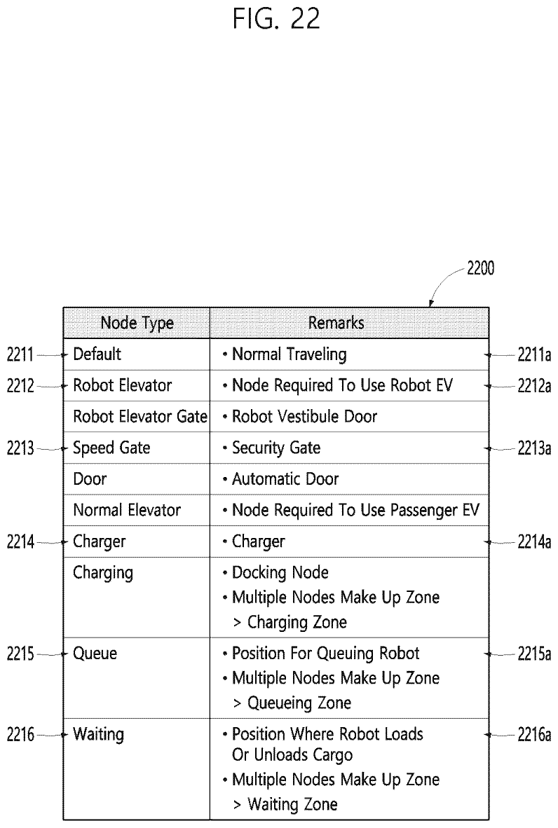

As illustrated in FIG. 22, node type information 2200 related to the type of the node graphic object may exist in the storage unit 320. In each node type information, the node may be matched with one of a first node type (travel type node), a second node type (operation type node), or a third node type (facility type node).

For example, in FIG. 22, first node information (“Default”, 2211) may be matched with the first type node (travel type node), which is a node linked with the normal travel of the robot R (2211a). In addition, second node information (“Robot Elevator”, 2212), third node information (“Speed Gate”, 2213), and the fourth node information (“Charging”, 2214) may each be matched with the third type node (facility type node), which is related to facilities positioned within the building 1000 (2212a, 2213a and 2214a). In addition, fifth node information (“Queue”, 2215) and sixth node information (“Waiting”, 2216) may each be matched with the second type node (operation type node), which is related to the operation of the robot R (queuing 2215a or waiting 2216a).

The control unit 330 may determine (or set) the type of a specific node graphic object on the basis of one of the plurality of node type information being selected through the user input applied to the second area 1520. Further, the control unit 330 may match the determined (or set) type to the specific node graphic object.

For example, as illustrated in (a) of FIG. 20, when “Queuing 1524a” is selected in the second area 1520, the control unit 330 may match the specific node graphic object with the second node type (operation node type).

When the robot R is positioned at the operation node corresponding to the second node type, the cloud server 20 may control the robot R to perform the specific operation matched to the second node type (e.g., allowing the robot R to stop traveling and perform waiting or queuing).

As another example, as illustrated in (b) and (c) of FIG. 20, when “Robot Elevator 1524b” or “Charger 1524c” is selected in the second area 1520, the control unit 330 may match the specific node graphic object with the third node type (facility node type).

Fourth, the zone information 1525a on the node graphic object may be understood as information that groups at least some of the nodes allocated on the specific map 1700 to be included in the same zone (or similar zones).

As illustrated in FIG. 23A, among the plurality of nodes allocated on the specific map 1700, at least some of the nodes 2311a, 2312a, and 2313a are grouped into a first group to be included in the first same zone 2310a, while some other of the nodes 2311b, 2312b, and 2313b are grouped into a second group to be included in the second same zone 2310b.

The control unit 330 may provide the plurality of nodes grouped into the same group (or similar groups) to be included in the same zone (or a similar zone) on the first area 1510 with the same visual exterior appearance (e.g., color, shape, pattern, three-dimensional effect, icon shape, etc.) (or similar visual exterior appearances) so that the user may intuitively recognize the plurality of nodes grouped into the same zone (or similar zones) simply by viewing the editing interface 1500.

For example, in FIG. 23A, the plurality of nodes 2311a, 2312a, and 2313a grouped into the first group to be included in the first same zone 2310a may include the same icon (e.g., a lightning-shaped icon) (or similar icons).

As another example, in FIG. 23A, the plurality of nodes 2311b, 2312b, and 2313b grouped into the second group to be included in the second same zone 2310b may be provided on the first area 1510 with the same color (or similar colors).

On the basis of the user input applied to the second area 1520, the control unit 330 may group at least part of the plurality of nodes allocated on the specific map 1700 into the same group (or similar groups) to be included in the same zone (or similar zones).

In some example embodiments, “grouping nodes” may be understood as “including nodes in a specific same zone,” “adding nodes to a specific group,” or “registering nodes in a specific zone.”

As illustrated in FIG. 23B, on the basis of the user input (or user information) applied through the second area 1520, the control unit 330 may group at least part of the plurality of nodes allocated on the specific map 1700 into the same group (or similar groups).

When one of the plurality of node graphic objects allocated on the specific map 1700 is selected (e.g., in response to the selection), at least one of the identification information on the selected node or the identification information on the zone that includes the selected node may be provided in the second area 1520.

When the selected node is not included in a specific zone, the control unit 330 may activate the function for the user of selecting user input 2320 to allow the selected node to be included in a specific zone, as illustrated in (a) of FIG. 23B, on the second area 1520.

As illustrated in (b) of FIG. 23B, the control unit 330 may provide a zone list 2321 that includes items corresponding to at least one zone (e.g., “Waiting-007-001,” “Waiting-007-002”) existing on the specific floor. The control unit 330 may allow the selected node graphic object to be included in the zone corresponding to the selected item, on the basis of one of the items in the zone list 2321 being selected.

Further, the control unit 330 may generate a new zone and allow the selected node graphic object to be included in the newly generated zone when receiving a zone generation request from the electronic device 50 on the basis of the user selection input on the second area 1520.

As illustrated in (c) of FIG. 23B, when an area 2322 corresponding to “Add New” is selected in the second area 1520, the control unit 330 may generate a new zone and then allow the selected node to be included in the new zone.

In this case, the new zone may be linked with the specific floor on which the selected node is positioned. For example, when the selected node is positioned on the 7^{th} floor, the new zone may be generated and linked to the 7^{th} floor.

Various information related to a specific zone may exist to be matched with the specific zone.

The control unit 330 may, on the basis of receiving a request for providing specific zone information from the electronic device 50, provide various information related to the specific zone on the second area 1520 of the editing interface 1500, as illustrated in FIG. 23C.

The “request for providing specific zone information” may be configured in various ways. For example, in the process of allowing a specific node graphic object to be included in a specific zone, as illustrated in FIG. 23B, the request for providing specific zone information may be configured on the basis of the user input for the name of the specific zone being applied. As another example, as illustrated in FIG. 23F, the request for providing specific zone information may be configured on the basis of one of items 2361, 2362, 2363, 2364, and 2365 included in a zone list 2360 provided in the second area 1520 being selected.

As illustrated in FIG. 23C, the specific zone information may include at least one of i) identification information on the specific zone (e.g., Waiting-007-001), ii) type (or attribute) information 2331 on the specific zone, iii) service information 2332 related to the specific zone, iv) a label 2333 (or keyword information) related to the specific zone, v) facility information 2334 linked (or interworked) with the specific zone, and/or vi) a node list 2335 including items 2335a, 2335b, and 2335c corresponding to at least one node graphic object included in the specific zone.

In the storage unit 320 according to some example embodiments, the specific zone and the specific zone information may be matched with each other and exist as matching information.

The type information 2331 on the specific zone may be determined (specified or set) on the basis of the type of at least one node graphic object included in the specific zone, or may be determined (specified or set) on the basis of the user selection.

More specifically, when a specific type of node graphic object (e.g., a facility node graphic object) is included in the specific zone, the type of the specific zone may be set to the type corresponding to the specific node graphic object (e.g., facility zone).

Further, when the specific zone includes node graphic objects of different types, the type of the specific zone may be set on the basis of the common purpose pursued by the different types of node graphic objects.

For example, assume that the specific zone includes a facility node graphic object corresponding to an elevator and an operation node graphic object corresponding to a waiting operation where the robot waits for the elevator in front of the elevator. In this case, the type of the specific zone may be related to elevator use.

The control unit 330 may activate the selection or input function for the second area 1520 to allow user input to be configured for one of the specific zone information in a state where the specific zone information is output in the second area 1520.

The control unit 330 may, on the basis of the information selected or input through the second area 1520, set (determine or specify) or change the specific zone information for the specific zone.

For example, when facility information 2334 to be interworked (or linked) with the specific zone is received through the second area 1520 as input, the control unit 330 may interwork the specific zone with the input facility information. More specifically, the control unit 330 may interwork at least one node graphic object included in the specific zone with the input facility information.

As another example, the control unit 330 may set or change the type of the specific zone on the basis of the user input applied through the second area 1520.

As described above, in some example embodiments, information regarding a specific zone may be set on the basis of the information input through the second area 1520, and the information input through the second area 1520 may be referred to as “editing information” in some example embodiments, as previously described.

Each of the plurality of node graphic objects included in the same zone (or similar zones) may be matched with a priority. Further, as illustrated in (a) of FIG. 23D, a node list 2335, in which items 2335a, 2335b, and 2335c corresponding to each node graphic object are sorted on the basis of the priority, may be provided on the second area 1520.

Here, “priority” is related to the order of use by the robot R, where a node graphic object with a higher priority may be used before a node graphic object with a lower priority.

For example, assume that a specific zone includes a first facility node graphic object corresponding to a first charger and a second facility node graphic object corresponding to a second charger, where the first facility node graphic object is matched with a first priority and the second facility node graphic object is matched with a second priority. The control unit 330 may generate a movement path (or traveling path) for the robot R to move to the first charger, which has a higher priority, and perform charging when both the first charger and the second charger are available.

In the node list 2335, the plurality of items 2335a, 2335b, and 2335c may be sequentially sorted from the item corresponding to the node graphic object with a higher priority to the item corresponding to the node graphic object with a lower priority.

For example, as illustrated in (a) of FIG. 23D, in the node list 2335, a first item 2335a corresponding to a first node graphic object (e.g., “NODE_A”) matched with a first priority may be positioned at the very top (e.g., a highest position). Below the first item 2335a, a second item 2335b corresponding to a second node graphic object (e.g., “NODE_B”), which is matched with a second priority lower than the first priority, may be positioned. Below the second item 2335b, a third item 2335c corresponding to a third node graphic object (e.g., “NODE_C”), which is matched with a third priority lower than the second priority, may be positioned.

Further, as illustrated in (a) of FIG. 23E, each of the plurality of node graphic objects 2350a, 2350b, and 2350c allocated on the specific map 1700 may include priority information matched to each node graphic object.

For example, the first node graphic object 2350a includes the number “1” corresponding to the first priority, the second node graphic object 2350b includes the number “2” corresponding to the second priority, and the third node graphic object 2350c includes the number “3” corresponding to the third priority.

The cloud server 20 may perform control of the robot R on the basis of the priority matched (or allocated) to each of the plurality of node graphic objects included in the specific zone.

More specifically, the cloud server 20 may generate the movement path of the robot R in first consideration of the first node among the first to third nodes, on the basis of the first to third priorities matched (or allocated) to each of the first to third node graphic objects 2350a, 2350b, and 2350c included in the same zone (or similar zones).

For example, assume that each of the first to third node graphic objects 2350a, 2350b, and 2350c included in the same zone (or similar zones) is a graphic object corresponding to the first to third chargers. The cloud server 20 may control the robot R to perform charging at the first charger corresponding to the first node graphic object, which has the first priority allocated (or matched), when all of the first to third chargers are in an empty state (or a chargeable state).

The control unit 330 may change the priority of the plurality of node graphic objects included in the same zone (or similar zones) on the basis of the user input applied to the editing interface 1500. Further, on the basis of the priority of the plurality of node graphic objects being changed, the priority information included in the plurality of node graphic objects provided on the specific map 1700 may be updated.

As illustrated in (b) of FIG. 23D, when one item (e.g., first item, 2335a) among the plurality of items included in the node list on the second area 1520 is selected, a highlighted indication with a visual exterior appearance distinct from other items 2335b and 2335c may be configured for the selected item 2335a, allowing the user to intuitively recognize which item is the selected item.

Further, the control unit 330 may change the position of the selected item 2335a on the node list on the basis of receiving a selection of the position to move the selected item 2335a from the electronic device 50, in a state where one item (e.g., first item, 2335a) is selected on the node list.

For example, as illustrated in (c) of FIG. 23D, on the basis of a user input (e.g., a drag) to move the selected item 2335a under the third item 2335c while the user has selected one item (e.g., first item 2335a) from the node list, the control unit 330 may move the selected item (e.g., first item 2335a) under the third item 2335c, as illustrated in (d) of FIG. 23D.

Further, the control unit 330 may change (or update) the priority matched to each node graphic object on the basis of the changed position of items 2335a, 2335b, and 2335c on the node list.

For example, as illustrated in (d) of FIG. 23, the first priority may be matched to the second node graphic object corresponding to the second item 2335b positioned at the top of the node list 2335, the second priority may be matched to the third node graphic object corresponding to the third item 2335c, and the third priority may be matched to the first node graphic object corresponding to the first item 2335a.

Further, the control unit 330 may change (or update) the priority information included in each of the plurality of node graphic objects 2350a′, 2350b′, and 2350c′ allocated on the specific map 1700, as illustrated in (b) of FIG. 23E, on the basis of the change (or update) in the priority matched to each of the plurality of node graphic objects included in the same zone (or similar zones).

For example, the first node graphic object 2350a′ may be updated to include the number “3” corresponding to the changed third priority, the second node graphic object 2350b′ may be updated to include the number “1” corresponding to the changed first priority, and the third node graphic object 2350c′ may be updated to include the number “2” corresponding to the second priority.

Further, the cloud server 20 may perform control of the robot R differently from before the priority change, on the basis of the change in the priority matched (or allocated) to each of the plurality of node graphic objects included in the specific zone.

More specifically, the cloud server 20 may generate the movement path of the robot in first consideration of the second node among the first to third nodes, on the basis of the change in which the first priority is matched (or allocated) to the second node graphic object among the first to third node graphic objects 2350a′, 2350b′, and 2350c′ included in the same zone (or similar zones).

For example, the cloud server 20 may control the robot R to perform charging at the second charger corresponding to the second node graphic object, which has the first priority allocated (or matched), when all of the first to third chargers are in an empty state (or a chargeable state).

The editing interface 1500 according to some example embodiments may provide a user interface capable of editing and managing information on the zone.

As illustrated in (a) of FIG. 23F, the control unit 330 may provide a zone list 2360 on the second area 1520 on the basis of receiving a request for providing the zone list from the electronic device 50.

The zone list 2360 may include at least one item corresponding to a zone (hereinafter, a plurality of items 2361 to 2365).

The plurality of items included in the zone list 2360 may correspond to items corresponding to zones linked to a specific floor. For example, the zone list 2360 may include items corresponding to each of the first to fifth zones linked to the seventh floor.

Each item included in the zone list 2360 may include identification information on the zone corresponding to a specific item 2361 (e.g., “ZONE-ID-001”) and quantity information on the node graphic objects included in the zone corresponding to the specific item 2361 (e.g., “5”, 2361a). Through the quantity information, the user may intuitively recognize the number of node graphic objects included in each zone.

Further, each item included in the zone list 2360 may further include a function icon 2365a for receiving a deletion request for the zone corresponding to a specific item 2365.

The control unit 330 may delete information related to the specific zone corresponding to the specific item 2365, which includes the function icon 2365a, on the basis of receiving the user input for the function icon 2365a. In this case, when the function icon 2365a is selected, the control unit 330 may output guidance information guiding the deletion of zone information, as illustrated in (b) of FIG. 23F (“Deleting a zone also removes all information on the zone entered in node. Delete a zone?”).

The control unit 330 may delete information related to the specific zone on the basis of receiving the user input for the function icon 2365a. Further, the control unit 330 may delete information on the specific zone to which at least one node graphic object included in the specific zone is pre-matched (or matched). That is, the control unit 330 may release grouping of the node graphic objects that were included in the specific zone to be no longer included in the specific zone.

Further, the control unit 330 may release the allocation of at least one node graphic object included in the specific zone on the specific map 1700, on the basis of receiving the user input for the function icon 2365a related to the specific zone. That is, the control unit 330 may delete the node graphic object so that the node graphic object displayed to overlap the specific map 1700, is no longer provided on the specific map 1700.

As described above, some example embodiments may provide a user interface not only for individually deleting specific node graphic objects allocated on the specific map 1700 but also for collectively deleting a plurality of node graphic objects included in a specific zone at once.

As described above, some example embodiments may provide a user interface that allows the user to freely and conveniently group a plurality of nodes into a single zone and edit the priority of the plurality of nodes included within the same zone (or similar zones). Therefore, the user may conveniently set the traveling paths and operations of robots R providing services within the building 1000 through the user interface provided by some example embodiments, and may intuitively recognize the set content.

This user interface of some example embodiments may provide an optimized (or improved) service for efficiently managing robots R in the building 1000 configured with a plurality of floors and where a plurality of robots R are present.

As described above, at least one of the node graphic object 1900 or the zone allocated on the specific map 1700 may have facility information on a facility positioned on a specific floor within the building 1000 matched thereto.

The control unit 330 may interwork the facility with the specific node graphic object 1900 or the plurality of node graphic objects included in the specific zone on the basis of the facility information matched to at least one of the node graphic object 1900 or the zone.

As illustrated in (a) and (b) of FIG. 24, the control unit 330 may interwork the specific node with at least one facility infrastructure 2420, 2430, and 2440 included in facility information 2410, on the basis of the facility information 2410 input through the second area 1520.

Here, “interworking the node with the facility infrastructure” means that the node and facility are operated in association with each other. For example, when the robot R is positioned at a specific node positioned on a specific floor, the elevator interworked with the specific node may be controlled to move to a specific floor.

The interworking of the node and the facility infrastructure may be configured between at least one node and at least one facility infrastructure. More specifically, the node and facility infrastructure may be interworked on a one-to-one basis, or a plurality of facility infrastructure may be interworked with a single node. Additionally, a single facility infrastructure may be interworked with a plurality of nodes.

As described above, the control unit 330 may perform interworking between a specific node (or a plurality of nodes included in a specific zone) and a specific facility on the basis of the facility information input through the second area 1520 of the editing interface 1500.

As described above, some example embodiments provide a user interface through the editing interface 1500 that allows the user to set interworking between nodes and facilities. The user may conveniently and easily interwork the node with the facility infrastructure simply by inputting facility information regarding the facility infrastructure into the editing interface 1500.

As described above, the user may allocate the area graphic objects 1800 with a plurality of types and node graphic objects 1900 on the specific map 1700 through the editing interface 1500 according to some example embodiments (see FIG. 15).

When the plurality of graphic objects 1800 with different types and the plurality of node graphic objects 1900 with different types are allocated on the specific map 1700, it may be challenging for the user to intuitively recognize the area graphic objects and node graphic objects on the specific map 1700.

To this end, in some example embodiments a graphic object for each type on the specific map 1700 may be filtered and provided on the basis of the type of graphic object.

As illustrated in FIG. 25A, the control unit 330 may provide a filtering area 2600 related to the filtering function for at least one type of graphic object allocated on the specific map 1700 in the second area 1520, in a state where the specific map 1700 corresponding to a specific floor is being provided in the first area 1510 of the editing interface 1500.

The filtering area 2600 may include information 2610, 2620, 2630 and 2640 related to the plurality of graphic object types allocated on the specific map 1700, as well as checkboxes matched to each of the information related to the plurality of graphic object types.

The control unit 330 may provide only the type of graphic object corresponding to the checkboxes checked on the basis of the user input to the filtering area 2600, to overlap the specific map 1700 in the first area 1510.

For example, as illustrated in FIG. 25A, when the checkboxes corresponding to a first specific type (“Virtual Wall,” 2630) and a second specific type (“Advanced Area,” 2640) are selected in the filtering area 2600, the control unit 330 may provide a graphic object 2651 of a first specific type and a graphic object 2652 of a second specific type, to overlap the specific map 1700 in the first area 1510. In this case, the control unit 330 may restrict the output of graphic objects corresponding to a third specific type (“Node,” 2610) and a fourth specific type (“Edge,” 2620), which correspond to the unchecked checkboxes.

In another example, as illustrated in FIG. 25B, when the checkboxes corresponding to the third specific type (“Node,” 2610) and the fourth specific type (“Edge,” 2620) are selected in the filtering area 2600, the control unit 330 may provide a graphic object 2661 of the third specific type and a graphic object 2662 of the second specific type, to overlap the specific map 1700 in the first area 1510. In this case, the control unit 330 may restrict the output of graphic objects corresponding to the first specific type (“Virtual Wall,” 2630) and the second specific type (“Advanced Area,” 2640), which correspond to the unchecked checkboxes.

Hereinafter, the description will first address the first allocation process, followed by the second allocation process. However, the order of the first allocation process and the second allocation process may be changed. That is, it is apparent that the second allocation process may proceed first, followed by the first allocation process.

The map generation method and system for robot operation according to some example embodiments may provide an editing interface that includes at least part of the specific map corresponding to a specific floor on the display unit of an electronic device in response to receiving a map editing request for the specific floor among the plurality of floors in the building. Therefore, the user may generate and edit each floor-specific map for a building configured with a plurality of floors. Accordingly, the user may generate and correct each floor-customized maps by reflecting the characteristics of each floor in a building configured with a plurality of floors.

Further, the map generation method and system for robot operation according to some example embodiments may allocate a graphic object on the specific map included in the editing interface on the basis of editing information received from an electronic device. Therefore, since the user may prepare and edit the map simply by allocating graphic objects in the editing interface, even an unskilled user may conveniently and easily prepare and edit the map.

Further, the map generation method and system for robot operation according to some example embodiments may update a specific map allocated with graphic objects to the cloud server so that the robots may travel on the specific floor according to the attributes of the graphic objects allocated on the specific map. Therefore, the robot may efficiently travel by following a global plan on the basis of a map that reflects interactions between robots, between robots and humans, and between robots and various facility infrastructure placed in the building, without the need to process complex environments.

Further, a robot-friendly building according to some example embodiments may use technological convergence in which robotics, autonomous driving, AI, cloud technologies are fused and connected and provide a new space where these technologies, robots, and facility infrastructure provided in the building are organically combined.

Further, a robot-friendly building according to some example embodiments is capable of systematically managing the travel of a robot providing services in a more systematic manner by organically controlling a plurality of robots and facility infrastructure using the cloud server that interworks with the plurality of robots. Therefore, the robot-friendly building according to some example embodiments may provide various services to humans more safely, quickly, and accurately.

Further, the robot applied to the building according to some example embodiments may be implemented in a brainless form controlled by the cloud server, according to which a large number of robots placed in the building may be manufactured at a lower cost without expensive sensors, and may be controlled with high performance and high precision.

Furthermore, in the building according to some example embodiments, robots and humans may coexist naturally in the same space (or similar spaces) by controlling the travel of the robots to take into account humans, in addition to taking into account tasks allocated to the plurality of robots placed in the building and a situation in which the robots are moving.

Further, in the building according to some example embodiments, by performing various controls to prevent (or reduce) accidents by robots and respond to unexpected situations, it is possible to instill in humans the perception that robots are friendly and safe, rather than dangerous.

Some example embodiments described above may be executed by processing circuitry (e.g., one or more processors) on a computer and implemented by executing a program that may be stored on a non-transitory computer-readable medium.

Further, some example embodiments described above may be implemented as computer-readable code or instructions on a non-transitory medium in which a program is recorded. That is, the various control methods according to some example embodiments may be provided in the form of a program, either in an integrated or individual manner.

Generally, control of robots performing tasks inside a building (e.g., a multi-floored building also occupied by people) is a complex process that takes into consideration structures and objects of the building as well as movement of robots (and people) in in the building. However, according to some example embodiments, improved devices and methods are provided for controlling robots inside a building. For example, the improved devices and methods may provide a graphical user interface that permits the allocation of graphical objects and/or nodes. The graphical objects may be associated with attributes, and/or the nodes may be associated with different types, according to which the robots may be controlled. Therefore, the graphical objects and/or nodes account for the complexity of the process such that a user of the graphical user interface may accurately and intuitively place nodes along which robots may travel, thereby controlling the robots in the building conveniently, effectively and safely.

The non-transitory computer-readable medium includes all kinds of storage devices for storing data readable by a computer system. Examples of non-transitory computer-readable media include hard disk drives (HDDs), solid state disks (SSDs), silicon disk drives (SDDs), ROMs, RAMs, CD-ROMs, magnetic tapes, floppy discs, optical data storage devices, etc.

Further, the non-transitory computer-readable medium may be on a server or cloud storage that includes storage and that the electronic device is accessible through communication. In this case, the computer may download the program according to some example embodiments from the server or cloud storage, through wired or wireless communication.

Further, in some example embodiments, the computer described above is an electronic device equipped with a processor, that is, a central processing unit (CPU), and is not particularly limited to any type.

It should be appreciated that the detailed description is interpreted as being illustrative in every sense, not restrictive. The scope of the inventive concepts should be determined on the basis of the reasonable interpretation of the appended claims, and all of the modifications within the equivalent scope of the inventive concepts belong to the scope of the inventive concepts.

1. A method of generating a map, comprising:
receiving a map editing request for a specific floor among a plurality of floors of a building;
providing an editing interface on a display unit of an electronic device in response to the map editing request, the editing interface including at least a part of a specific map corresponding to the specific floor;
allocating at least one graphic object on the specific map based on editing information received from the electronic device; and
updating the specific map on a cloud server based on completion of the allocating such that robots travel through the specific floor according to an attribute of the at least one graphic object.

2. The method of claim 1, wherein the at least one graphic object includes at least one of:
an area graphic object for specifying a traveling mode of the robots for a specific area of the specific floor;
a travel node graphic object corresponding to a travel node linked to travel of the robots, for configuring a traveling path of the robots;
an operation node graphic object corresponding to an operation node linked to a specific operation of the robots; or
a facility node graphic object corresponding to a facility node linked to a facility on the specific floor.

3. The method of claim 2, wherein
the at least one graphic object includes the area graphic object;
the allocating includes allocating the area graphic object to the specific area; and
the updating causes the robots to travel the specific area according to travel characteristics of the traveling mode linked to the area graphic object.

4. The method of claim 3, wherein the area graphic object is configured to have one type among a plurality of different types, each of the plurality of different types being linked to a different traveling mode.

5. The method of claim 4, wherein
the at least one graphic object includes a plurality of area graphic objects, each of the plurality of area graphic objects having a corresponding type among the plurality of different types;
the plurality of different types include a first type of area graphic object and a second type of area graphic object, the first type of area graphic object being linked to a first traveling mode, and the second type of area graphic object being linked to a second traveling mode different from the first traveling mode; and
a visual exterior appearance of the first type of area graphic object is different from a visual exterior appearance of the second type of area graphic object.

6. The method of claim 5, wherein
the plurality of area graphic objects includes a first area graphic object and a second area graphic object, the first area graphic object being of the first type of area graphic object, and the second area graphic object being of the second type of area graphic object;
the allocating includes
allocating the first area graphic object to a first specific area of the specific floor, and
allocating the second area graphic object to a second specific area of the specific floor; and
the updating causes the robots to
travel according to the first traveling mode based on entering the first specific area,
travel according to a third traveling mode based on exiting the first specific area, the third traveling mode being a traveling mode the robots had before entering the first specific area,
travel according to the second traveling mode based on entering the second specific area, and
travel according to a fourth traveling mode based on exiting the second specific area, the second traveling mode being a traveling mode the robots had before entering the second specific area.

7. The method of claim 4, wherein the editing information includes information for specifying at least one of:
a placement position of the area graphic object on the specific map;
a type of the area graphic object;
a size of the area graphic object; or
a shape of the area graphic object.

8. The method of claim 7, wherein
the editing interface includes a first interface area and a second interface area, the first interface area including the specific map, and the second interface area including a setting menu for a setting related to editing of the specific map; and
the editing information is based on a user input that is input to at least one of the first interface area or the second interface area.

9. The method of claim 8, wherein the editing information is based on at least one of:
a first user input to the first interface area specifying a positioning area where the area graphic object is to be positioned;
a second user input to the first interface area specifying a size of the area graphic object; or
a third user input to the first interface area specifying a shape of the area graphic object.

10. The method of claim 9, wherein the editing interface includes a graphic object editing tool in the first interface area, the graphic object editing tool being configured to receive the first user input, the second user input and the third user input.

11. The method of claim 9, wherein the allocating of the at least one graphic object includes:
specifying the area graphic object based on at least one of the first user input, the second user input, or the third user input; and
receiving a selection of the one type of the area graphic object based on a fourth user input to the setting menu.

12. The method of claim 11, wherein the allocating of the at least one graphic object includes configuring a color of the area graphic object on the specific map to have a color matched to the one type of the area graphic object.

13. The method of claim 2, wherein
the updating causes the robots to travel along a traveling path formed by a plurality of travel nodes, each of the plurality of travel nodes corresponding to one among a plurality of travel node graphic objects allocated on the specific map;
the allocating of the graphic object includes configuring a travel direction specification to define a traveling direction of the robots between at least a portion of the plurality of travel nodes; and
the method further comprises receiving the travel direction specification through the editing interface, the receiving of the travel direction specification includes adding a connecting line that connects adjacent travel node graphic objects among the plurality of travel node graphic objects through the editing interface.

14. A method of generating a map, comprising:
receiving a map editing request for a specific floor among a plurality of floors of a building;
providing an editing interface on a display unit of an electronic device in response to the map editing request, the editing interface including at least a part of a specific map corresponding to the specific floor;
allocating at least one node on the specific map based on editing information received from the electronic device; and
updating the specific map on a cloud server based on completion of the allocating such that robots
travel the specific floor along the at least one node allocated on the specific map, or
perform an operation defined at the at least one node on the specific floor.

15. The method of claim 14, wherein
the at least one node corresponds to at least one of:
a first type of node that configures a traveling path for the robots, the first type of node corresponding to a travel node linked to the travel of the robots,
a second type of node that corresponds to an operation node linked to a specific operation of the robots, or
a third type of node that corresponds to a facility node linked to a facility on the specific floor; and
the updating causes the robots to perform an operation defined at the at least one node based on the at least one node being allocated to a place where the robots are positioned.

16. The method of claim 15, wherein
the at least one node includes the operation node;
the specific operation of the robots includes a waiting operation in which the robots stop traveling and wait when positioned at the operation node; and
the allocating includes setting the operation node with direction information that defines a direction in which the robots positioned at the operation node face.

17. The method of claim 14, wherein
the at least one node includes a plurality of nodes;
the allocating includes grouping a subset of nodes in a same zone on the specific map, the subset of nodes being among the plurality of nodes; and
the method further comprising providing identification information in an area of the editing interface in response to selection of one node among the subset of nodes through the editing interface, the identification information including at least one of identification information on the one node or identification information on a zone including the one node.

18. A system for generating a map, comprising:
a communication unit configured to receive a map editing request for a specific floor among a plurality of floors of a building; and
processing circuitry configured to
provide an editing interface on a display unit of an electronic device in response to the map editing request, the editing interface including at least a part of a specific map corresponding to the specific floor,
allocate at least one graphic object on the specific map based on editing information received from the electronic device, and
update the specific map on a cloud server based on completion of the allocation of the at least one graphic object such that robots travel through the specific floor according to an attribute of the at least one graphic object.
